(19) United States
(12) Patent Application Publication
(10) Pub. No.: US 2019/0350242 A1
(43) Pub. Date: Nov. 21, 2019

(54) STEVIOL GLYCOSIDES WITH IMPROVED SOLUBILITIES, TASTE PROFILES AND FLAVORING EFFECTS

(71) Applicants: Sweet Green Fields USA, LLC, Bellingham, WA (US); EPC Natural Products Co., Ltd., Beijing (CN)

(72) Inventors: Mel Clinton Jackson, Waikoloa, HI (US); Hansheng Wang, Beijing (CN); Xin Shi, Beijing (CN); Jingang Shi, Beijing (CN)

(21) Appl. No.: 16/361,529

(22) Filed: Mar. 22, 2019

Related U.S. Application Data
(63) Continuation-in-part of application No. 14/739,887, filed on Jun. 15, 2015, now Pat. No. 10,357,052.
(60) Provisional application No. 62/012,936, filed on Jun. 16, 2014.
(60) Provisional application No. 62/647,451, filed on Mar. 23, 2018.
(60) Provisional application No. 62/669,718, filed on May 10, 2018.
(60) Provisional application No. 62/750,632, filed on Oct. 25, 2018.

(51) Int. Cl. A23L 27/30

(52) U.S. Cl. CPC A23L 27/36; A23V 2002/00; A23L 27/31

(57) ABSTRACT

A steviol glycoside composition comprises one or more steviol glycosides, one or more salts, and one or more non-steviol glycoside sweeteners. The steviol glycoside composition has improved solubility and sensory profiles and may be used as a sweetener or a flavoring agent.

### CROSS REFERENCE TO RELATED APPLICATIONS

This application is a Continuation-in-Part of U.S. application Ser. No. 14/739,887, filed Jun. 15, 2015, which claims priority to U.S. Provisional Patent Application Ser. No. 62/012,936, filed Jun. 16, 2014, the contents of which are incorporated herein by reference in their entirety. This application claims benefit under 35 U.S.C. 119(e) to U.S. Provisional Patent Application Ser. Nos. 62/647,451, filed Mar. 23, 2018; 62/669,718, filed May 10, 2018 and 62/750,632, filed Oct. 25, 2018, the contents of which are incorporated herein by reference in their entirety.

### FIELD OF THE INVENTION

The present application discloses steviol glycoside compositions containing steviol glycosides, salts, and other natural or synthetic sweeteners with improved solubilities and sensory profiles, and methods for making the steviol glycoside compositions.

### BACKGROUND OF THE INVENTION

Steviol glycosides, such as rebaudioside A (RA), rebaudioside B (RB), rebaudioside C (RC), rebaudioside D (RD), are high intensity sweeteners and have been widely used as a sweetener in food and beverage products.

Stevia glycosides generally have poor solubility. The taste of some Stevia glycosides, such as RA, also needs improvement. Therefore, there exists a need in the food and beverage industry for Stevia glycoside compositions with improved solubility and an improved taste profile.

### BRIEF SUMMARY OF THE INVENTION

As further described below, the inventors have unexpectedly discovered that steviol glycosides prepared by hydrolysis have improved solubility and taste profiles compared to the starting materials or a simple combination of purified steviol glycosides present in the hydrolyzed product. For example, the alkaline hydrolysis product of RA (which contains RA and RB) has improved solubility and taste profiles compared to RA, or a mixture of pure RA and pure RB. Further, steviol glycosides prepared by hydrolysis may be blended with an unhydrolyzed steviol glycoside composition to improve the solubility and sensory profile of the unhydrolyzed steviol glycoside composition. Finally, steviol glycosides can be combined with one or more salts, and one or more natural or synthetic sweeteners other than steviol glycosides to provide a composition with improve the solubility and sensory profile.

One aspect of the present application relates to a steviol glycoside composition comprising rebaudioside A (RA) in an amount of 40-95 wt % of the composition, rebaudioside B (RB) in an amount of 1-20 wt % of the composition, one or more non-steviol glycoside sweeteners in an amount of 0.05-3 wt % of the composition, and one or more salts in an amount of 0.005-0.5 wt % of the composition.

Another aspect of the present application relates to a blended steviol glycoside composition, comprising (A) an alkaline hydrolysis product of a first steviol glycoside composition, and (B) a second steviol glycoside composition, wherein the weight ratio of component (A):component (B) is in a range of 5:95 to 95:5 and wherein the blended steviol glycoside composition has an improved sensory profile compared to component (B).

Another aspect of the present application relates to a steviol glycoside composition, comprising a blend of (A) a steviol glycoside composition, and (B) thaumatin, wherein the weight ratio of A:B is between 5,000:1 and 5:1.

Another aspect of the present application relates to a method for preparing a hydrolyzed steviol glycoside composition, comprising the steps of: dissolving a steviol glycoside composition in water, wherein the steviol glycoside composition comprises 20-99 wt % RA; adding an alkali to the steviol glycoside composition to form a starting mixture; and incubating the starting mixture at 75-105° C. for 2 to 6 hours to produce an incubated mixture; neutralizing the incubated mixture to produce a neutralized mixture; and spray drying the neutralized mixture to produce the hydrolyzed steviol glycoside composition.

Another aspect of present application relates to a method improving taste profile of a target steviol glycoside composition, comprising the step of: adding an alkaline hydrolyzed steviol glycoside composition prepared by the method of the present application to the target steviol glycoside composition at a weight ratio of 5:95 to 50:50 to generate an improved composition, wherein the target steviol glycoside composition comprises 20-99 wt % RA and wherein the improved composition comprises 40-95 wt % RA.

While multiple embodiments are disclosed, still other embodiments of the present application will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### BRIEF DESCRIPTION OF THE DRAWINGS

FIG. 1: Tabular data showing the effect of varying the concentration of NaOH in the reaction of RA50, RA80, and RA97 after 18 h at 90° C.

FIG. 2: Graphical illustrations showing the effect of varying the concentration of NaOH in the reaction of RA50 after 18 h at 90° C.

FIG. 3: Graphical illustrations showing the effect of varying the concentration of NaOH in the reaction of RA80 after 18 h at 90° C.

FIG. 4: Graphical illustrations showing the effect of varying the concentration of NaOH in the reaction of RA97 after 18 h at 90° C.

FIG. 5: Tabular data showing a sensory panel for 50% reduced sugar lemon and lime carbonated soda (50% S.R. Lemon & Line CSD) mixed with RA/RB hydrolysate derived from RA97 versus mixed with a commercial RA extract.

FIG. 6: Tabular data showing Anova scores of overall (OV) like, sweetness, bitterness, sugar like, and mouth drying (MD) from the results in FIG. 5.

FIG. 7: Tabular data showing the average overall (OV) like, sweetness, bitterness, sugar like, and mouth drying (MD) from the results in FIG. 5.

FIG. 8: Tabular data and graphical illustrations showing the sensory panel results for RA (RA50, RA80, and RA97) and RA/RB hydrolysates (ABH) compositions.

FIG. 9: A graphical illustration showing the effect of hydrolyzed glucose on RA/RB sensory (MJ=Tester #10, SJ=Tester #11).

FIG. 10: A graphical illustration showing the effect of hydrolyzed glucose on RA97 sensory (MJ=Tester #10, SJ=Tester #11).

FIG. 11: A HPLC chromatogram of hydrolyzed 83/17 RA/RB dry blend.

FIG. 12: A HPLC chromatogram of hydrolyzed RA80.

FIG. 13: A HPLC chromatogram of hydrolyzed RA97.

FIG. 14: A graphical illustration showing the taste characteristics of hydrolyzed RA80 (90 ppm) vs. 83/17 RA/RB dry blend (MJ=Tester #10, SJ=Tester #11).

FIG. 15: A graphical illustration showing the taste characteristics of hydrolyzed RA97 (90 ppm) vs. 83/17 RA/RB dry blend (MJ=Tester #10. SJ=Tester #11).

### DETAILED DESCRIPTION

In the specification and in the claims, the terms “including” and “comprising” are open-ended terms and should be interpreted to mean “including, but not limited to . . . .” These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

The phrase “Stevia starting material” or “raw material” means a material containing steviol glycosides of the plant Stevia rebaudiana or other species of Stevia genus. The Stevia starting material or raw material can be a crude extract, a purified extract, or a byproduct of a purification process. A crude extract is typically the first dried product produced after processing harvested Stevia plant material. A purified extract contains a higher concentration of one or more steviol glycosides of interest than contained in a crude extract. A byproduct of a purification process typically is all or a portion of the waste stream from purifying steviol glycosides from crude extract or from an intermediate purity.

Without specific description, the acronym “RAx” refers to a Stevia composition containing RA in amount of ≥x % and <(x+10)% with the following exceptions: The acronym “RA100” specifically refers to purified RA that contains less than 0.2 wt % of other steviol glycosides; the acronym “RA99.5” specifically refers to a composition comprising 99-99.8 wt % of RA; the acronym “RA99” specifically refers to a composition where the amount of RA is ≥99 wt %, but <100 wt %; the acronym “RA98” specifically refers to a composition where the amount of RA is ≥98 wt %, but <99 wt %; the acronym “RA97” specifically refers to a composition where the amount of RA is ≥97 wt %, but <98 wt %; the acronym “RA95” specifically refers to a composition where the amount of RA is ≥95 wt %, but <97 wt %; the acronym “RA85” specifically refers to a composition where the amount of RA is ≥85 wt %, but <95 wt %; the acronym “RA75” specifically refers to a composition where the amount of RA is ≥75 wt %, but <80 wt %; the acronym “RA65” specifically refers to a composition where the amount of RA is ≥65 wt %, but <70 wt %; the acronym “RA20” specifically refers to a composition where the amount of RA is ≥15 wt %, but <30 wt %.

As used herein, the acronym “RAx-HP” refers to a hydrolysis product of RAx prepared by the hydrolysis method described in the present application. By way of example, RA can be hydrolyzed to lyse a glucose unit from the glycoside chain on the C13 carbon of RA, which converts RA to RB. Similarly, ST can be hydrolyzed to lyse a glucose unit from the glycoside chain on the C13 carbon of ST, which converts ST to STB. The inventors have unexpectedly discovered that the solubility and sensory profile of a steviol glycoside composition (e.g., the RAiRB mixture produced from hydrolysis of RA) can be improved compared to the materials present in the starting material in purified form. For example, the products from alkaline hydrolysis of RA include a mixture of RA and RB, which together have an improved solubility and sensory profile compared to a mixture made from comparable amounts of purified IA and RB.

As used herein, “percentage of hydrolysis” or “% of hydrolysis” is determined by the formula (starting SG weight−unhydrolyzed SG weight)/starting SG weight. For example, in a preparation where the starting weight of RA is 100 g and the final (post-hydrolysis) product comprises 95 g RA, the persentage of hydrolysis is (100-95)/100=5%.

As used herein, the terms “rebaudioside A, “Reb A,” and “RA” are equivalent terms referring to the same molecule. The same condition applies to all lettered rebaudiosides.

As used herein, the term “total stevio glycoside” or “TSG” is based on the sum of nine steviol glycosides including Rebaudioside A, Rebaudioside B, Rebaudioside C, Rebaudioside D, Rebaudioside F, Stevioside, Steviolbiosed, Rubusoside, and Dulcoside A.

The phrase “Stevia containing sweetener” or “Stevia containing flavoring agent” is intended to include any sweetener composition or flavoring agent that is prepared from a Stevia plant, such as a Stevia extract, or the individual components found in Stevia. The sweetener or flavoring agent can include one or more of the components associated with the Stevia plant, such as those noted above.

A “Stevia composition” as referred to herein, pertains to a material that includes one or more steviol glycosides found in the Stevia plant.

The phrase “sucrose equivalence” is the amount of non-sucrose sweetener required to provide the sweetness of a given percentage of sucrose in the same food, beverage, or solution. For instance, a non-diet soft drink typically contains 12 grams of sucrose per 100 ml of water, i.e., 12% sucrose. This means that to be commercially accepted diet soft drinks must have the same sweetness as a 12% sucrose soft drink, i.e., a diet soft drink must have 12% sucrose equivalence (“SE”). Soft drink dispensing equipment assumes an SE of 12%, since such equipment is set up for use with sucrose-based syrups.

The phase “sensory profile” or “taste profile” is defined as the temporal profile of all basic tastes of a sweetener. The onset and decay of sweetness when a sweetener is consumed, as perceived by trained human tasters and measured in seconds from first contact with a taster's tongue (“onset”) to a cutoff point (typically 180 seconds after onset), is called the “temporal profile of sweetness”. A plurality of such human tasters is called a “sensory panel”. In addition to sweetness, sensory panels can also judge the temporal profile of the other “basic tastes”: sugar-likeness bitterness, aftertaste, metallic taste, lingering, saltiness, sourness, piquance (aka spiciness), and umami (aka savoriness or meatiness). The onset and decay of bitterness when a sweetener is consumed, as perceived by trained human tasters and measured in seconds from first perceived taste to the last perceived aftertaste at the cutoff point, is called the “temporal profile of bitterness”.

The term “flavor” or “flavor characteristic”, as used herein, is the combined sensory perception of the components of taste, odor, and/or texture. The term “enhance”, as used herein, includes augmenting, intensifying, accentuating, magnifying, and potentiating the sensory perception of a flavor characteristic without changing the nature or quality thereof.

The term “modify”, as used herein, includes altering, varying, suppressing, depressing, fortifying and supplementing the sensory perception of a flavor characteristic where the quality or duration of such characteristic was deficient.

The term “flavoring agent,” as used herein, refers to an agent or a mixture of agents that adds a flavor to, or changes a taste profile of, a mixture.

While not wishing to be bound by theory, the inventors have unexpectedly discovered that one or more steviol glycosides, whether prepared by hydrolysis or not, can be combined with one or more salts, natural or synthetic sweeteners other than steviol glycosides, flavoring agents, additives and/or other functional ingredients to provide ingestible compositions having improved solubility, balanced flavor, and sensory profiles, as further described below.

While not wishing to be bound by theory, the inventors believe that the results are due to the glucose and salts generated in the hydrolysis process, i.e., the hydrolysate of RA is a composition comprising additional components, in addition to RA and RB, and thus is different from the plain mixture. Thus, if the same molar concentration of purified RA and RB are mixed and dissolved, the RA and RB rapidly precipitate out of solution. In contrast, the hydrolyzed RA/RB and hydrolyzed ST/STB stay in solution. For clarification purposes, RA/RB means the products of alkaline hydrolysis of RA. Similarly, ST/STB means the products of alkaline hydrolysis of ST.

### Stevia Glycoside Composition

One aspect of the present application relates to a steviol glycoside composition comprising one or more steviol glycosides, one or more non-steviol glycoside sweeteners, and one or more salts.

### Steviol Glycosides

Steviol glycosides are glycosides of steviol, a diterpene compound shown below in formula I.

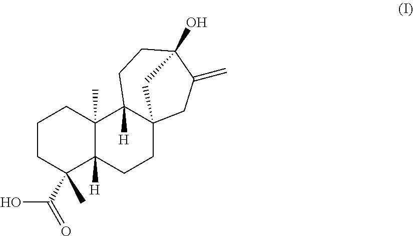

As shown in Formula II, steviol glycosides are a steviol molecule with the glycosylation at the C13 and/or C19 position.

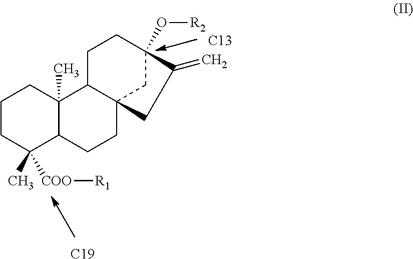

Table A provides a non-limiting list of about 80 steviol glycosides for use in the present application.

TABLE A
Steviol glycosides

| | | | | # of Xy1ose | | | |
|---|---|---|---|---|---|---|---|
| | | # of | # of | or | | | |
| Steviol | | Glucose | Rhamnose | Arabinose | | | |
| Glycoside | | moieties | moieties | moieties | | | |
| Name | MW | (mW = 180) | (mw = 164) | (mw = 150) | R1 (C-19) | R2 (C-13) | Backbone |
| Related | 457 | — | | | | | |
| SvGn#1 | | | | | | | |
| Steviol- | 479 | 1 | | | H— | Glcβ1- | Steviol |
| monoside | | | | | | | |
| Steviol- | 479 | 1 | 1 | | Glcβ1- | H— | |
| monoside A | | | | | | | |
| SG-4 | 611 | 1 | | 1 | H— | Xylβ(1-2)Glcβ1- | Steviol |
| Dulcoside A1 | 625 | 1 | 1 | | H— | Rhaα(1-2)Glcβ1- | Steviol |
| Iso- | 641 | 2 | | | H— | Glcβ(1-2)Glcβ1- | Isosteviol |
| Steviolbioside | | | | | | | |
| Reb-G1 | 641 | 2 | | | H— | Glcβ(1-3)Glcβ1- | Steviol |
| rubusoside | 641 | 2 | | | Glcβ1- | Glcβ1- | Steviol |
| steviolbioside | 641 | 2 | | | H— | Glcβ(1-2)Glcβ1- | Steviol |
| Related | 675 | — | | | | | |
| SvGn#3 | | | | | | | |
| Reb-F1 | 773 | 2 | | 1 | H— | Xylβ(1-2)[Glcβ(1-3)] | Steviol |
| | | | | | | Glcβ1- | |
| Reb-R1 | 773 | 2 | | 1 | H— | Glcβ(1-2)[Glcβ(1-3)] | Steviol |
| | | | | | | Xylβ1- | |
| Stevioside F | 773 | 2 | | 1 | Glcβ1- | Xylβ(1-2)Glcβ1- | Steviol |
| (SG-1) | | | | | | | |
| SG-Unk1 | 773 | 2 | | 1 | — | — | Steviol |
| dulcoside A | 787 | 2 | 1 | | Glcβ1- | Rhaα(1-2)Glcβ1- | Steviol |
| dulcoside B | 787 | 2 | 1 | | H— | Rhaα(1-2)[Glcβ(1-3)] | Steviol |
| (JECFA C) | | | | | | Glcβ1- | |
| SG-3 | 787 | 2 | 1 | | H— | 6-deoxyGlcβ(1-2) | Steviol |
| | | | | | | [Glcβ(1-3)]Glcβ1- | |
| Stevioside D | 787 | 2 | 1 | | Glcβ1- | Glcβ(1-2)6-deoxyGlcβ1- | |
| Iso-Reb B | 803 | 3 | | | H— | Glcβ(1-2)[Glcβ(1-3)] | Isosteviol |
| | | | | | | Glcβ1- | |
| Iso-Stevioside | 803 | 3 | | | Glcβ1- | Glcβ(1-2)Glcβ1- | Isosteviol |
| Reb B | 803 | 3 | | | H— | Glcβ(1-2)[Glcβ(1-3)] | Steviol |
| | | | | | | Glcβ1- | |
| Reb G | 803 | 3 | | | Glcβ1- | Glcβ(1-3)Glcβ1- | Steviol |
| Reb-KA | 803 | 3 | | | Glcβ(1-2) | Glcβ1- | Steviol |
| | | | | | Glcβ1- | | |
| SG-13 | 803 | 3 | | | Glcβ1- | Glcβ(1-2)Glcβ1- | Isomeric |
| | | | | | | | steviol |
| | | | | | | | (12α- |
| | | | | | | | hydroxy) |
| Stevioside | 803 | 3 | | | Glcβ1- | Glcβ(1-2)Glcβ1- | Steviol |
| Stevioside B | 803 | 3 | | | Glcβ(1-3) | Glcβ1- | Steviol |
| (SG-15) | | | | | Glcβ1- | | |
| Reb F | 935 | 3 | | 1 | Glcβ1- | Xylβ(1-2)[Glcβ(1-3)] | Steviol |
| | | | | | | Glcβ1- | |
| Reb R | 935 | 3 | | 1 | Glcβ1- | Glcβ(1-2)Glcβ(1-3)] | Steviol |
| | | | | | | Xylβ1- | |
| SG-Unk2 | 935 | 3 | | 1 | — | — | Steviol |
| SG-Unk3 | 935 | 3 | | 1 | — | — | Steviol |
| Reb F3 | 935 | 3 | | 1 | Xylβ(1-6) | Glcβ(1-2)Glcβ1- | Steviol |
| (SG-11) | | | | | Glcβ1- | | |
| Reb F2 | 935 | 1 | | 1 | Glcβ1- | Glcβ(1-2)[Xylβ(1-3)] | Steviol |
| (SG-14) | | | | | | Glcβ1- | |
| Reb C | 949 | 3 | 1 | | Glcβ1- | Rhaα(1-2)[Glcβ(1-3)] | Steviol |
| | | | | | | Glcβ1- | |
| Reb C2/ | 949 | 3 | 1 | | Rhaα(1-2) | Glcβ(1-2) | Steviol |
| Reb S | | | | | Glcβ1- | Glcβ1- | |
| Stevioside E | 949 | 3 | 1 | | Glcβ1- | 6-DeoxyGlcβ(1-2) | Steviol |
| (SG-9) | | | | | | [Glcβ(1-3)]Glcβ1- | |
| Stevioside E2 | 949 | 3 | 1 | | 6-Deoxy | Glcβ(1-2)[Glcβ(1-3)] | |
| | | | | | Glcβ1- | Glcβ1- | |
| SG-10 | 949 | 3 | 1 | | Glcβ1- | Glcα(1-3)Glcβ(1-2)] | Steviol |
| | | | | | | [Glcβ(1-3)]Glcβ1- | |
| Reb L1 | 949 | 3 | 1 | | H— | Glcβ(1-3)Rhaα(1-2) | Steviol |
| | | | | | | [Glcβ(1-3)]Glcβ1- | |
| SG-2 | 949 | 3 | 1 | | Glcβ1- | 6-deoxyGlcβ(1-2) | Steviol |
| | | | | | | [Glcβ(1-3)]Glcβ1- | |
| Reb A3 | 965 | 4 (1 Fru) | | | Glcβ1- | Glcβ(1-2)[Fruβ(1-3)] | |
| (SG-8) | | | | | | Glcβ1- | |
| Iso-Reb A | 965 | 4 | | | Glcβ1- | Glcβ(1-2)[Glcβ(1-3)] | Isosteviol |
| | | | | | | Glcβ1- | |
| Reb A | 965 | 4 | | | Glcβ1- | Glcβ(1-2)[Glcβ(1-3)] | Steviol |
| | | | | | | Glcβ1- | |
| Reb A2 | 965 | 4 | | | Glcβ1- | Glcβ(1-6)[Glcβ(1-2)] | Steviol |
| (SG-7) | | | | | | Glcβ1- | |
| Reb E | 965 | 4 | | | Glcβ(1-2) | Glcβ(1-2)Glcβ1- | Steviol |
| | | | | | Glcβ1- | | |
| Reb H1 | 965 | 4 | | | H— | Glcβ(1-6)Glcβ(1-3) | Steviol |
| | | | | | | [Glcβ1-3)]Glcβ1- | |
| Related | 981 | — | | | | | |
| SvGn#2 | | | | | | | |
| Related | 981 | — | | | | | |
| SvGn#5 | | | | | | | |
| Reb U2 | 1097 | 4 | | 1 | Xylβ(1-2) | Glcβ(1-2)Glcβ1- | |
| | | | | | [Glcβ1-3)] | | |
| | | | | | Glcβ1- | | |
| Reb T | 1097 | 4 | | 1 | Xylβ(1-2) | Glcβ(1-2)[Glcβ(1-3)] | |
| | | | | | Glcβ1- | Glcβ1- | |
| Reb W | 1097 | 4 | | 1 | Glcβ(1-2) | Glcβ(1-2)Glcβ1- | |
| | | | | | [Araβ(1-3)] | | |
| | | | | | Glcβ1- | | |
| Reb W2 | 1097 | 4 | | 1 | Araβ(1-2) | Glcβ(1-2)[Glcβ(1-3)] | |
| | | | | | Glcβ1- | Glcβ1- | |
| Reb W3 | 1097 | 4 | | 1 | Araβ(1-6) | Glcβ(1-2)[Glcβ(1-3)] | |
| | | | | | Glcβ1- | Glcβ1- | |
| Reb U | 1097 | 4 | | 1 | Araα(1-2)- | Glcβ(1-2)[Glcβ(1-3)] | Steviol |
| | | | | | Glcβ1- | Glcβ1- | |
| SG-12 | 1111 | 4 | 1 | | Rhaα(1-2) | Glcβ(1-2)[Glcβ(1-3)] | Steviol |
| | | | | | Glcβ1- | Glcβ1- | |
| Reb H | 1111 | 4 | 1 | | Glcβ1- | Glcβ(1-3)Rhaα(1-2) | Steviol |
| | | | | | | [Glcβ(1-3)]Glcβ1- | |
| Reb J | 1111 | 4 | 1 | | Rhaα(1-2) | Glcβ(1-2)[Glcβ(1-3)] | Steviol |
| | | | | | Glcβ1- | Glcβ1- | |
| Reb K | 1111 | 4 | 1 | | Glcβ(1-2) | Rhaα(1-2)[Glcβ(1-3)] | Steviol |
| | | | | | Glcβ1- | Glcβ1- | |
| Reb K2 | 1111 | 4 | 1 | | Glcβ(1-6) | Rhaα(1-2)[Glcβ(1-3)] | Steviol |
| | | | | | Glcβ1- | Glcβ1- | |
| SG-Unk4 | 1111 | 4 | 1 | | — | — | Steviol |
| SG-Unk5 | 1111 | 4 | 1 | | — | — | Steviol |
| Reb D | 1127 | 5 | | | Glcβ(1-2) | Glcβ(1-2)[Glcβ(1-3)] | Steviol |
| | | | | | Glcβ1- | Glcβ1- | |
| Reb I | 1127 | 5 | | | Glcβ(1-3) | Glcβ(1-2)[Glcβ(1-3)] | Steviol |
| | | | | | Glcβ1- | Glcβ1- | |
| Reb L | 1127 | 5 | | | Glcβ1- | Glcβ(1-6)Glcβ(1-2) | Steviol |
| | | | | | | [Glcβ(1-3)]Glcβ1- | |
| Reb I3 | 1127 | 5 | | | [Glcβ(1-2) | Glcβ(1-2)Glcβ1- | |
| | | | | | Glcβ(1-6)] | | |
| | | | | | Glcβ1- | | |
| SG-Unk6 | 1127 | 5 | | | — | — | Steviol |
| Reb Q | 1127 | 5 | | | Glcβ1-as | Glcα(1-4)Glcβ(1-2) | Steviol |
| (SG-5) | | | | | | [Glcβ(1-3)]Glcβ1- | |
| Reb 12 | 1127 | 5 | | | Glcβ1- | Glcα(1-3)Glcβ1-2 | Steviol |
| (SG-6) | | | | | | [Glcβ1-3)]Glcβ1- | |
| Reb Q2 | 1127 | 5 | | | Glcα(1-2) | Glcβ(1-2)Glcβ1- | |
| | | | | | Glcα(1-4) | | |
| | | | | | Glcβ1- | | |
| Reb Q3 | 1127 | 5 | | | Glcβ1- | Glcα(1-4)Glcβ(1-3) | |
| | | | | | | [Glcβ(1-2)]Glcβ1- | |
| Reb T1 | 1127 | 5 | | | Galβ(1-2) | Glcβ(1-2)[Glcβ(1-3)] | |
| | | (1 Gal) | | | Glcβ1- | Glcβ1- | |
| Related | 1127 | — | | | | | |
| SvGn#4 | | | | | | | |
| Reb V2 | 1259 | 5 | | 1 | Xylβ(1-2) | Glcβ(1-2)[Glcβ(1-3)] | Steviol |
| | | | | | [Glcβ(1-3)]- | Glcβ1- | |
| | | | | | Glcβ1- | | |
| Reb V | 1259 | 5 | | 1 | Glcβ(1-2) | Xylβ(1-2)[Glcβ(1-3)]- | |
| | | | | | [Glcβ(1-3)] | Glcβ1- | |
| | | | | | Glcβ1- | | |
| Reg Y | 1259 | 5 | | 1 | Glcβ(1-2) | Glcβ(1-2)[Glcβ(1-3)] | |
| | | | | | [Araβ(1-3)] | Glcβ1- | |
| | | | | | Glcβ1- | | |
| Reb N | 1273 | 5 | 1 | | Rhaα(1-2) | Glcβ(1-2)[Glcβ(1-3)] | Steviol |
| | | | | | [Glcβ(1-3)] | Glcβ1- | |
| | | | | | Glcβ1- | | |
| Reb M | 1289 | 6 | | | Glcβ(1-2) | Glcβ(1-2)[Glcβ(1-3)] | Steviol |
| | | | | | [Glcβ(1-3)] | Glcβ1- | |
| | | | | | Glcβ1- | | |
| 15α-OH | 1305 | 6 | | | Glcβ1-2 | Glcβ(1-2)[Glcβ1-3] | 15α- |
| Reb M | | | | | Glcβ(1-3) | Glcβ1- | Hydroxy- |
| | | | | | Glcβ1- | | steviol |
| Reb O | 1435 | 6 | 1 | | Glcβ(1-3) | Glcβ(1-2)[Glcβ(1-3)] | Steviol |
| | | | | | Rhaα(1-2) | Glcβ1- | |
| | | | | | [Glcβ(1-3)] | | |
| | | | | | Glcβ1- | | |
| Reb O2 | 1435 | 6 | 1 | | Glcβ(1-4) | Glcβ(1-2)[Glcβ(1-3)] | |
| | | | | | Rhaα(1-2) | Glcβ1- | |
| | | | | | [Glcβ(1-3)] | | |
| | | | | | Glcβ1- | | |

The one or more steviol glycosides contained in the steviol glycoside composition of the present application can make up anywhere from about 1 wt. % of the steviol glycoside composition to about 99 wt. % of the steviol glycoside composition, specifically about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, about 31 wt. %, about 32 wt. %, about 33 wt. %, about 34 wt. %, about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, about 51 wt. %, about 52 wt. %, about 53 wt. %, about 54 wt. %, about 55 wt. %, about 56 wt. %, about 57 wt. %, about 58 wt. %, about 59 wt. %, about 60 wt. %, about 61 wt. %, about 62 wt. %, about 63 wt. %, about 64 wt. %, about 65 wt. %, about 66 wt. %, about 67 wt. %, about 68 wt. %, about 69 wt. %, about 70 wt. %, about 71 wt. %, about 72 wt. %, about 73 wt. %, about 74 wt. %, about 75 wt. %, about 76 wt. %, about 77 wt. %, about 78 wt. %, about 79 wt. %, about 80 wt. %, about 81 wt. %, about 82 wt. %, about 83 wt. %, about 84 wt. %, about 85 wt. %, about 86 wt. %, about 87 wt. %, about 88 wt. %, about 89 wt. %, about 90 wt. %, about 91 wt. %, about 92 wt. %, about 93 wt. %, about 94 wt. %, about 95 wt. %, about 96 wt. %, about 97 wt. %, about 98 wt. %, about 99 wt. %, and all ranges there between, including for example from about 40 wt % to about 45 wt %, 40 wt % to about 50 wt %, 40 wt % to about 55 wt %, 40 wt % to about 60 wt %, 40 wt % to about 65 wt %, 40 wt % to about 70 wt %, 40 wt % to about 75 wt %, 40 wt % to about 80 wt %, 40 wt % to about 85 wt %, 40 wt % to about 90 wt %, 40 wt % to about 95 wt %, 40 wt % to about 97 wt %, 40 wt % to about 99 wt %, 45 wt % to about 50 wt %, 45 wt % to about 55 wt %, 45 wt % to about 60 wt %, 45 wt % to about 65 wt %, 45 wt % to about 70 wt %, 45 wt % to about 75 wt %, 45 wt % to about 80 wt %, 45 wt % to about 85 wt %, 45 wt % to about 90 wt %, 45 wt % to about 95 wt %, 45 wt % to about 97 wt %, 45 wt % to about 99 wt %, 50 wt % to about 55 wt %, 50 wt % to about 60 wt %, 50 wt % to about 65 wt %, 50 wt % to about 70 wt %, 50 wt % to about 75 wt %, 50 wt % to about 80 wt %, 50 wt % to about 85 wt %, 50 wt % to about 90 wt %, 50 wt % to about 95 wt %, 50 wt % to about 97 wt %, 50 wt % to about 99 wt %, 55 wt % to about 60 wt %, 55 wt % to about 65 wt %, 55 wt % to about 70 wt %, 55 wt % to about 75 wt %, 55 wt % to about 80 wt %, 55 wt % to about 85 wt %, 55 wt % to about 90 wt %, 55 wt % to about 95 wt %, 55 wt % to about 97 wt %, 55 wt % to about 99 wt %, 60 wt % to about 65 wt %, 60 wt % to about 70 wt %, 60 wt % to about 75 wt %, 60 wt % to about 80 wt %, 60 wt % to about 85 wt %, 60 wt % to about 90 wt %, 60 wt % to about 95 wt %, 60 wt % to about 97 wt %, 60 wt % to about 99 wt %, 65 wt % to about 70 wt %, 65 wt % to about 75 wt %, 65 wt % to about 80 wt %, 65 wt % to about 85 wt %, 65 wt % to about 90 wt %, 65 wt % to about 95 wt %, 65 wt % to about 97 wt %, 65 wt % to about 99 wt %, 70 wt % to about 75 wt %, 70 wt % to about 80 wt %, 70 wt % to about 85 wt %, 70 wt % to about 90 wt %, 70 wt % to about 95 wt %, 70 wt % to about 97 wt %, 70 wt %/0 to about 99 wt %, 75 wt % to about 80 wt %, 75 wt % to about 85 wt %, 75 wt % to about 90 wt %, 75 wt % to about 95 wt %, 75 wt % to about 97 wt %, 75 wt % to about 99 wt %, 80 wt % to about 85 wt %, 80 wt % to about 90 wt %, 80 wt % to about 95 wt %, 80 wt % to about 97 wt %, 80 wt % to about 99 wt %, 85 wt % to about 90 wt %, 85 wt % to about 95 wt %, 85 wt % to about 97 wt %, 85 wt % to about 99 wt %, 90 wt % to about 95 wt %, 90 wt % to about 97 wt %, 90 wt % to about 99 wt %, 95 wt % to about 97 wt %, and 95 wt % to about 99 wt %.

In some embodiments, the one or more steviol glycosides of the present application comprise RA in an amount of 1-100 wt %, 1-95 wt %, 1-90 wt %, 1-85 wt %, 1-80 wt %, 1-75 wt %, 1-70 wt %, 1-65 wt %, 1-60 wt %, 1-55 wt %, 1-50 wt %, 1-45 wt %, 1-40 wt %, 1-35 wt %, 1-30 wt %, 1-25 wt %, 1-20 wt %, 1-15 wt %, 1-10 wt %, 1-5 wt %, 5-100 wt %, 5-95 wt %, 5-90 wt %, 5-85 wt %, 5-80 wt %, 5-75 wt %, 5-70 wt %, 5-65 wt %, 5-60 wt %, 5-55 wt %, 5-50 wt %, 5-45 wt %, 5-40 wt %, 5-35 wt %, 5-30 wt %, 5-25 wt %, 5-20 wt %, 5-15 wt %, 5-10 wt %, 10-100 wt %, 10-95 wt %, 10-90 wt %, 10-85 wt %, 10-80 wt %, 10-75 wt %, 10-70 wt %, 10-65 wt %, 10-60 wt %, 10-55 wt %, 10-50 wt %, 10-45 wt %, 10-40 wt %, 10-35 wt %, 10-30 wt %, 10-25 wt %, 10-20 wt %, 10-15 wt %, 15-100 wt %, 15-95 wt %, 15-90 wt %, 15-85 wt %, 15-80 wt %, 15-75 wt %, 15-70 wt %, 15-65 wt %, 15-60 wt %, 15-55 wt %, 15-50 wt %, 15-45 wt %, 15-40 wt %, 15-35 wt %, 15-30 wt %, 15-25 wt %, 15-20 wt %, 20-100 wt %, 20-95 wt %, 20-90 wt %, 20-85 wt %, 20-80 wt %, 20-75 wt %, 20-70 wt %, 20-65 wt %, 20-60 wt %, 20-55 wt %, 20-50 wt %, 20-45 wt %, 20-40 wt %, 20-35 wt %, 20-30 wt %, 20-25 wt %, 25-100 wt %, 25-95 wt %, 25-90 wt %, 25-85 wt %, 25-80 wt %, 25-75 wt %, 25-70 wt %, 25-65 wt %, 25-60 wt %, 25-55 wt %, 25-50 wt %, 25-45 wt %, 25-40 wt %, 25-35 wt %, 25-30 wt %, 30-100 wt %, 30-95 wt %, 30-90 wt %, 30-85 wt %, 30-80 wt %, 30-75 wt %, 30-70 wt %, 30-65 wt %, 30-60 wt %, 30-55 wt %, 30-50 wt %, 30-45 wt %, 30-40 wt %, 30-35 wt %, 35-100 wt %, 35-95 wt %, 35-90 wt %, 35-85 wt %, 35-80 wt %, 35-75 wt %, 35-70 wt %, 35-65 wt %, 35-60 wt %, 35-55 wt %, 35-50 wt %, 35-45 wt %, 35-40 wt %, 40-100 wt %, 40-95 wt %, 40-90 wt %, 40-85 wt %, 40-80 wt %, 40-75 wt %, 40-70 wt %, 40-65 wt %, 40-60 wt %, 40-55 wt %, 40-50 wt %, 40-45 wt %, 45-100 wt %, 45-95 wt %, 45-90 wt %, 45-85 wt %, 45-80 wt %, 45-75 wt %, 45-70 wt %, 45-65 wt %, 45-60 wt %, 45-55 wt %, 45-50 wt %, 50-100 wt %, 50-95 wt %, 50-90 wt %, 50-85 wt %, 50-80 wt %, 50-75 wt %, 50-70 wt %, 50-65 wt %, 50-60 wt %, 50-55 wt %, 55-100 wt %, 55-95 wt %, 55-90 wt %, 55-85 wt %, 55-80 wt %, 55-75 wt %, 55-70 wt %, 55-65 wt %, 55-60 wt %, 60-100 wt %, 60-95 wt %, 60-90 wt %, 60-85 wt %, 60-80 wt %, 60-75 wt %, 60-70 wt %, 60-65 wt %, 65-100 wt %, 65-95 wt %, 65-90 wt %, 65-85 wt %, 65-80 wt %, 65-75 wt %, 65-70 wt %, 70-100 wt %, 70-95 wt %, 70-90 wt %, 70-85 wt %, 70-80 wt %, 70-75 wt %, 75-100 wt %, 75-95 wt %, 75-90 wt %, 75-85 wt %, 75-80 wt %, 80-100 wt %, 80-95 wt %, 80-90 wt %, 80-85 wt %, 85-100 wt %, 85-95 wt %, 85-90 wt %, 90-100 wt %, 90-95 wt %, 95-100 wt %.

In some embodiments, the one or more steviol glycosides of the present application comprise RB in an amount of 0.1-100 wt %, 0.1-95 wt %, 0.1-90 wt %, 0.1-85 wt %, 0.1-80 wt %, 0.1-75 wt %, 0.1-70 wt %, 0.1-65 wt %, 0.1-60 wt %, 0.1-55 wt %, 0.1-50 wt %, 0.1-45 wt %, 0.1-40 wt %, 0.1-35 wt %, 0.1-30 wt %, 0.1-25 wt %, 0.1-20 wt %, 0.1-15 wt %, 0.1-10 wt %, 0.1-8 wt %, 0.1-5 wt %, 0.1-2 wt %, 0.1-1.5 wt %, 0.1-1 wt %, 0.1-0.5 wt %, 0.5-100 wt %, 0.5-95 wt %, 0.5-90 wt %, 0.5-85 wt %, 0.5-80 wt %, 0.5-75 wt %, 0.5-70 wt %, 0.5-65 wt %, 0.5-60 wt %, 0.5-55 wt %, 0.5-50 wt %, 0.5-45 wt %, 0.5-40 wt %, 0.5-35 wt %, 0.5-30 wt %, 0.5-25 wt %, 0.5-20 wt %, 0.5-15 wt %, 0.5-10 wt %, 0.5-8 wt %, 0.5-7 wt %, 0.5-6 wt %, 0.5-5 wt %, 0.5-4.5 wt %, 0.5-4 wt %, 0.5-3.5 wt %, 0.5-3 wt %, 0.5-2.5 wt %, 0.5-2 wt %, 0.5-1.5 wt %, 0.5-1 wt %, 1-100 wt %, 1-95 wt %, 1-90 wt %, 1-85 wt %, 1-80 wt %, 1-75 wt %, 1-70 wt %, 1-65 wt %, 1-60 wt %, 1-55 wt %, 1-50 wt %, 1-45 wt %, 1-40 wt %, 1-35 wt %, 1-30 wt %, 1-25 wt %, 1-20 wt %, 1-15 wt %, 1-10 wt %, 1-8 wt %, 1-7 wt %, 1-6 wt %, 1-5 wt %, 1-4.5 wt %, 1-4 wt %, 1-3.5 wt %, 1-3 wt %, 1-2.5 wt %, 1-2 wt %, 1-1.5 wt %, 1.5-100 wt %, 1.5-95 wt %, 1.5-90 wt %, 1.5-85 wt %, 1.5-80 wt %, 1.5-75 wt %, 1.5-70 wt %, 1.5-65 wt %, 1.5-60 wt %, 1.5-55 wt %, 1.5-50 wt %, 1.5-45 wt %, 1.5-40 wt %, 1.5-35 wt %, 1.5-30 wt %, 1.5-25 wt %, 1.5-20 wt %, 1.5-15 wt %, 1.5-10 wt %, 1.5-8 wt %, 1.5-7 wt %, 1.5-6 wt %, 1.5-5.5 wt %, 1.5-5 wt %, 1.5-4.5 wt %, 1.5-4 wt %, 1.5-3.5 wt %, 1.5-2.5 wt %, 1.5-2 wt %, 5-100 wt %, 5-95 wt %, 5-90 wt %, 5-85 wt %, 5-80 wt %, 5-75 wt %, 5-70 wt %, 5-65 wt %, 5-60 wt %, 5-55 wt %, 5-50 wt %, 5-45 wt %, 5-40 wt %, 5-35 wt %, 5-30 wt %, 5-25 wt %, 5-20 wt %, 5-15 wt %, 5-10 wt %, 5-8 wt %, 10-100 wt %, 10-95 wt %, 10-90 wt %, 10-85 wt %, 10-80 wt %, 10-75 wt %, 10-70 wt %, 10-65 wt %, 10-60 wt %, 10-55 wt %, 10-50 wt %, 10-45 wt %, 10-40 wt %, 10-35 wt %, 10-30 wt %, 10-25 wt %, 10-20 wt %, 10-15 wt %, 15-100 wt %, 15-95 wt %, 15-90 wt %, 15-85 wt %, 15-80 wt %, 15-75 wt %, 15-70 wt %, 15-65 wt %, 15-60 wt %, 15-55 wt %, 15-50 wt %, 15-45 wt %, 15-40 wt %, 15-35 wt %, 15-30 wt %, 15-25 wt %, 15-20 wt %, 20-100 wt %, 20-95 wt %, 20-90 wt %, 20-85 wt %, 20-80 wt %, 20-75 wt %, 20-70 wt %, 20-65 wt %, 20-60 wt %, 20-55 wt %, 20-50 wt %, 20-45 wt %, 20-40 wt %, 20-35 wt %, 20-30 wt %, 20-25 wt %, 30-100 wt %, 30-95 wt %, 30-90 wt %, 30-85 wt %, 30-80 wt %, 30-75 wt %, 30-70 wt %, 30-65 wt %, 30-60 wt %, 30-55 wt %, 30-50 wt %, 30-45 wt %, 30-40 wt %, 30-35 wt %, 40-100 wt %, 40-95 wt %, 40-90 wt %, 40-85 wt %, 40-80 wt %, 40-75 wt %, 40-70 wt %, 40-65 wt %, 40-60 wt %, 40-55 wt %, 40-50 wt %, 40-45 wt %, 50-100 wt %, 50-95 wt %, 50-90 wt %, 50-85 wt %, 50-80 wt %, 50-75 wt %, 50-70 wt %, 50-65 wt %, 50-60 wt %, 50-55 wt %, 60-100 wt %, 60-95 wt %, 60-90 wt %, 60-85 wt %, 60-80 wt %, 60-75 wt %, 60-70 wt %, 60-65 wt %, 70-100 wt %, 70-95 wt %, 70-90 wt %, 70-85 wt %, 70-80 wt %, 70-75 wt %, 80-100 wt %, 80-95 wt %, 80-90 wt %, 80-85 wt %, 90-100 wt %, 90-95 wt %, 95-100 wt %.

### Non-Steviol Glycoside Sweeteners

The one or more non-steviol glycoside sweeteners in the steviol glycoside composition of the present application include, but are not limited to, natural sweeteners, natural high potency sweeteners, synthetic sweeteners, or a combination thereof.

As used herein, a “natural sweetener” refers to any sweetener found naturally in nature, excluding steviol glycosides. The phrase “natural high potency sweetener” refers to any sweetener found naturally in nature that has a sweetness potency greater than sucrose, fructose, or glucose, yet has less calories. The phrase “synthetic sweetener” refers to any composition which is not found naturally in nature that has a sweetness potency greater than sucrose, fructose, or glucose, yet has less calories. As used herein, the terms “natural sweeteners,” “natural high potency sweeteners” and “synthetic sweeteners” do not include steviol glycosides.

In certain embodiments, the non-steviol glycoside sweetener includes at least one carbohydrate sweetener. Exemplary carbohydrate sweeteners are selected from, but not limited to, the group consisting of sucrose, glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, fucose, rhamnose, arabinose, turanose, sialose and combinations thereof.

Other suitable non-steviol glycoside sweeteners include burned sugar from all sources, mogroside IV, mogroside V, Luo han guo, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I, sugar alcohols, such as erythritol, sucralose, acesulfame acid and salts thereof, such as acesulfame-K and potassium acesulfame; L-α-aspartyl-L-phenylalanine methylester (Aspartame), N—[N-[3-(3-hydroxy-4-methoxyphenyl) propyl]-α-aspartyl]-L-phenylalanine (Advantame), N—[N-[3-(3-hydroxy-4-methoxyphenyl) propyl]-α-aspartyl]-L-phenylalanine 1-methyl ester (ANS9801), alitame, saccharin and salts thereof, neohesperidin dihydrochalcone, cyclamate, cyclamic acid and salts thereof, neotame, trehalose, raffinose, cellobiose, tagatose, DOLCIA PRIMA™, allulose, inulin, and combinations thereof.

The non-steviol glycoside sweetener may be a caloric sweetener or mixture of caloric sweeteners. Caloric sweeteners include sucrose, fructose, glucose, high fructose corn/starch syrup, a beet sugar, a cane sugar, and combinations thereof.

In certain embodiments, the non-steviol glycoside sweetener is a rare sugar selected from sorbose, lyxose, ribulose, xylose, xylulose, D-allose, L-ribose, D-tagatose, L-glucose, L-fucose, L-arabinose, turanose and combinations thereof. The rare sugars can be present in the sweetener compositions in an amount from about 0.5 wt % to about 3.0 wt %, such as, for example, about 0.5 wt % to about 2.5 wt %, about 0.5 wt % to about 2.0 wt %, about 0.5 wt % to about 1.5 wt %, about 0.5 wt % to about 1.0 wt %, about 1.0 wt % to about 3.0 wt %, about 1.0 wt % to about 2.5 wt %, about 1.0 wt % to about 2.0 wt %, about 1.0 wt % to about 1.5 wt %, about 2.0 wt % to about 3.0 wt % and about 2.0 wt % to about 2.5 wt %.

In certain embodiments, the non-steviol glycoside sweetener is a synthetic sweetener, such as sucralose and saccharin.

The steviol glycoside composition of the present application comprise one or more non-steviol glycoside sweetener in an amount of 0.01-0.05 wt %, 0.01-0.1 wt %, 0.01-0.3 wt %, 0.01-0.5 wt %, 0.01-1 wt %, 0.01-2 wt %, 0.01-3 wt %, 0.01-5 wt %, 0.01-10 wt %, 0.01-20 wt %, 0.01-30 wt %, 0.05-0.1 wt %, 0.05-0.3 wt %, 0.05-0.5 wt %, 0.05-1 wt %, 0.05-2 wt %, 0.05-3 wt %, 0.05-5 wt %, 0.05-10 wt %, 0.05-20 wt %, 0.05-30 wt %, 0.1-0.3 wt %, 0.1-0.5 wt %, 0.1-1 wt %, 0.1-2 wt %, 0.1-3 wt %, 0.1-5 wt %, 0.1-10 wt %, 0.1-20 wt %, 0.1-30 wt %, 0.5-1 wt %, 0.5-1.5 wt %, 0.5-1.7 wt %, 0.5-2 wt %, 0.5-3 wt %, 0.5-5 wt %, 0.5-10 wt %, 0.5-20 wt %, 0.5-30 wt %, 0.7-1 wt %, 0.7-1.3 wt %, 0.7-1.5 wt %, 0.8-1.3 wt %, 0.8-1.5 wt %, 0.9-1.3 wt %, 0.9-1.5 wt %, 1-1.3 wt %, 1-1.5 wt %, 1-1.7 wt %, 1-2 wt %, 1-3 wt %, 1-5 wt %, 1-10 wt %, 1-20 wt %, 1-30 wt %, 1.2-1.5 wt %, 1.2-1.7 wt %, 1.2-2 wt %, 1.2-3 wt %, 1.2-5 wt %, 1.4-2.0 wt %, 1.4-2.2 wt %, 1.4-2.4 wt %, 1.4-2.6 wt %, 1.4-2.8 wt %, 1.4-3 wt %, 1.6-2.2 wt %, 1.6-2.4 wt %, 1.6-2.6 wt %, 1.6-2.8 wt %, 1.6-3 wt %, 1.8-2.2 wt %, 1.8-2.4 wt %, 1.8-2.6 wt %, 1.8-2.8 wt %, 1.8-3 wt %, 2-3 wt %, 2-4 wt %, 2-5 wt %, 2-10 wt %, 2-20 wt %, 2-30 wt %, 5-10 wt %, 5-20 wt %, 5-30 wt %, 10-20 wt %, 10-30 wt %, 20-30 wt %.

### Salts

The one or more salts in the steviol glycoside composition of the present application can be organic salts or inorganic salts. As used herein, the term “salt” refers to salts that retain the desired chemical activity of the steviol glycoside compositions of the present application and are safe for human or animal consumption in a generally acceptable range.

In some embodiments, the one or more salts are salts formed with metal cations such as calcium, bismuth, barium, magnesium, aluminum, copper, cobalt, nickel, cadmium, sodium, potassium, and the like, or with a cation formed from ammonia, N,N-dibenzylethylenediamine, D-glucosamine, ethanolamine, diethanolamine, triethanolamine, N-methylglucamine tetraethylammonium, or ethylenediamine.

In some embodiments, the one or more salts are formed with inorganic acids, such as hydrochloric acid, hydrobromic acid, sulfuric acid, nitric acid, phosphoric acid, and the like; or formed with organic acids, such as acetic acid, propionic acid, hexanoic acid, cyclopentanepropionic acid, glycolic acid, pyruvic acid, lactic acid, malonic acid, succinic acid, malic acid, maleic acid, fumaric acid, tartaric acid, citric acid, benzoic acid, 3-(4-hydroxybenzoyl)benzoic acid, cinnamic acid, mandelic acid, methanesulfonic acid, ethanesulfonic acid, 1,2-ethane-disulfonic acid, 2-hydroxyethanesulfonic acid, benzenesulfonic acid, 4-chlorobenzenesulfonic acid, 2-naphthalenesulfonic acid, 4-toluenesulfonic acid, camphorsulfonic acid, 4-methylbicyclo[2.2.2]-oct-2-ene-1-carboxylic acid, glucoheptonic acid, 3-phenylpropionic acid, trimethylacetic acid, tertiary butylacetic acid, lauryl sulfuric acid, gluconic acid, glutamic acid, hydroxynaphthoic acid, salicylic acid, stearic acid and muconic acid.

In particular embodiments, inorganic salts include, but are not limited to, sodium chloride, sodium carbonate, sodium bicarbonate, sodium acetate, sodium sulfide, sodium sulfate, sodium phosphate, potassium chloride, potassium citrate, potassium carbonate, potassiumn bicarbonate, potassium acetate, europium chloride (EuCl₃), gadolinium chloride (GdCl₃), terbium chloride (TbCl₃), magnesium sulfate, alum, magnesium chloride, mono-, di-, tri-basic sodium or potassium salts of phosphoric acid (e.g., inorganic phosphates), salts of hydrochloric acid (e.g., inorganic chlorides), sodium carbonate, sodium bisulfate, and sodium bicarbonate. Suitable organic salts include, but are not limited to, choline chloride, alginic acid sodium salt (sodium alginate), glucoheptonic acid sodium salt, gluconic acid sodium salt (sodium gluconate), gluconic acid potassium salt (potassium gluconate), guanidine HCl, glucosamine HCl, amiloride HCl, monosodium glutamate (MSG), adenosine monophosphate salt, magnesium gluconate, potassium tartrate (monohydrate), and sodium tartrate (dihydrate).

In certain embodiments, the salt is a metal or metal alkali halide, a metal or metal alkali carbonate or bicarbonate, or a metal or metal alkali phosphate, biphosphate, pyrophosphate, triphosphate, metaphosphate, or metabisulfate thereof. In certain particular embodiments, the salt is an inorganic salt that comprises sodium, potassium, calcium, or magnesium. In some embodiments, the salt is a sodium salt or a potassium salt.

The salt forms can be added to the sweetener compositions in the same amounts as their acid or base forms.

Alternative salts include various chloride or sulfate salts, such as sodium chloride, potassium chloride, magnesium chloride, sodium sulfate, magnesium sulfate, and potassium sulfate, or any edible salt.

In some embodiments, the one or more non-steviol glycoside salts comprises one or more amino acid salts. In some embodiments, the one or more non-steviol glycoside salts comprises one or more poly-amino acid salts. In some embodiments, the one or more non-steviol glycoside salts comprises one or more sugar acid salts.

In some embodiments, the one or more salts comprise salts of steviol glycosides (i.e., SG salts, such as salts of RB and salts of STB).

Regardless of the salt used in the present compositions, the salt content in a composition is calculated based on the weight of sodium chloride. More specifically, the salt content (based on weight of NaC) may be determined by determining the total ash content of a sample according to the general method for determining total ash content as set forth in FAO JECFA MONOGRAPHS, vol. 4, 2007. The weight of sodium chloride is determined from the weight of sodium oxide multiplied by a factor of 1.89. For example, if the total ash content of 100 g steviol glycoside composition is I g, the steviol glycoside composition has a salt content of 1.89 wt %.

In some embodiments, the steviol glycoside composition of the present application comprise one or more salts in an amount of 0.0005-0.001 wt %, 0.0005-0.005 wt %, 0.0005-0.01 wt %, 0.0005-0.05 wt %, 0.0005-0.1 wt %, 0.0005-0.2 wt %, 0.0005-0.3 wt %, 0.0005-0.5 wt %, 0.0005-1 wt %, 0.0005-2 wt %, 0.0005-5 wt %, 0.001-0.005 wt %, 0.001-0.01 wt %, 0.001-0.05 wt %, 0.001-0.1 wt %, 0.001-0.2 wt %, 0.001-0.3 wt %, 0.001-0.5 wt %, 0.001-1 wt %, 0.001-2 wt %, 0.001-5 wt %, 0.005-0.01 wt %, 0.005-0.05 wt %, 0.005-0.1 wt %, 0.005-0.2 wt %, 0.005-0.3 wt %, 0.005-0.5 wt %, 0.005-1 wt %, 0.005-2 wt %, 0.005-5 wt %, 0.01-0.05 wt %, 0.01-0.1 wt %, 0.01-0.2 wt %, 0.01-0.3 wt %, 0.01-0.5 wt %, 0.01-1 wt %, 0.01-2 wt %, 0.01-5 wt %, 0.05-0.1 wt %, 0.05-0.2 wt %, 0.05-0.3 wt %, 0.05-0.5 wt %, 0.05-1 wt %, 0.05-2 wt %, 0.05-5 wt %, 0.1-0.2 wt %, 0.1-0.3 wt %, 0.1-0.5 wt %, 0.1-1 wt %, 0.1-2 wt %, 0.1-5 wt %/a, 0.2-0.3 wt %, 0.2-0.5 wt %, 0.2-1 wt %, 0.2-2 wt %, 0.2-5 wt %, 0.3-0.5 wt %, 0.3-1 wt %, 0.3-2 wt %, 0.3-5 wt %, 0.5-1 wt %, 0.5-2 wt %, 0.5-5 wt %, 1-2 wt %, 1-5 wt % or 2-5 wt %.

In some embodiments, the steviol glycoside composition of the present application comprises between 20-90 wt % RA, between 0.1-15 wt % RB, between 0.01-5 wt % non-steviol glycoside sweetener and between 0.001-1 wt % salt. In one embodiment, the steviol glycoside composition further comprises 0-78.88% of non-RA and non-RB steviol glycosides. In some embodiments, the steviol glycoside composition further comprises 2-40 wt % ST and 0-2 wt % STB. In some embodiments, the steviol glycoside composition further comprises 2-40 wt % ST and 0.01-2 wt % STB.

In some embodiments, the steviol glycoside composition comprises between 30-85 wt % RA, between 0.5-12 wt % RB, between 0.03-4 wt % non-steviol glycoside sweetener and between 0.003-0.5 wt % salt. In some embodiments, the steviol glycoside composition further comprises 20-40 wt % ST and 0-1 wt % STB. In some embodiments, the steviol glycoside composition further comprises 20-40 wt % ST and 0.01-1 wt % STB.

In some embodiments, the steviol glycoside composition comprises between 40-80 wt % RA, between 1-10 wt % RB, between 0.05-3 wt % non-steviol glycoside sweetener and between 0.01-0.5 wt % salt. In some embodiments, the steviol glycoside composition further comprises 20-40 wt % ST and 0-0.4 wt % STB. In some embodiments, the steviol glycoside composition further comprises 20-40 wt % ST and 0-1 wt % STB. In some embodiments, the steviol glycoside composition further comprises 20-40 wt % ST and 0.01-1 wt % STB.

In some embodiments, the steviol glycoside composition comprises between 50-70 wt % RA, between 2-5 wt % RB, between 0.1-1 wt % non-steviol glycoside sweetener and between 0.02-0.2 wt % salt. In some embodiments, the steviol glycoside composition further comprises 20-40 wt % ST and about 0.2-0.5 wt % STB.

In some embodiments, the steviol glycoside composition comprises between 75-85 wt % RA, between 4-10 wt % RB, between 1-2 wt % non-steviol glycoside sweetener and between 0.1-0.3 wt % salt. In some embodiments, the steviol glycoside composition further comprises 2-4 wt % ST.

In some embodiments, the steviol glycoside composition comprises between 45-60 wt % RA, between 1-4 wt % RB, between 1-2 wt % non-steviol glycoside sweetener and between 0.1-0.3 wt % salt. In some embodiments, the steviol glycoside composition further comprises 25-40 wt % ST and 0.5-1.5 wt % STB.

In some embodiments, the steviol glycoside composition comprises essentially purified RD, essentially purified RM, or a mixture essentially containing purified RD and purified RM. In some further embodiments, the content of essentially purified RD, essentially purified RM, or a mixture essentially containing purified RD and purified RM is in the range of 1 wt % to 99 wt %, 2 wt % to 99 wt %, 3 wt % to 99 wt %, 4 wt % to 99 wt %, 5 wt % to 99 wt %, 6 wt % to 99 wt %, 7 wt % to 99 wt %, 8 wt % to 99 wt %, 9 wt % to 99 wt %, 10 wt % to 99 wt %, 15 wt % to 99 wt %, 20 wt % to 99 wt %, 25 wt % to 99 wt %, 30 wt % to 99 wt %, 35 wt % to 99 wt %, 40 wt % to 99 wt %, 45 wt % to 99 wt %, 50 wt % to 99 wt %, 55 wt % to 99 wt %, 60 wt % to 99 wt %, 65 wt % to 99 wt %, 70 wt % to 99 wt %, 75 wt % to 99 wt %, 80 wt % to 99 wt %, 85 wt % to 99 wt %, 90 wt % to 99 wt %, 95 wt % to 99 wt %, 10 wt % to 95 wt %, 20 wt % to 95 wt %, 30 wt % to 95 wt %, 40 wt % to 9 wt 5%, 50 wt % to 95 wt %, 60 wt % to 95 wt %, 70 wt % to 95 wt %, 80 wt % to 95 wt %, 10 wt % to 90 wt %, 20 wt % to 90 wt %, 30 wt % to 90 wt %, 40 wt % to 90 wt %, 50 wt % to 90 wt %, 60 wt % to 90 wt %, 70 wt % to 90 wt %, 80 wt % to 90 wt %, 10 wt % to 80 wt %, 20 wt % to 80 wt %, 30 wt % to 80 wt %, 40 wt % to 80 wt %, 50 wt % to 80 wt %, 60 wt % to 80 wt %, 70 wt % to 80 wt %, 10 wt % to 70 wt %, 20 wt % to 70 wt %, 30 wt % to 70 wt %, 40 wt % to 70 wt %, 50 wt % to 70 wt %, 60 wt % to 70 wt %, 10 wt % to 60 wt %, 20 wt % to 60 wt %, 30 wt % to 60 wt %, 40 wt % to 60 wt %, 50 wt % to 60 wt, 10 wt % to 50 wt %, 20 wt % to 50 wt %, 30 wt % to 50 wt %, 40 wt % to 50 wt %, 10 wt % to 40 wt %, 20 wt % to 40 wt, 30 t % to 40 wt %, 10 wt % to 30 wt %, 20 wt % to 30 wt % or 10 wt % to 20 wt %.

In some embodiments, the steviol glycoside composition comprises 50-85 wt % RA, 2-10 wt % RB, 0.1-2 wt % non-steviol glycoside sweetener and 0.01-0.3 wt % salt.

In some embodiments, the steviol glycoside composition comprises 50-70 wt % RA, 2-5 wt % RB, 0.1-1 wt % non-steviol glycoside sweetener and 0.02-0.2 wt % salt.

In some embodiments, the steviol glycoside composition comprises 75-85 wt % RA, 4-10 wt % RB, 1-2 wt % non-steviol glycoside sweetener and 0.1-0.3 wt % salt.

In some embodiments, the steviol glycoside composition comprises 45-60 wt % RA, 1-4 wt % RB, 1-2 wt % non-steviol glycoside sweetener and 0.1-0.3 wt % salt.

In some embodiments, the non-steviol glycoside sweetener in the steviol glycoside composition of the present application is glucose.

In some embodiments, the salt in the steviol glycoside composition of the present application is a sodium salt. In some embodiments, the sodium salt is NaCl.

In some embodiments, the RB comprises a salt of RB. In some embodiments, the salt of RB is a sodium salt of RB. In some embodiments, the RB in the steviol glycoside composition is the hydrolysis product of RA.

In some embodiments, the steviol glycoside composition further comprises ST and STB. In some embodiments, the STB comprises a salt of STB. In some embodiments, the salt of STB is a sodium salt of STB. In some embodiments, the STB in the steviol glycoside composition is the hydrolysis product of ST.

In some embodiments, the steviol glycoside composition comprises a blend of one or more steviol glycosides. In some embodiments, different steviol glycosides are used as starting materials for hydrolysis. In other embodiments, partially hydrolyzed materials are blended with steviol glycosides.

In some embodiments, the steviol glycoside composition comprises a blend of (A) an alkali hydrolysis product of a steviol glycoside composition and (B) one or more non-hydrolyzed steviol glycoside composition. In some embodiments, component (A) is the alkali hydrolysis product of a steviol glycoside composition selected from the group consisting of RA20, RA30, RA40, RA50, RA60, RA80, RA90, RA97, RA99 and RA100, while component (B) is selected from the group consisting of RA20, RA30, RA40, RA50, RA60, RA80, RA90, RA97, RA99 and RA100.

In some embodiments, the steviol glycoside composition comprises an alkali hydrolysis product of RA50, and has an improved solubility and sensory profiles compared to RA50.

In some embodiments, the steviol glycoside composition comprises a blend of RA50 and an alkali hydrolysis product of RA50, and has an improved solubility and sensory profiles compared to RA50.

In some embodiments, the steviol glycoside composition comprises a blend of (A) an alkali hydrolysis product of RA99, and (B) one or more non-hydrolyzed steviol glycoside composition selected from the group consisting of RA50, RA60 and RA80, RA90, RA97 and RA99, and has an improved solubility and sensory profiles compared to RA99, RA97 or RA50.

In some embodiments, the weight ratio of B:A is in the range of 9:1 to 1:9, 8:2 to 2:8, 7:3 to 3:7, or 6:4 to 4:6.

In some embodiments, the steviol glycoside composition of the present application comprises between 40-80 wt % RA, between 1.5-8 wt % RB, between 0.1-2.5 wt % glucose and between 0.01-0.3 wt % salt. In some embodiments, the salt comprises a sodium salt of RB. In some embodiments, the RB is a hydrolysis product of RA. In some embodiments, the steviol glycoside composition further comprises 20-40 wt % ST and 0-1 wt % STB. In some embodiments, the salt further comprises a sodium salt of STB.

In some embodiments, the steviol glycoside composition comprises between 40-80 wt % RA, between 1-5 wt % RB, between 0.05-2 wt % non-steviol glycoside sweetener and between 0.005-0.3 wt % salt.

In some embodiments, the steviol glycoside composition comprises between 75-95 wt % RA, between 4-20 wt % RB, between 0.5-3 wt % non-steviol glycoside sweetener and between 0.05-0.5 wt % salt.

In some embodiments, the steviol glycoside composition comprises between 50-65 wt % RA, between 1.5-3.5 wt % RB, between 0.1-1 wt % non-steviol glycoside sweetener and between 0.01-0.15 wt % salt.

In some embodiments, the steviol glycoside composition comprises between 60-75 wt % RA, between 1.5-3.5 wt % RB, between 0.1-1 wt % non-steviol glycoside sweetener and between 0.01-0.15 wt % salt.

In some embodiments, the steviol glycoside composition comprises between 40-60 wt % RA, between 1.5-3.5 wt % RB, between 0.1-1 wt % non-steviol glycoside sweetener and between 0.01-0.15 wt % salt.

In some embodiments, the steviol glycoside composition comprises between 75-95 wt % RA, between 4-20 wt % RB, between 0.5-2 wt % non-steviol glycoside sweetener and between 0.1-0.2 wt % salt.

In some embodiments, the steviol glycoside composition comprises between 75-95 wt % RA, between 7-20 wt % RB, between 1-3 wt % non-steviol glycoside sweetener and between 0.2-0.3 wt % salt.

In some embodiments, the steviol glycoside composition further comprises 0.01-10 wt %, 0.01-5 wt %, 0.01-2 wt %, 0.01-1 wt %, 0.01-0.5 wt %, 0.01-0.2 wt %, 0.01-0.1 wt %, 0.01-0.05 wt %, 0.02-10 wt %, 0.02-5 wt %, 0.02-2 wt %, 0.02-1 wt %, 0.02-0.5 wt %, 0.02-0.2 wt %, 0.02-0.1 wt %, 0.02-0.05 wt %, 0.05-10 wt %, 0.05-5 wt %, 0.05-2 wt %, 0.05-1 wt %, 0.05-0.5 wt %, 0.05-0.2 wt %, 0.1-10 wt %, 0.1-5 wt %, 0.1-2 wt %, 0.1-1 wt %, 0.1-0.5 wt %, 0.2-10 wt %, 0.2-5 wt %, 0.2-2 wt %, 0.121 wt %, 0.2-0.5 wt %, 0.5-10 wt %, 0.5-5 wt %, 0.5-2 wt %, 0.5-1 wt %, 1-10 wt %, 1-5 wt %, 1-2 wt %, 2-10 wt % or 2-5 wt % thaumatin.

### Blended Steviol Glycoside Composition

Another aspect of the present disclosure relates to a steviol glycoside composition comprising a hydrolysis product of a steviol glycoside composition (SG-HP) In some embodiments, the steviol glycoside composition comprises a blend of (A) a SG-HP and (B) a target steviol glycoside composition, wherein the steviol glycoside composition has an improved taste profile compared to the taste profile of the target steviol glycoside composition. In some embodiments, the target steviol glycoside composition is a steviol glycoside composition that has not been subjected to a hydrolysis reaction (non-SG-HP). In some embodiments, the target steviol glycoside composition is also a SG-HP.

In some embodiments, component (A) is a hydrolysis product, preferable an alkaline hydrolysis product, of a steviol glycoside composition selected from the group consisting of RA20, RA30, RA40, RA50, RA60, RA70, RA80, RA90, RA95, RA97, RA99 and combinations thereof; and component (B) is (i) a non-SG-HP selected from the group consisting of RA20, RA30, RA40, RA50, RA60, RA70, RA80, RA90, RA95, RA97, RA99, RA100 and combinations thereof, or (ii) a hydrolysis product, preferable an alkaline hydrolysis product, of a steviol glycoside composition selected from the group consisting of RA20, RA30, RA40, RA50, RA60, RA70, RA80, RA90, RA95, RA97, RA99, RA100 and combinations thereof.

In some embodiments, the RA20 has a TSG of about 20-25 wt %, about 20-30 wt %, about 20-35 wt %, about 20-40 wt %, about 20-45 wt %, about 20-50 wt %, about 20-55 wt %, about 20-60 wt %, about 20-65 wt %, about 20-70 wt %, about 20-80 wt %, about 20-85 wt %, about 20-90 wt %, about 20-95 wt % or about 20-100 wt %. In some embodiments, the RA30 has a TSG of about 30-35 wt %, about 30-40 wt %, about 30-45 wt %, about 30-50 wt %, about 30-55 wt %, about 30-60 wt %, about 30-65 wt %, about 30-70 wt %, about 30-75 wt %, about 30-80 wt %, about 30-85 wt %, about 30-90 wt %, about 30-95 wt % or about 30-100 wt %. In some embodiments, the RA40 has a TSG of about 40-45 wt %, about 40-50 wt %, about 40-55 wt %, about 40-60 wt %, about 40-65 wt %, about 40-70 wt %, about 40-75 wt %, about 40-80 wt %, about 40-85 wt %, about 40-90 wt %, about 40-95 wt % or about 40-100 wt %. In some embodiments, the RA50 has a TSG of about 50-55 wt %, about 50-60 wt %, about 50-65 wt %, about 50-70 wt %, about 50-75 wt %, about 50-80 wt %, about 50-85 wt %, about 50-90 wt %, about 50-95 wt % or about 50-100 wt %. In some embodiments, the RA60 has a TSG of about 60-65 wt %, about 60-70 wt %, about 60-75 wt %, about 60-85 wt %, about 60-90 wt %, about 60-95 wt % or about 60-100 wt %. In some embodiments, the RA70 has a TSG of about 70-75 wt %, about 70-80 wt %, about 70-85 wt %, about 70-90 wt %, about 70-95 wt %, about 70-100 wt %. In some embodiments, the RA80 has a TSG of about 80-85 wt %, about 80-90 wt %, about 80-95 wt % or about 80-100 wt %. In some embodiments, the RA90 has a TSG of about 90-95 wt % or about 90-100 wt %. In some embodiments, the RA95 has a TSG of about 95-100 wt %. In some embodiments, the RA97 has a TSG of about 97-100 wt %. In some embodiments, the RA99 has a TSG of about 99-100 wt %.

In some embodiments, the SG-HP is a alkaline hydrolysis product of RA20, RA30, RA40, RA50, RA60, RA70, RA80, RA90, RA95, RA97, RA99, RA99.5 or RA100 and that the percentage of RA hydrolysis is within the range of 10-20%, 10-30%, 10-40%, 10-50%, 10-60%, 10-70%, 10-80%, 10-90%, 20-30%, 20-40%, 20-50%, 20-60%, 20-70%, 20-80%, 20-90%, 30-40%, 30-50%, 30-60%, 30-70%, 30-80%, 30-90%, 40-50%, 40-60%, 40-70%, 40-80%, 40-90%, 50-60%, 50-70%, 50-80%, 50-90%, 60-70%, 60-80%, 60-90%, 70-80%, 70-90% or 80-90%.

In some embodiments, the weight ratio of component (A):component (B) is in a range of 0.5:9.5 to 9.5:0.5 and wherein the blended steviol glycoside composition has an improved sensory profile compared to component (B). In some embodiments, the weight ratio of component (A):component (B) is 1:9 to 9:1, 2:8 to 8:2 or 3:7 to 7:3.

In some embodiments, the steviol glycoside composition comprises a hydrolysis product of RA99 (RA99-HP). In some embodiments, the RA99-HP comprises 75-80 wt % RA, 15-20% RB, 0.1-1 wt % ST, 90-99 wt % TSG, 2-5 wt % glucose and 0.1-1 wt % salt.

In some embodiments, the steviol glycoside composition comprises a hydrolysis product of RA50 (RA50-HP). In some embodiments, the RA50-HP comprises 35-45 wt % RA, 5-15% RB, 20-30 wt % ST, 3-8% STB, 80-95 wt % TSG, 3-10 wt % glucose and 0.5-2 wt % salt.

In some embodiments, the steviol glycoside composition comprises RA50, wherein the RA50 comprises RA in an amount of 50-55 wt %, RB in an amount of 0.5-1 wt %, ST in an amount of 35-40 wt % and STB in an amount of 0.1-0.5 wt %, with TSG in an amount of 95-99 wt %.

In some embodiments, the steviol glycoside composition comprises RA60, wherein the RA60 comprises RA in an amount of 60-65 wt %, RB in an amount of 0.5-1 wt %, ST in an amount of 25-30 wt %, STB in an amount of 0.1-0.5 wt % and rubusoside in an amount of 0.1-0.5 wt i %, with TSG in an amount of 95-99 wt %.

In some embodiments, the steviol glycoside composition comprises RA80, wherein the RA80 comprises RA in an amount of 80-85 wt %, RB in an amount of 0.5-1 wt %, ST in an amount of 4-5 wt %, with TSG in an amount of 95-99 wt %.

In some embodiments, the steviol glycoside composition comprises RA97, wherein the RA97 comprises RA in an amount of 97-98 wt %, RB in an amount of 0.5-1 wt % and ST in an amount of 0.1-0.5 wt %, with TSG in an amount of 99-100 wt %.

In some embodiments, the one or more steviol glycosides of the present application comprise one or more hydrolysis products thereof, wherein the resulting hydrolysis products are formed from the one or more steviol glycosides. Thus, for example, RB may be formed as the hydrolysis product of RA, while STB may be formed as the hydrolysis product of ST).

By way of example, RA starting material can be dissolved in water (preferably potable water), alkali added, and the solution temperature raised preferably from 85° C. to 95° C., and more preferably to 90° C. The solution is stirred and is maintained at the selected temperature for a duration that provides the desired concentrations of RA and RB in the solution or until the alkali is exhausted. The preferred duration of alkaline hydrolysis at commercial scale is a minimum of 30 minutes; shorter durations typically do not exhaust the amounts of alkali used in commercial production. The pH of the final RA/RB solution is typically very close to pH 7.0, but pH can be adjusted (typically by adding HCl or NaOH). This process for producing an RA/RB solution from RA starting materials will also hydrolyze any ST present in the Stevia starting material to form STB.

The RA/RB (and ST/STB) solution produced as described above is brown in color, has a faint “burnt sugar” smell, and has a weak “caramel” taste. The brown color, burnt sugar smell, and caramel taste can be removed by column chromatography such as an activated charcoal column, a polymer resin adsorption column or with an ion exchange column as the chromatography matrix, binding the caramel components to the column while letting the steviol glycosides pass through. Depending upon the beverage, food, or other comestible in which the RA/RB (or ST/STB) is used, the brown color, burnt sugar smell, and caramel taste may be desirable, or unnoticeable; in either case, therefore, it would be unnecessary to remove the brown color, burnt sugar smell, and caramel taste by column chromatography.

In some embodiments, the starting or raw materials include >40 wt. % of total steviol glycosides, >50 wt. % of total steviol glycosides, >55 wt. % of total steviol glycosides, >60 wt. % of total glycosides, >65 wt. % of total steviol glycosides, >70 wt. % of total steviol glycosides, >75 wt. % of total steviol glycosides, >80 wt. % of total steviol glycosides >85 wt. % of total steviol glycosides, >90 wt. % of total steviol glycosides, >95 wt. % of total steviol glycosides, or >99 wt. % of total steviol glycosides. In some embodiments, the starting or raw materials include 40-99 wt %, 40-95 wt %, 40-90 wt %, 40-70 wt %, 40-60 wt %, 40-50 wt %, 45-99 wt %, 45-95 wt %, 45-90 wt %, 45-80 wt %, 45-70 wt %, 45-60 wt %, 45-50 wt %, 50-99 wt %, 50-95 wt %, 50-90 wt %, 50-80 wt %, 50-70 wt %, 50-60 wt %, 55-99 wt %, 55-95 wt %, 55-90 wt %, 55-80 wt %, 55-70 wt %, 55-60 wt %, 60-99 wt %, 60-95 wt %, 60-90 wt %, 60-80 wt %, 60-70 wt %, 65-99 wt %, 65-95 wt %, 65-90 wt %, 65-80 wt %, 65-70 wt %, 70-99 wt %, 70-95 wt %, 70-90 wt %, 70-80 wt %, 75-99 wt %, 75-95 wt %, 75-90 wt %, 75-80 wt %, 80-99 wt %, 80-95 wt %, 80-90 wt %, 85-99 wt %, 85-95 wt %, or 85-90 wt % of steviol glycosides. The solubility of the steviol glycoside products formed from the starting materials is a function of alkaline concentration in the hydrolysis step. Alternatively, in other embodiments, the hydrolysis step may be carried out in the extraction solution of Stevia or any composition of Stevia glycosides.

In some embodiments, RA is hydrolyzed to lyse a glucose unit from the glycoside chain on the C13 carbon of RA, which converts RA to RB, and thus the mole ratio of RB and glucose is about 1:1. In some embodiments, the starting or raw materials include >10 wt. % of RA and/or ST, >20 wt. % of RA and/or ST, >30 wt. % of RA and/or ST, >40 wt. % of RA and/or ST, >50 wt. % of RA and/or ST, >55 wt. % of RA and/or ST, >60 wt. % of RA and/or ST, >65 wt. % of RA and/or ST, >70 wt. % of RA and/or ST, >75 wt. % of RA and/or ST, >80 wt. % of RA and/or ST. >85 wt. % of RA and/or ST, >90 wt. % of RA and/or ST, >95 wt. % of RA and/or ST, or >99 wt. % of RA and/or ST. In some embodiments, the starting or raw materials include include 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 15-99 wt %, 15-95 wt %, 15-90 wt %, 15-80 wt %, 15-70 wt %, 15-60 wt %, 15-50 wt %, 15-40 wt %, 15-30 wt %, 15-20 wt %, 20-99 wt %, 20-95 wt %, 20-90 wt %, 20-80 wt %, 20-70 wt %, 20-60 wt %, 20-50 wt %, 20-40 wt %, 20-30 wt %, 25-99 wt %, 25-95 wt %, 25-90 wt %, 25-80 wt %, 25-70 wt %, 25-60 wt %, 25-50 wt %, 25-40 wt %, 25-30 wt %, 30-99 wt %, 30-95 wt %, 30-90 wt %, 30-80 wt %, 30-70 wt %, 30-60 wt %, 30-50 wt %, 30-40 wt %, 35-99 wt %, 35-95 wt %, 35-90 wt %, 35-80 wt %, 35-70 wt %, 35-60 wt %, 35-50 wt %, 35-40 wt %, 40-99 wt %, 40-95 wt %, 40-90 wt %, 40-80 wt %, 40-70 wt %, 40-60 wt %, 40-50 wt %, 45-99 wt %, 45-95 wt %, 45-90 wt %, 45-70 wt %, 45-60 wt %, 45-50 wt %, 50-99 wt %, 50-95 wt %, 50-90 wt %, 50-80 wt %, 50-70 wt %, 50-60 wt %, 55-99 wt %, 55-95 wt %, 55-90 wt %, 55-80 wt %, 55-70 wt %, 55-60 wt %, 60-99 wt %, 60-95 wt %, 60-90 wt %, 60-80 wt %, 60-70 wt %, 65-99 wt %, 65-95 wt %, 65-90 wt %, 65-80 wt %, 65-70 wt %, 70-99 wt %, 70-95 wt %, 70-90 wt %, 70-80 wt %, 75-99 wt %, 75-95 wt %, 75-90 wt %, 75-80 wt %, 80-99 wt %, 80-95 wt %, 80-90 wt %, 85-99 wt %, 85-95 wt %, or 85-90 wt % of RA and/or ST.

Alkaline hydrolysis of the starting or raw material is preferred for simplicity and economics. In some embodiments, enzymatic lysis of a glucose unit from the C13 carbon of RA or ST can also be used. In some embodiments, sodium hydroxide is used for hydrolysis of RA, ST and/or other steviol glycosides. In some embodiments, potassium hydroxide and other well-known alkali used in food processing are used.

Steviol Glycoside Composition Comprising Thaumatin, RM and/or RD

Another aspect of the present application relates to a blended steviol glycoside composition comprises (A) a SG-HP, a SG or both, and (B) thaumatin, with an A:B weight ratio of 5,000:1 to 5:1. In some embodiments, the steviol glycoside composition has an A:B ratio in the range of 2,000:1 to 5:1, 1,000:1 to 5:1, 500:1 to 5:1, 200:1 to 5:1, 100:1 to 5:1, 20:1 to 5:1, 2,000:1 to 20:1, 1,000:1 to 20:1, 500:1 to 20:1, 200:1 to 20:1, 100:1 to 20:1, 2,000:1 to 50:1, 1,000:1 to 50:1, 500:1 to 50:1, 200:1 to 50:1, 2,000:1 to 100:1, 1,000:1 to 100:1, 500:1 to 100:1, 200:1 to 100:1, 2,000:1 to 200:1, 1,000:1 to 200:1, 500:1 to 200:1 or 2,000:1 to 500:1. In some embodiments, component (A) is the steviol glycoside composition further comprises thaumatin.

In some embodiments, the component (A) comprises (1) RA20, RA30, RA40, RA50, RA60, RA70, RA80, RA90, RA95, RA97, RA99, RA99.5 or RA100, or (2) a hydrolysis product of RA20, RA30, RA40, RA50, RA60, RA70, RA80, RA90, RA95, RA97, RA99, RA99.5 or RA100, or (3) a mixture of (1) and (2).

Another aspect of the present application relates to a blend steviol glycoside composition that comprises (A) a SG-HP and (B) a target steviol glycoside composition comprising RD and/or RM. In some embodiments, the SG-HP is selected from the group consisting of the hydrolysis products of RA20, RA30, RA40, RA50, RA60, RA70, RA80, RA90, RA95, RA97, RA99, RA99.5 or RA100. In some embodiments, the SG-HP is an alkaline hydrolysis product of RA50. In some embodiments, the target steviol glycoside composition comprising RD in an amount of about 1-99 wt % of the target steviol glycoside composition. In some embodiments, the target steviol glycoside composition comprises RD in an amount of 20-95 wt %, 30-95 wt %, 40-95 wt %, 50-95 wt %, 60-95 wt %, 70-95 wt %, 80-95 wt %, 20-85 wt %, 30-85 wt %, 40-85 wt %, 50-85 wt %, 60-85 wt %, 70-85 wt %, 20-75 wt %, 30-75 wt %, 40-75 wt %, 50-75 wt %, 60-75 wt %, 20-65 wt %, 30-65 wt %, 40-65 wt %, 50-65 wt %, 20-55 wt %, 30-55 wt %, 40-55 wt %, 20-45 wt %, 30-45 wt % or 20-35 wt %, of the target steviol glycoside composition. In some embodiments, the target steviol glycoside composition comprises RD in an amount of 40-95 wt % of the target steviol glycoside composition. In some embodiments, the target steviol glycoside composition comprising RM in an amount of about 1-99 wt % of the target steviol glycoside composition. In some embodiments, In some embodiments, the target steviol glycoside composition comprises RM in an amount of 20-95 wt %, 30-95 wt %, 40-95 wt %, 50-95 wt %, 60-95 wt %, 70-95 wt %, 80-95 wt %, 20-85 wt %, 30-85 wt %, 40-85 wt %, 50-85 wt %, 60-85 wt %, 70-85 wt %, 20-75 wt %, 30-75 wt %, 40-75 wt %, 50-75 wt %, 60-75 wt %, 20-65 wt %, 30-65 wt %, 40-65 wt %, 50-65 wt %, 20-55 wt %, 30-55 wt %, 40-55 wt %, 20-45 wt %, 30-45 wt % or 20-35 wt %, of the target steviol glycoside composition. In some embodiments, the target steviol glycoside composition comprises RM in an amount of 50-95 wt % of the target steviol glycoside composition. In some embodiments, the final product (i.e., the mixture of the SG-HP and the target steviol glycoside composition) comprises RM, or RD, or both in the amount of 1-99 wt %, 10-95 wt %, 20-95 wt %, 30-95 wt %, 40-95 wt %, 50-95 wt %, 60-95 wt %, 70-95 wt %, 80-95 wt %, 10-95 wt %, 20-85 wt %, 30-85 wt %, 40-85 wt %, 50-85 wt %, 60-85 wt %, 70-85 wt %, 10-75 wt %, 20-75 wt %, 30-75 wt %, 40-75 wt %, 50-75 wt %, 60-75 wt %, 10-65 wt %, 20-65 wt %, 30-65 wt %, 40-65 wt %, 50-65 wt %, 10-55 wt %, 20-55 wt %, 30-55 wt %, 40-55 wt %, 10-45 wt %, 20-45 wt %, 30-45 wt %, 10-35 wt %, 20-35 wt % or 10-25 wt %. In some embodiments, the steviol glycoside composition comprises SG-HP (A) and the target steviol glycoside composition (B) at an A:B ratio in the range of 1:99 to 99:1, 1:95 to 95:1, 5:95 to 95:5, 1:10 to 10:1 or 1:5 to 5:1.

### Beverages

Another aspect of the present disclosure relates to a beverage that comprises the blended steviol glycoside composition of the present application. In some embodiments, the concentration of component (A) in the beverage is in the range of about 50 ppm to about 500 ppm. In some embodiments, the concentration of component (B) in the beverage is in the range of about 50 ppm to about 500 ppm. In some embodiments, the total concentration of component (A) and component (B) in the beverage is in the range of about 100 ppm to about 1,000 ppm.

In some embodiments, the beverage comprises component (A) in a concentration of about 50-100 ppm, about 50-150 ppm, about 50-200 ppm, about 50-250 ppm, about 50-300 ppm, about 50-350 ppm, about 50-400 ppm, about 50-450 ppm, about 50-500 ppm, about 100-150 ppm, about 100-200 ppm, about 100-250 ppm, about 100-300 ppm, about 100-350 ppm, about 100-400 ppm, about 100-450 ppm, about 100-500 ppm, about 150-200 ppm, about 150-250 ppm, about 150-300 ppm, about 150-350 ppm, about 150-400 ppm, about 150-450 ppm, about 150-500 ppm, about 200-250 ppm, about 200-300 ppm, about 200-350 ppm, about 200-400 ppm, about 200-450 ppm, about 200-500 ppm, about 250-300 ppm, about 250-350 ppm, about 250-400 ppm, about 250-450 ppm, about 250-500 ppm, about 300-350 ppm, about 300-400 ppm, about 300-450 ppm, about 300-500 ppm, about 350-400 ppm, about 350-450 ppm, about 350-500 ppm, about 400-450 ppm, about 400-500 ppm or about 450-500 ppm.

In some embodiments, the in the beverage comprises component (B) in a concentration of about 50-100 ppm, about 50-150 ppm, about 50-200 ppm, about 50-250 ppm, about 50-300 ppm, about 50-350 ppm, about 50-400 ppm, about 50-450 ppm, about 50-500 ppm, about 100-150 ppm, about 100-200 ppm, about 100-250 ppm, about 100-300 ppm, about 100-350 ppm, about 100-400 ppm, about 100-450 ppm, about 100-500 ppm, about 150-200 ppm, about 150-250 ppm, about 150-300 ppm, about 150-350 ppm, about 150-400 ppm, about 150-450 ppm, about 150-500 ppm, about 200-250 ppm, about 200-300 ppm, about 200-350 ppm, about 200-400 ppm, about 200-450 ppm, about 200-500 ppm, about 250-300 ppm, about 250-350 ppm, about 250-400 ppm, about 250-450 ppm, about 250-500 ppm, about 300-350 ppm, about 300-400 ppm, about 300-450 ppm, about 300-500 ppm, about 350-400 ppm, about 350-450 ppm, about 350-500 ppm, about 400-450 ppm, about 400-500 ppm or about 450-500 ppm.

In some embodiments, the in the beverage comprises component (A) and component (B) in a total concentration of about 100-150 ppm, about 100-200 ppm, about 100-250 ppm, about 100-300 ppm, about 100-350 ppm, about 100-400 ppm, about 100-450 ppm, about 100-500 ppm, about 100-550 ppm, about 100-600 ppm, about 100-650 ppm, about 100-700 ppm, about 100-750 ppm, about 100-800 ppm, about 100-850 ppm, about 100-900 ppm, about 100-950 ppm, about 100-1,000 ppm, about 150-200 ppm, about 150-250 ppm, about 150-300 ppm, about 150-350 ppm, about 150-400 ppm, about 150-450 ppm, about 150-500 ppm, about 150-550 ppm, about 150-600 ppm, about 150-650 ppm, about 150-700 ppm, about 150-750 ppm, about 150-800 ppm, about 150-850 ppm, about 150-900 ppm, about 150-950 ppm, about 150-1,000 ppm, about 200-250 ppm, about 200-300 ppm, about 200-350 ppm, about 200-400 ppm, about 200-450 ppm, about 200-500 ppm, about 200-550 ppm, about 200-600 ppm, about 200-650 ppm, about 200-700 ppm, about 200-750 ppm, about 200-800 ppm, about 200-850 ppm, about 200-900 ppm, about 200-950 ppm, about 200-1,000 ppm, about 250-300 ppm, about 250-350 ppm, about 250-400 ppm, about 250-450 ppm, about 250-550 ppm, about 250-600 ppm, about 250-650 ppm, about 250-700 ppm, about 250-750 ppm, about 250-800 ppm, about 250-850 ppm, about 250-900 ppm, about 250-950 ppm, about 250-1,000 ppm, about 300-350 ppm, about 300-400 ppm, about 300-450 ppm, about 300-500 ppm, about 300-550 ppm, about 300-600 ppm, about 300-650 ppm, about 300-700 ppm, about 300-750 ppm, about 300-800 ppm, about 300-850 ppm, about 300-900 ppm, about 300-950 ppm, about 300-1,000 ppm, about 350-400 ppm, about 350-450 ppm, about 350-500 ppm, about 350-550 ppm, about 350-600 ppm, about 350-650 ppm, about 350-700 ppm, about 350-750 ppm, about 350-800 ppm, about 350-850 ppm, about 350-900 ppm, about 350-950 ppm, about 350-1,000 ppm, about 400-450 ppm, about 400-500 ppm, about 400-550 ppm, about 400-600 ppm, about 400-650 ppm, about 400-700 ppm, about 400-750 ppm, about 400-800 ppm, about 400-850 ppm, about 400-900 ppm, about 400-1,000 ppm, about 450-500 ppm, about 450-550 ppm, about 450-600 ppm, about 450-650 ppm, about 450-700 ppm, about 450-750 ppm, about 450-800 ppm, about 450-850 ppm, about 450-900 ppm, about 450-950 ppm, about 450-1,000 ppm, about 500-550 ppm, about 500-600 ppm, about 500-650 ppm, about 500-700 ppm, about 500-750 ppm, about 500-800 ppm, about 500-850 ppm, about 500-900 ppm, about 500-950 ppm, about 500-1,000 ppm, about 550-600 ppm, about 550-650 ppm, about 550-700 ppm, about 550-750 ppm, about 550-800 ppm, about 550-850 ppm, about 550-900 ppm, about 550-950 ppm, about 550-1,000 ppm, about 600-650 ppm, about 600-700 ppm, about 600-750 ppm, about 600-800 ppm, about 600-850 ppm, about 600-900 ppm, about 600-950 ppm, about 600-1,000 ppm, about 650-700 ppm, about 650-750 ppm, about 650-800 ppm, about 650-850 ppm, about 650-900 ppm, about 650-950 ppm, about 650-1,000 ppm, about 700-750 ppm, about 700-800 ppm, about 700-850 ppm, about 700-900 ppm, about 700-950 ppm, about 700-1,000 ppm, about 750-800 ppm, about 750-850 ppm, about 750-900 ppm, about 750-950 ppm, about 750-1,000 ppm, about 800-850 ppm, about 800-900 ppm, about 800-950 ppm, about 800-1,000 ppm, about 850-900 ppm, about 850-950 ppm, about 850-1,000 ppm, about 900-950 ppm, about 900-1,000 ppm or about 950-1,000 ppm.

In some embodiments, the beverage further comprises thaumatin at a concentration range of 0.1-100 ppm, 0.1-30 ppm, 0.1-10 ppm, 0.1-3 ppm, 0.1-1 ppm, 0.1-0.3 ppm, 0.3-100 ppm, 0.3-30 ppm, 0.3-10 ppm, 0.3-3 ppm, 0.3-1 ppm, 0.5-7 ppm, 1-100 ppm, 1-30 ppm, 1-10 ppm, 1-3 ppm, 3-100 ppm, 3-30 ppm, 3-10 ppm, 10-100 ppm, 10-30 ppm or 30-100 ppm.

In some embodiments, the beverage further comprises an acid, wherein an aftertaste of the acid is masked by thaumatin. In some embodiments, the concentration of the acid is 50-50,000 ppm. In some embodiments, the concentration of the acid is about 50-200 ppm, about 50-500 ppm, about 50-1,000 ppm, about 50-2,000 ppm, about 50-5,000 ppm, about 50-10,000 ppm, about 50-25,000 ppm, about 50-50,000 ppm, about 200-500 ppm, about 200-1,000 ppm, about 200-2,000 ppm, about 200-5,000 ppm, about 200-10,000 ppm, about 200-25,000 ppm, about 200-50,000 ppm, about 500-1,000 ppm, about 500-2,000 ppm, about 500-5,000 ppm, about 500-10,000 ppm, about 500-25,000 ppm, about 500-50,000 ppm, about 1,000-2,000 ppm, about 1,000-5,000 ppm, about 1,000-10,000 ppm, about 1,000-25,000 ppm, about 1,000-50,000 ppm, about 2,000-5,000 ppm, about 2,000-10,000 ppm, about 2,000-25,000 ppm, about 2,000-50,000 ppm, about 5,000-10,000 ppm, about 5,000-25,000 ppm, about 5,000-50,000 ppm, about about 10,000-25,000 ppm or about 10,000-50,000 ppm. In some embodiments, the beverage has a pH value in the range of 1-14. In some embodiments, the beverage has a pH value in the range of 1-7, 1-6, 1-5, 1-4, 1-3, 1-2, 2-7, 2-6, 2-5, 2-4, 2-3, 3-7, 3-6, 3-5, 3-4, 4-7, 4-6, 4-5, 5-7, 5-6 or 6-7.

The acid can be an organic acid or an inorganic acid. In some embodiments, the acid is an organic acid selected from the group consisting of C2-C30 carboxylic acids, substituted hydroxyl C2-C30 carboxylic acids, butyric acid, substituted butyric acid, benzoic acid, substituted benzoic acids, substituted cinnamic acids, hydroxyacids, substituted hydroxybenzoic acids, anisic acid substituted cyclohexyl carboxylic acids, tannic acid, aconitic acid, lactic acid, tartaric acid, citric acid, isocitric acid, gluconic acid, glucoheptonic acids, adipic acid, hydroxycitric acid, malic acid, fruitaric acid, fumaric acid, maleic acid, succinic acid, chlorogenic acid, salicylic acid, creatine, caffeic acid, bile acids, acetic acid, ascorbic acid, alginic acid, erythorbic acid, polyglutamic acid, glucono delta lactone, and amino acids.

In some embodiments, the acid is an inorganic acid selected from the group consisting of phosphoric acid, phosphorous acid, polyphosphoric acid, hydrochloric acid, sulfuric acid and carbonic acid.

### Additional Agents

The steviol glycoside composition of the present application, whether made from purified steviol glycosides or from a mixture of hydrolyzed and unhydrolyzed steviol glycoside compositions, may further includes one or more additional agents selected from the group consisting of flavoring agents, minerals, organic acids and inorganic acids, polyols, nucleotides, bitter compounds, astringent compounds, proteins or protein hydrolysates, surfactants, gums and waxes, antioxidants, polymers, fatty acids, vitamins, preservatives, hydration agents and combinations thereof, as further described below.

Flavoring Agents

The flavoring agent can be natural, semi-synthetic, or synthetic. Suitable flavorants and flavoring ingredient additives for use in the steviol glycoside compositions of the present application include, but are not limited to, vanillin, vanilla extract, mango extract, cinnamon, citrus, coconut, ginger, viridiflorol, almond, bay, thyme, cedar leaf, nutmeg, allspice, sage, mace, menthol (including menthol without mint), an essential oil, such as an oil derived from a plant or a fruit, such as peppermint oil, spearmint oil, other mint oils, clove oil, cinnmamon oil, oil of wintergreen, or an oil of almonds; a plant extract, fruit extract or fruit essence from grape skin extract, grape seed extract, apple, banana, watermelon, pear, peach, grape, strawberry, raspberry, cherry, plum, pineapple, apricot, a flavoring agent comprising a citrus flavor, such as an extract, essence, or oil of lemon, lime, orange, tangerine, grapefruit, citron, kumquat, and combinations thereof.

Non-limiting examples of proprietary flavorants include Dohler™ Natural Flavoring Sweetness Enhancer K14323 (Dohler™, Darmstadt, Germany), Symrise™ Natural Flavor Mask for Sweeteners 161453 and 164126 (Symrise™, Holzminden, Germany), Natural Advantage™ Bitterness Blockers 1, 2, 9 and 10 (Natural Advantage™, Freehold, N.J., U.S.A.), and Sucramask™ (Creative Research Management, Stockton, Calif., U.S.A.).

In some embodiments, the flavoring agent is present in the steviol glycoside composition of the present application in a concentration from about 0.1 ppm to about 4,000 ppm, about 0.1 ppm to about 1,000 ppm, about 0.1 ppm to about 600 ppm, about 0.1 ppm to about 400 ppm, about 0.1 ppm to about 200 ppm, about 0.1 ppm to about 100 ppm, about 0.1 ppm to about 40 ppm, about 0.1 ppm to about 10 ppm, about 1 ppmn to about 4,000 ppm, about 1 ppm to about 1,000 ppm, about 1 ppm to about 600 ppm, about 1 ppm to about 400 ppm, about 1 ppm to about 200 ppm, about 1 ppm to about 100 ppm, about 1 ppm to about 40 ppm, about 1 ppm to about 10 ppm, about 10 ppm to about 4,000 ppm, about 10 ppm to about 1,000 ppm, about 10 ppm to about 600 ppm, about 10 ppm to about 400 ppm, about 10 ppm to about 200 ppm, about 10 ppm to about 100 ppm, about 10 ppm to about 40 ppm.

Minerals

Minerals, in accordance with the teachings of this application, comprise inorganic chemical elements required by living organisms. Minerals are comprised of a broad range of compositions (e.g., elements, simple salts, and complex silicates) and also vary broadly in crystalline structure. They may naturally occur in foods and beverages, may be added as a supplement, or may be consumed or administered separately from foods or beverages.

Minerals may be categorized as either bulk minerals, which are required in relatively large amounts, or trace minerals, which are required in relatively small amounts. Bulk minerals generally are required in amounts greater than or equal to about 100 mg per day and trace minerals are those that are required in amounts less than about 100 mg per day.

In particular embodiments of the present application, the mineral is chosen from bulk minerals, trace minerals or combinations thereof. Non-limiting examples of bulk minerals include calcium, chlorine, magnesium, phosphorous, potassium, sodium, and sulfur. Non-limiting examples of trace minerals include chromium, cobalt, copper, fluorine, iron, manganese, molybdenum, selenium, zinc, and iodine. Although iodine generally is classified as a trace mineral, it is required in larger quantities than other trace minerals and often is categorized as a bulk mineral.

In certain particular embodiments, the mineral is a trace mineral, believed to be necessary for human nutrition, non-limiting examples of which include bismuth, boron, lithium, nickel, rubidium, silicon, strontium, tellurium, tin, titanium, tungsten, and vanadium.

The minerals embodied herein may be in any form known to those of ordinary skill in the art. For example, in a particular embodiment the minerals may be in their ionic form, having either a positive or negative charge. In another particular embodiment the minerals may be in their molecular form. For example, sulfur and phosphorous often are found naturally as sulfates, sulfides, and phosphates.

Organic Acids and Inorganic Acid

Suitable organic acid additives include any compound which comprises a —COOH moiety, such as, for example, C2-C30 carboxylic acids, substituted hydroxyl C2-C30 carboxylic acids, butyric acid (ethyl esters), substituted butyric acid (ethyl esters), benzoic acid, substituted benzoic acids (e.g., 2,4-dihydroxybenzoic acid), substituted cinnamic acids, hydroxyacids, substituted hydroxybenzoic acids, anisic acid substituted cyclohexyl carboxylic acids, tannic acid, aconitic acid, lactic acid, tartaric acid, citric acid, isocitric acid, gluconic acid, glucoheptonic acids, adipic acid, hydroxycitric acid, malic acid, fruitaric acid (a blend of malic, fumaric, and tartaric acids), fumaric acid, maleic acid, succinic acid, chlorogenic acid, salicylic acid, creatine, caffeic acid, bile acids, acetic acid, ascorbic acid, alginic acid, erythorbic acid, polyglutamic acid, glucono delta lactone, and their alkali or alkaline earth metal salt derivatives thereof. In addition, the organic acid additives also may be in either the D- or L-configuration.

The examples of the organic acid additives described optionally may be substituted with at least one group chosen from hydrogen, alkyl, alkenyl, alkynyl, halo, haloalkyl, carboxyl, acyl, acyloxy, amino, amido, carboxyl derivatives, alkylamino, dialkylamino, arylamino, alkoxy, aryloxy, nitro, cyano, sulfo, thiol, imine, sulfonyl, sulfenyl, sulfinyl, sulfamyl, carboxalkoxy, carboxamido, phosphonyl, phosphinyl, phosphoryl, phosphino, thioester, thioether, anhydride, oximino, hydrazino, carbamyl, phosphor or phosphonato. In particular embodiments, the organic acid additive is present in the sweetener composition in an amount effective to provide a concentration from about 10 ppm to about 5,000 ppm when present in an orally consumable composition, such as, for example, a beverage.

Organic acids also include amino acids such as, aspartic acid, arginine, glycine, glutamic acid, proline, threonine, theanine, cysteine, cystine, alanine, valine, tyrosine, leucine, arabinose, trans-4-hydroxyproline, isoleucine, asparagine, serine, lysine, histidine, omithine, methionine, carnitine, aminobutyric acid (α-, β-, and/or δ-isomers), glutamine, hydroxyproline, taurine, norvaline and sarcosine. The amino acid may be in the D- or L-configuration and in the mono-, di-, or tri-form of the same or different amino acids. Additionally, the amino acids may be α-, β-, γ- and/or δ-isomers if appropriate. Combinations of the foregoing amino acids and their corresponding salts (e.g., sodium, potassium, calcium, magnesium salts or other alkali or alkaline earth metal salts thereof, or acid salts) also are suitable additives in some embodiments. The amino acids may be natural or synthetic. The amino acids also may be modified. Modified amino acids refers to any amino acid wherein at least one atom has been added, removed, substituted, or combinations thereof (e.g., N-alkyl amino acid, N-acyl amino acid, or N-methyl amino acid). Non-limiting examples of modified amino acids include amino acid derivatives such as trimethyl glycine, N-methyl-glycine, and N-methyl-alanine. As used herein, modified amino acids encompass both modified and unmodified amino acids.

As used herein, amino acids also encompass both peptides and polypeptides (e.g., dipeptides, tripeptides, tetrapeptides, and pentapeptides) such as glutathione and L-alanyl-L-glutamine. Suitable polyamino acid additives include poly-L-aspartic acid, poly-L-lysine (e.g., poly-L-a-lysine or poly-L-s-lysine), poly-L-omithine (e.g., poly-L-a-omithine or poly-L-s-ornithine), poly-L-arginine, other polymeric forms of amino acids, and salt forms thereof (e.g., calcium, potassium, sodium, or magnesium salts such as L-glutamic acid mono sodium salt). The poly-amino acid additives also may be in the D- or L-configuration. Additionally, the poly-amino acids may be α-, β-, γ-, δ-, and ε-isomers if appropriate. Combinations of the foregoing poly-amino acids and their corresponding salts (e.g., sodium, potassium, calcium, magnesium salts or other alkali or alkaline earth metal salts thereof or acid salts) also are suitable additives in some embodiments. The poly-amino acids described herein also may comprise co-polymers of different amino acids. The poly-amino acids may be natural or synthetic. The poly-amino acids also may be modified, such that at least one atom has been added, removed, substituted, or combinations thereof (e.g., N-alkyl poly-amino acid or N-acyl poly-amino acid). As used herein, poly-amino acids encompass both modified and unmodified poly-amino acids. For example, modified poly-amino acids include, but are not limited to, poly-amino acids of various molecular weights (MW), such as poly-L-a-lysine with a MW of 1,500, MW of 6,000, MW of 25,200, MW of 63,000, MW of 83,000, or MW of 300,000.

In particular embodiments, the amino acid is present in the steviol glycoside composition in an amount effective to provide a concentration from about 10 ppm to about 50,000 ppm when present in an orally consumable composition, such as, for example, a beverage. In another embodiment, the amino acid is present in the sweetener composition in an amount effective to provide a concentration from about 1,000 ppm to about 10,000 ppm when present in an orally consumable composition, such as, for example, from about 2,500 ppm to about 5,000 ppm or from about 250 ppm to about 7,500 ppm.

Suitable inorganic acid additives include, but are not limited to, phosphoric acid, phosphorous acid, polyphosphoric acid, hydrochloric acid, sulfuric acid, carbonic acid, sodium dihydrogen phosphate, and alkali or alkaline earth metal salts thereof (e.g., inositol hexaphosphate Mg/Ca).

The inorganic acid additive is present in the sweetener composition in an amount effective to provide a concentration from about 25 ppm to about 25,000 ppm when present in an orally consumable composition, such as, for example, a beverage.

Polyols

The term “polyol”, as used herein, refers to a molecule that contains more than one hydroxyl group. A polyol may be a diol, triol, or a tetraol which contains 2, 3, and 4 hydroxyl groups respectively. A polyol also may contain more than 4 hydroxyl groups, such as a pentaol, hexaol, heptaol, or the like, which contain 5, 6, or 7 hydroxyl groups, respectively. Additionally, a polyol also may be a sugar alcohol, polyhydric alcohol, or polyalcohol which is a reduced form of carbohydrate, wherein the carbonyl group (aldehyde or ketone, reducing sugar) has been reduced to a primary or secondary hydroxyl group.

Non-limiting examples of polyols in some embodiments include maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, and sugar alcohols or any other carbohydrates capable of being reduced which do not adversely affect taste.

In certain embodiments, the polyol is present in the steviol glycoside compositions in an amount effective to provide a concentration from about 100 ppm to about 250,000 ppm when present in an orally consumable composition. In other embodiments, the polyol is present in the sweetener compositions in an amount effective to provide a concentration from about 400 ppm to about 80,000 ppm when present in an orally consumable composition, such as, for example, from about 5,000 ppm to about 40,000 ppm.

Nucleotides

Suitable nucleotide additives include, but are not limited to, inosine monophosphate (“IMP”), guanosine monophosphate (“GMP”), adenosine monophosphate (“AMP”), cytosine monophosphate (CMP), uracil monophosphate (UMP), inosine diphosphate, guanosine diphosphate, adenosine diphosphate, cytosine diphosphate, uracil diphosphate, inosine triphosphate, guanosine triphosphate, adenosine triphosphate, cytosine triphosphate, uracil triphosphate, alkali or alkaline earth metal salts thereof, and combinations thereof. The nucleotides described herein also may comprise nucleotide-related additives, such as nucleosides or nucleic acid bases (e.g., guanine, cytosine, adenine, thymine, uracil).

The nucleotide is present in the steviol glycoside composition in an amount effective to provide a concentration from about 5 ppm to about 1,000 ppm when present in an orally consumable composition, such as, for example, a beverage.

Bitter Compounds

Suitable bitter compound additives include, but are not limited to, caffeine, quinine, urea, bitter orange oil, naringin, quassia, and salts thereof.

When present in a consumable, such as, for example, a beverage, the bitter compound is present in the sweetener composition in an amount effective to provide a concentration from about 25 ppm to about 25,000 ppm.

Astringent Compounds

Suitable astringent compound additives include, but are not limited to, tannic acid, europium chloride (EuCl3), gadolinium chloride (GdCl3), terbium chloride (TbCl3), alum, tannic acid, and polyphenols (e.g., tea polyphenols). The astringent additive is present in the sweetener composition in an amount effective to provide a concentration from about 10 ppm to about 5,000 ppm when present in a consumable, such as, for example, a beverage.

Proteins or Protein Hydrolysates

Suitable protein or protein hydrolysate additives include, but are not limited to, bovine serum albumin (BSA), whey protein (including fractions or concentrates thereof such as 90% instant whey protein isolate, 34% whey protein, 50%>hydrolyzed whey protein, and 80%>whey protein concentrate), soluble rice protein, soy protein, protein isolates, protein hydrolysates, reaction products of protein hydrolysates, glycoproteins, and/or proteoglycans containing amino acids (e.g., glycine, alanine, serine, threonine, asparagine, glutamine, arginine, valine, isoleucine, leucine, norvaline, methionine, proline, tyrosine, hydroxyproline, and the like), collagen (e.g., gelatin), partially hydrolyzed collagen (e.g., hydrolyzed fish collagen), and collagen hydrolysates (e.g., porcine collagen hydrolysate).

The protein hydrolysate is present in the sweetener composition in an amount effective to provide a concentration from about 200 ppm to about 50,000 ppm when present in a consumable, such as, for example, a beverage.

Surfactants

Suitable surfactant additives include, but are not limited to, polysorbates (e.g., polyoxyethylene sorbitan monooleate (polysorbate 80), polysorbate 20, polysorbate 60), sodium dodecylbenzenesulfonate, dioctyl sulfosuccinate or dioctyl sulfosuccinate sodium, sodium dodecyl sulfate, cetylpyridinium chloride (hexadecylpyridinium chloride), hexadecyltrimethylammonium bromide, sodium cholate, carbamoyl, choline chloride, sodium glycocholate, sodium taurodeoxycholate, lauric arginate, sodium stearoyl lactylate, sodium taurocholate, lecithins, sucrose oleate esters, sucrose stearate esters, sucrose palmitate esters, sucrose laurate esters, and other emulsifiers, and the like.

The surfactant additive is present in the steviol glycoside composition in an amount effective to provide a concentration from about 30 ppm to about 2,000 ppm when present in an orally consumable composition, such as, for example, a beverage.

Gums and Waxes

Gums and mucilages represent a broad array of different branched structures. Guar gum, derived from the ground endosperm of the guar seed, is a galactomannan. Guar gum is commercially available (e.g., Benefiber by Novartis AG). Other gums, such as gum arabic and pectins, have still different structures. Still other gums include xanthan gum, gellan gum, tara gum, psylium seed husk gum, and locust been gum.

Waxes are esters of ethylene glycol and two fatty acids, generally occurring as a hydrophobic liquid that is insoluble in water.

Antioxidants

As used herein “antioxidant” refers to any substance which inhibits, suppresses, or reduces oxidative damage to cells and biomolecules. Without being bound by theory, it is believed that antioxidants inhibit, suppress, or reduce oxidative damage to cells or biomolecules by stabilizing free radicals before they can cause harmful reactions. As such, antioxidants may prevent or postpone the onset of some degenerative diseases.

Examples of suitable antioxidants for embodiments of this application include, but are not limited to, vitamins, vitamin cofactors, minerals, hormones, carotenoids, carotenoid terpenoids, non-carotenoid terpenoids, flavonoids, flavonoid polyphenolics (e.g., bioflavonoids), flavonols, flavones, phenols, polyphenols, esters of phenols, esters ofpolyphenols, nonflavonoid phenolics, isothiocyanates, and combinations thereof. In some embodiments, the antioxidant is vitamin A, vitamin C, vitamin E, ubiquinone, mineral selenium, manganese, melatonin, a-carotene, β-carotene, lycopene, lutein, zeanthin, crypoxanthin, reservatol, eugenol, quercetin, catechin, gossypol, hesperetin, curcumin, ferulic acid, thymol, hydroxytyrosol, tumeric, thyme, olive oil, lipoic acid, glutathinone, gutamine, oxalic acid, tocopherol-derived compounds, butylated hydroxyanisole (BHA), butylated hydroxytoluene (BHT), ethylenediaminetetraacetic acid (EDTA), tert-butylhydroquinone, acetic acid, pectin, tocotrienol, tocopherol, coenzyme Q10, zeaxanthin, astaxanthin, canthaxantin, saponins, limonoids, kaempfedrol, myricetin, isorhamnetin, proanthocyanidins, quercetin, rutin, luteolin, apigenin, tangeritin, hesperetin, naringenin, crodictyol, flavan-3-ols (e.g., anthocyanidins), gallocatechins, epicatechin and its gallate forms, epigallocatechin and its gallate forms (ECGC) theaflavin and its gallate forms, thearubigins, isoflavone, phytoestrogens, genistein, daidzein, glycitein, anythocyanins, cyaniding, delphinidin, malvidin, pelargonidin, peonidin, petunidin, ellagic acid, gallic acid, salicylic acid, rosmarinic acid, cinnamic acid and its derivatives (e.g., ferulic acid), chlorogenic acid, chicoric acid, gallotannins, ellagitannins, anthoxanthins, betacyanins and other plant pigments, silymarin, citric acid, lignan, antinutrients, bilirubin, uric acid, R-a-lipoic acid, N-acetylcysteine, emblicanin, apple extract, apple skin extract (applephenon), rooibos extract red, rooibos extract, green, hawthorn berry extract, red raspberry extract, green coffee antioxidant (GCA), aronia extract 20%, grape seed extract (VinOseed), cocoa extract, hops extract, mangosteen extract, mangosteen hull extract, cranberry extract, pomegranate extract, pomegranate hull extract, pomegranate seed extract, hawthorn berry extract, pomella pomegranate extract, cinnamon bark extract, grape skin extract, bilberry extract, pine bark extract, pycnogenol, elderberry extract, mulberry root extract, wolfberry (gogi) extract, blackberry extract, blueberry extract, blueberry leaf extract, raspberry extract, turmeric extract, citrus bioflavonoids, black currant, ginger, acai powder, green coffee bean extract, green tea extract, and phytic acid, or combinations thereof. In alternate embodiments, the antioxidant is a synthetic antioxidant such as butylated hydroxytolune or butylated hydroxyanisole, for example. Other sources of suitable antioxidants for embodiments of this application include, but are not limited to, fruits, vegetables, tea, cocoa, chocolate, spices, herbs, rice, organ meats from livestock, yeast, whole grains, or cereal grains.

Particular antioxidants belong to the class of phytonutrients called polyphenols (also known as “polyphenolics”), which are a group of chemical substances found in plants, characterized by the presence of more than one phenol group per molecule. A variety of health benefits may be derived from polyphenols, including prevention of cancer, heart disease, and chronic inflammatory disease and improved mental strength and physical strength, for example. Suitable polyphenols for embodiments of this application include catechins, proanthocyanidins, procyanidins, anthocyanins, quercerin, rutin, reservatrol, isoflavones, curcumin, punicalagin, ellagitannin, hesperidin, naringin, citrus flavonoids, chlorogenic acid, other similar materials, and combinations thereof.

In particular embodiments, the antioxidant is a catechin such as, for example, epigallocatechin gallate (EGCG). Suitable sources of catechins for embodiments of this application include, but are not limited to, green tea, white tea, black tea, oolong tea, chocolate, cocoa, red wine, grape seed, red grape skin, purple grape skin, red grape juice, purple grape juice, berries, pycnogenol, and red apple peel.

In some embodiments, the antioxidant is chosen from proanthocyanidins, procyanidins or combinations thereof. Suitable sources of proanthocyanidins and procyanidins for embodiments of this application include, but are not limited to, red grapes, purple grapes, cocoa, chocolate, grape seeds, red wine, cacao beans, cranberry, apple peel, plum, blueberry, black currants, choke berry, green tea, sorghum, cinnamon, barley, red kidney bean, pinto bean, hops, almonds, hazelnuts, pecans, pistachio, pycnogenol, and colorful berries.

In particular embodiments, the antioxidant is an anthocyanin. Suitable sources of anthocyanins for embodiments of this application include, but are not limited to, red berries, blueberries, bilberry, cranberry, raspberry, cherry, pomegranate, strawberry, elderberry, choke berry, red grape skin, purple grape skin, grape seed, red wine, black currant, red currant, cocoa, plum, apple peel, peach, red pear, red cabbage, red onion, red orange, and blackberries.

In some embodiments, the antioxidant is chosen from quercetin, rutin or combinations thereof. Suitable sources of quercetin and rutin for embodiments of this application include, but are not limited to, red apples, onions, kale, bog whortleberry, lingonberrys, chokeberry, cranberry, blackberry, blueberry, strawberry, raspberry, black currant, green tea, black tea, plum, apricot, parsley, leek, broccoli, chili pepper, berry wine, and ginkgo.

In some embodiments, the antioxidant is reservatrol. Suitable sources of reservatrol for embodiments of this application include, but are not limited to, red grapes, peanuts, cranberry, blueberry, bilberry, mulberry, Japanese Itadori tea, and red wine.

In particular embodiments, the antioxidant is an isoflavone. Suitable sources of isoflavones for embodiments of this application include, but are not limited to, soy beans, soy products, legumes, alfalfa sprouts, chickpeas, peanuts, and red clover.

In some embodiments, the antioxidant is curcumin. Suitable sources of curcumin for embodiments of this application include, but are not limited to, turmeric and mustard.

In particular embodiments, the antioxidant is chosen from punicalagin, ellagitannin or combinations thereof. Suitable sources of punicalagin and ellagitannin for embodiments of this application include, but are not limited to, pomegranate, raspberry, strawberry, walnut, and oak-aged red wine.

In some embodiments, the antioxidant is a citrus flavonoid, such as hesperidin or naringin. Suitable sources of citrus flavonoids, such as hesperidin or naringin, for embodiments of this application include, but are not limited to, oranges, grapefruits, and citrus juices.

In particular embodiments, the antioxidant is chlorogenic acid. Suitable sources of chlorogenic acid for embodiments of this application include, but are not limited to, green coffee, yerba mate, red wine, grape seed, red grape skin, purple grape skin, red grape juice, purple grape juice, apple juice, cranberry, pomegranate, blueberry, strawberry, sunflower, Echinacea, pycnogenol, and apple peel.

Polymers

Suitable polymer additives include, but are not limited to, chitosan, pectin, pectic, pectinic, polyuronic, polygalacturonic acid, starch, food hydrocolloid or crude extracts thereof (e.g., gum acacia Senegal (Fibergum™), gum acacia seyal, carageenan), poly-L-lysine (e.g., poly-L-α-lysine or poly-L-ε-lysine), poly-L-ornithine (e.g., poly-L-α-ornithine or poly-L-ε-ornithine), polypropylene glycol, polyethylene glycol, poly(ethylene glycol methyl ether), polyarginine, polyaspartic acid, polyglutamic acid, polyethylene imine, alginic acid, sodium alginate, propylene glycol alginate, and sodium polyethyleneglycolalginate, sodium hexametaphosphate and its salts, and other cationic polymers and anionic polymers.

The polymer is present in the sweetener composition in an amount effective to provide a concentration from about 30 ppm to about 2,000 ppm when present in an orally consumable composition, such as, for example, a beverage.

Fatty Acids.

As used herein, “fatty acid” refers to any straight chain monocarboxylic acid and includes saturated fatty acids, unsaturated fatty acids, long chain fatty acids, medium chain fatty acids, short chain fatty acids, fatty acid precursors (including omega-9 fatty acid precursors), and esterified fatty acids. As used herein, “long chain polyunsaturated fatty acid” refers to any polyunsaturated carboxylic acid or organic acid with a long aliphatic tail. As used herein, “omega-3 fatty acid” refers to any polyunsaturated fatty acid having a first double bond as the third carbon-carbon bond from the terminal methyl end of its carbon chain. In particular embodiments, the omega-3 fatty acid may comprise a long chain omega-3 fatty acid. As used herein, “omega-6 fatty acid” any polyunsaturated fatty acid having a first double bond as the sixth carbon-carbon bond from the terminal methyl end of its carbon chain.

Suitable omega-3 fatty acids for use in embodiments of the present application can be derived from algae, fish, animals, plants, or combinations thereof, for example. Examples of suitable omega-3 fatty acids include, but are not limited to, linolenic acid, alpha-linolenic acid, eicosapentaenoic acid, docosahexaenoic acid, stearidonic acid, eicosatetraenoic acid and combinations thereof. In some embodiments, suitable omega-3 fatty acids can be provided in fish oils, (e.g., menhaden oil, tuna oil, salmon oil, bonito oil, and cod oil), microalgae omega-3 oils or combinations thereof. In particular embodiments, suitable omega-3 fatty acids may be derived from commercially available omega-3 fatty acid oils, such as Microalgae DHA oil (from Martek, Columbia, Md.), OmegaPure (from Omega Protein, Houston, Tex.), Marinol C-38 (from Lipid Nutrition, Channahon, Ill.), Bonito oil and MEG-3 (from Ocean Nutrition, Dartmouth, NS), Evogel (from Symrise, Holzminden, Germany), Marine Oil, from tuna or salmon (from Arista Wilton, Conn.), OmegaSource 2000, Marine Oil, from menhaden and Marine Oil, from cod (from OmegaSource, RTP, NC).

Suitable omega-6 fatty acids include, but are not limited to, linoleic acid, gamma-linolenic acid, dihommo-gamma-linolenic acid, arachidonic acid, eicosadienoic acid, docosadienoic acid, adrenic acid, docosapentaenoic acid and combinations thereof.

Suitable esterified fatty acids for embodiments of the present application may include, but are not limited to, monoacylgycerols containing ornega-3 and/or omega-6 fatty acids, diacylgycerols containing omega-3 and/or omega-6 fatty acids, or triacylgycerols containing omega-3 and/or omega-6 fatty acids and combinations thereof.

Vitamins.

Vitamins are organic compounds that the human body needs in small quantities for normal functioning. The body uses vitamins without breaking them down, unlike other nutrients such as carbohydrates and proteins. To date, thirteen vitamins have been recognized, and one or more can be used in the compositions herein. Suitable vitamins and their alternative chemical names are provided in the accompanying parentheses which follow include, vitamin A (retinol, retinaldehyde), vitamin D (calciferol, cholecalciferol, lumisterol, ergocalciferol, dihydrotachysterol, 7-dehydrocholesterol), vitamin E (tocopherol, tocotrienol), vitamin K (phylloquinone, naphthoquinone), vitamin B1 (thiamin), vitamin B2 (riboflavin, vitamin G), vitamin B3 (niacin, nicotinic acid, vitamin PP), vitamin B5 (pantothenic acid), vitamin B6 (pyridoxine, pyridoxal, pyridoxamine), vitamin B7 (biotin, vitamin H), vitamin B9 (folic acid, folate, folacin, vitamin M, pteroyl-L-glutamic acid), vitamin B12 (cobalamin, cyanocobalamin), and vitamin C (ascorbic acid).

Various other compounds have been classified as vitamins by some authorities. These compounds may be termed pseudo-vitamins and include, but are not limited to, compounds such as ubiquinone (coenzyme Q10), pangamic acid, dimethylglycine, taestrile, amygdaline, flavanoids, para-aminobenzoic acid, adenine, adenylic acid, and s-methylmethionine. As used herein, the term vitamin includes pseudo-vitamins.

In some embodiments, the vitamin is a fat-soluble vitamin chosen from vitamin A, D, E, K and combinations thereof. In other embodiments, the vitamin is a water-soluble vitamin chosen from vitamin 131, vitamin B2, vitamin 133, vitamin B6, vitamin B12, folic acid, biotin, pantothenic acid, vitamin C and combinations thereof.

Preservatives

In particular embodiments of this application, the preservative is chosen from antimicrobials, antienzymatics or combinations thereof. Non-limiting examples of antimicrobials include sulfites, propionates, benzoates, sorbates, nitrates, nitrites, bacteriocins, salts, sugars, acetic acid, dimethyl dicarbonate (DMDC), ethanol, and ozone.

According to a particular embodiment, the preservative is a sulfite. Sulfites include, but are not limited to, sulfur dioxide, sodium bisulfite, and potassium hydrogen sulfite.

According to another particular embodiment, the preservative is a propionate. Propionates include, but are not limited to, propionic acid, calcium propionate, and sodium propionate.

According to yet another particular embodiment, the preservative is a benzoate. Benzoates include, but are not limited to, sodium benzoate and benzoic acid.

In another particular embodiment, the preservative is a sorbate. Sorbates include, but are not limited to, potassium sorbate, sodium sorbate, calcium sorbate, and sorbic acid.

In still another particular embodiment, the preservative is a nitrate and/or a nitrite. Nitrates and nitrites include, but are not limited to, sodium nitrate and sodium nitrite.

In yet another particular embodiment, the at least one preservative is a bacteriocin, such as, for example, nisin.

In another particular embodiment, the preservative is ethanol or ozone.

Non-limiting examples of antienzymatics suitable for use as preservatives in particular embodiments of the application include ascorbic acid, citric acid, and metal chelating agents such as ethylenediaminetetraacetic acid (EDTA). Hydration Agents.

Hydration products help the body to replace fluids that are lost through excretion. For example, fluid is lost as sweat in order to regulate body temperature, as urine in order to excrete waste substances, and as water vapor in order to exchange gases in the lungs. Fluid loss can also occur due to a wide range of external causes, non-limiting examples of which include physical activity, exposure to dry air, diarrhea, vomiting, hyperthermia, shock, blood loss, and hypotension. Diseases causing fluid loss include diabetes, cholera, gastroenteritis, shigellosis, and yellow fever. Forms of malnutrition that cause fluid loss include the excessive consumption of alcohol, electrolyte imbalance, fasting, and rapid weight loss.

In a particular embodiment, the hydration product is a composition that helps the body replace fluids that are lost during exercise. Accordingly, in a particular embodiment, the hydration product is an electrolyte, non-limiting examples of which include sodium, potassium, calcium, magnesium, chloride, phosphate, bicarbonate, and combinations thereof: Suitable electrolytes for use in particular embodiments of this application are also described in U.S. Pat. No. 5,681,569, the disclosure of which is expressly incorporated herein by reference. In particular embodiments, the electrolytes are obtained from their corresponding water-soluble salts. Non-limiting examples of salts for use in particular embodiments include chlorides, carbonates, sulfates, acetates, bicarbonates, citrates, phosphates, hydrogen phosphates, tartrates, sorbates, citrates, benzoates, or combinations thereof. In other embodiments, the electrolytes are provided by juice, fruit extracts, vegetable extracts, tea, or teas extracts.

In particular embodiments of this application, the hydration product is a carbohydrate to supplement energy stores burned by muscles. Suitable carbohydrates for use in particular embodiments of this application are described in U.S. Pat. Nos. 4,312,856, 4,853,237, 5,681,569, and 6,989,171, the disclosures of which are expressly incorporated herein by reference. Non-limiting examples of suitable carbohydrates include monosaccharides, disaccharides, oligosaccharides, complex polysaccharides or combinations thereof. Non-limiting examples of suitable types of monosaccharides for use in particular embodiments include trioses, tetroses, pentoses, hexoses, heptoses, octoses, and nonoses. Non-limiting examples of specific types of suitable monosaccharides include glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, and sialose. Non-limiting examples of suitable disaccharides include sucrose, lactose, and maltose. Non-limiting examples of suitable oligosaccharides include saccharose, maltotriose, and maltodextrin. In other particular embodiments, the carbohydrates are provided by a corn syrup, a beet sugar, a cane sugar, a juice, or a tea.

In another particular embodiment, the hydration agent is a flavanol that provides cellular rehydration. Flavanols are a class of natural substances present in plants, and generally comprise a 2-phenylbenzopyrone molecular skeleton attached to one or more chemical moieties. Non-limiting examples of suitable flavanols for use in particular embodiments of this application include catechin, epicatechin, gallocatechin, epigallocatechin, epicatechin gallate, epigallocatechin 3-gallate, theaflavin, theaflavin 3-gallate, theaflavin 3′-gallate, theaflavin 3,3′ gallate, thearubigin or combinations thereof. Several common sources of flavanols include tea plants, fruits, vegetables, and flowers. In preferred embodiments, the flavanol is extracted from green tea.

In a particular embodiment, the hydration product is a glycerol solution to enhance exercise endurance. The ingestion of a glycerol containing solution has been shown to provide beneficial physiological effects, such as expanded blood volume, lower heart rate, and lower rectal temperature.

### Method of Improving the Taste Profile of a Steriol Glycoside Composition

Another aspect of present application relates to a method for improving the taste profile of a target steviol glycoside composition, comprising the steps of: adding a hydrolyzed steviol glycoside composition to the target steviol glycoside composition to generate an improved steviol glycoside composition. In some embodiments, the hydrolyzed steviol glycoside composition is an alkaline hydrolyzed steviol glycoside composition. In some embodiments, the hydrolyzed steviol glycoside composition is an alkaline hydrolyzed steviol glycoside prepared by the method of the present application.

In some embodiments, the hydrolyzed steviol glycoside composition (A) is added to the target steviol glycoside composition (B) at a A:B weight ratio of 5:95 to 95:5 to generate the improved composition.

In some embodiments, the target steviol glycoside composition comprises 20-99 wt % RA. In some embodiments, the improved composition comprises 40-95 wt % RA.

In some embodiments, the hydrolyzed steviol glycoside composition (A) is RA20-HP, RA30-HP, RA40-HP, RA50-HP, RA60-HP, RA70-HP, RA80-HP, RA90-HP, RA95-HP, RA97-HP or RA99-HP. In some embodiments, the RA20-HP, RA30-HP, RA40-HP, RA50-HP, RA60-HP, RA70-HP, RA80-HP, RA90-HP, RA95-HP, RA97-HP or RA99-HP is produced by alkaline hydrolysis with 20-60% hydrolysis of RA.

In some embodiments, the target steviol glycoside (B) is selected from the group consisting of RA20, RA30, RA40, RA50, RA60, RA70, RA80, RA90, RA95, RA97 and RA99. In some embodiments, the weight ratio of component (A):component (B) is between 1:9 and 9:1, or between 2:8 and 8:2, or between 3:7 and 7:3.

Another aspect of the present invention relates to a method for improving the taste profile of a steviol glycoside composition, comprising adding thaumatin (A) to the steviol glycoside composition (B) at a A:B wt ratio in the range of 1:5,000 to 1:5, 1:5,000 to 1:10, 1:5,000 to 1:25, 1:5,000 to 1:100, 1:5,000 to 1:250, 1:5,000 to 1:1,000, 1:2,000 to 1:5, 1:2,000 to 1:10, 1:2,000 to 1:25, 1:2,000 to 1:100, 1:2,000 to 1:250, 1:1,000 to 1:5, 1:1,000 to 1:10, 1:1,000 to 1:25, 1:1,000 to 1:100, 1:1,000 to 1:250, 1:500 to 1:5, 1:500 to 1:10, 1:500 to 1:25, 1:500 to 1:50 or 1:500 to 1:100.

### Method of Making Hydrolized Steviol Glycoside Composition

Another aspect of the present application is directed to methods of making a hydrolyzed steviol glycoside composition. The method comprises the step of subjecting a starting steviol glycoside composition to hydrolysis to produce a hydrolyzed steviol glycoside composition.

In some embodiments, the hydrolysis is alkaline hydrolysis. In other embodiments, the hydrolysis is enzyme catalyzed hydrolysis.

In some embodiments, the hydrolysis procedure comprises the steps of: dissolving a starting material in water (preferably potable water), adding alkali, such as NaOH or KOH, to form a starting mixture, and heating the starting mixture to a desired temperature in the range of about 4° C. to 200° C., and incubating the starting mixture at the desired temperature for a period of time that provides the desired level of hydrolysis or until the alkali is exhausted. In some further embodiments, the desired temperature is in the range of about 15° C. to 150° C. In some still further embodiments, the desired temperature is in the range of about 25° C. to 150° C. In some yet further embodiments, the desired temperature is in the range of about 50° C. to 125° C. In some yet still further embodiments, the desired temperature is in the range of about 75° C. to 105° C. In particular embodiments, the desired temperature is in the range of about 90° C. to 95° C. In some embodiments, the starting mixture is incubated at the desired temperature for a period of I minute to 144 hours, 30 minutes to 24 hours, or 2-4, 2-6, 2-8, 2-10, 2-12, 2-16, 2-20, 4-6, 4-8, 4-12, 4-16 hours. In some embodiments, the starting mixture is incubated at 85° C. to 95° C. for 0.5-2, 0.5-4, 0.5-6, 1-2, 1-4, 1-6, 2-4, 2-6 or 4-6 hours. In some embodiments, the starting mixture is incubated at 88° C. to 92° C. for 0.5-2, 0.5-4, 0.5-6, 1-2, 1-4, 1-6, 2-4, 2-6 or 4-6 hours. In some embodiments, the starting mixture is incubated at about 90° C. for 0.5-2, 0.5-4, 0.5-6, 1-2, 1-4, 1-6, 2-4, 2-6 or 4-6 hours.

The final hydrolysis product may have a pH value in the range of about 1-14. In some embodiments, the method further comprises the step of adjusting the pH of the final hydrolysis product with an acid such as HCl, or a base, such as NaOH. In some embodiments, the hydrolysis product has a basic pH and an acid is added to adjust the pH to a neutral pH in the final product. In some embodiments, the final product has a pH value in the range of 6-8. In other embodiments, the neutralization step is unnecessary and is therefore omitted.

In some embodiments, the steviol glycoside composition of the present application is prepared by mixing individual components together. Individual components of the steviol glycoside composition can be purchased or be made by processes known to those of ordinary skill in the art, and then combined (e.g., precipitation/co-precipitation, mixing, blending, grounding, mortar and pestal, microemulsion, solvothermal, sonochemical, etc.).

In addition, the inventors of the present application have surprisingly found that, following the mixing of the individual components, heating and cooling of the mixture results in an improved composition having improved solubility and taste over compositions not subjected to this heating and cooling step.

The inventors' experimental results, including hydrolysis studies and a sensory profile studies are disclosed herein and reported throughout the Figures following the specification. Many variations of alkaline molarity, RA purity, ST purity, and reaction time were tested, as disclosed. Reverse osmosis water was used as the solvent in all of the experiments. Solubility of the hydrolysis products, such as RA/RB and ST/STB products are a function of alkaline concentration in the hydrolysis step.

The hydrolysis products, such as RAiRB, and ST/STB, can be kept in solution as a syrup ready for distribution as a liquid sweetener, or dried for distribution as a dry sweetener. Drying may be achieved by spray-drying, lyophilization, oven drying, and other drying processes well-known in the art of sweeteners.

To modify the perceived sweetness of the steviol glycoside compositions containing the hydrolysis product (herein after the “Product”). The Product can be modified by the addition of taste modifying moieties, such as galactosides. For instance, β-1,4-galactosyl can be substituted on the Product using a β-1,4-galactosyl transferase enzyme in reactions known in the art. Such Product modified by one or more functional groups is included in the term “Product”.

In some embodiments, the Product, is in a powder form having a particle size in the range of about 1 to 1,000 microns. Fine powders are difficult to handle and difficult to admix with consumable compositions, such as tea leaves, tobacco products, herb leaves, coffees and other orally consumable compositions. Also, generally, only a relatively small amount of Product is used with a consumable composition when the Product is used as a flavor modifier or enhancer, sweetener, or co-sweetener.

In accordance with another embodiment, a process for adding Product to an orally consumable composition comprises mixing Product with a carrier to form a Product-carrier mixture. Preferred carriers include water, ethanol, other alkanols used in food processing, or mixtures thereof. The Product solution so formed is contacted with an orally consumable composition, and the carrier is removed from the orally consumable composition by evaporation, or otherwise, and the Product residues deposited with the orally consumable composition. This process is particularly useful for adding Product to tea leaves, herbal plant leaves, and other sweeteners, particularly granular sucrose (table sugar).

In accordance with still another embodiment, a liquid filter material, suitable for use with a consumable composition, is prepared with Product. The term “liquid filter”, as used herein, refers to a porous or semi-porous filter material used for preparation of an orally consumable composition such as a tea bag, a coffee filter or a filter disk. The term “filter disk” refers to a porous or semi-porous inactive article added to an orally consumable composition for the purposes of acting as a vehicle for the addition of a flavoring or sweetening composition to the orally consumable composition. A process for preparing a liquid filter comprising a filter material and Product is typically by mixing Product with a carrier to form a Product-carrier mixture; contacting the Product-carrier mixture with the filter material; and removing the carrier from the filter material thereby depositing a Product residue on the filter material.

The Product can be used in beverages, broths, and beverage preparations selected from the group comprising carbonated, non-carbonated, frozen, semi-frozen (“slush”), non-frozen, ready-to-drink, concentrated (powdered, frozen, or syrup), dairy, non-dairy, herbal, non-herbal, caffeinated, non-caffeinated, alcoholic, non-alcoholic, flavored, non-flavored, vegetable-based, fruit-based, root/tuber/corn-based, nut-based, other plant-based, cola-based, chocolate-based, meat-based, seafood-based, other animal-based, algae-based, calorie enhanced, calorie-reduced, and calorie-free products, optionally dispensed in open containers, cans, bottles or other packaging. Such beverages and beverage preparations can be in ready-to-drink, ready-to-cook, ready-to-mix, raw, or ingredient form and can use the Product as a sole sweetener or as a co-sweetener.

The Product can be used in foods and food preparations (e.g., sweeteners, soups, sauces, flavorings, spices, oils, fats, and condiments) selected from the group comprising dairy-based, cereal-based, baked, vegetable-based, fruit-based, root/tuber/corm-based, nut-based, other plant-based, egg-based, meat-based, seafood-based, other animal-based, algae-based, processed (e.g., spreads), preserved (e.g., meals-ready-to-eat rations), and synthesized (e.g., gels) products. Such foods and food preparations can be in ready-to-eat, ready-to-cook, ready-to-mix, raw, or ingredient form and can use the Product as a sole sweetener or as a co-sweetener.

The Product can be used in candies, confections, desserts, and snacks selected from the group comprising dairy-based, cereal-based, baked, vegetable-based, fruit-based, root/tuber/corm-based, nut-based, gum-based, other plant-based, egg-based, meat-based, seafood-based, other animal-based, algae-based, processed (e.g., spreads), preserved (e.g., meals-ready-to-eat rations), and synthesized (e.g., gels) products. Such candies, confections, desserts, and snacks can be in ready-to-eat, ready-to-cook, ready-to-mix, raw, or ingredient form, and can use the Product as a sole sweetener or as a co-sweetener.

The Product can be used in prescription and over-the-counter pharmaceuticals, assays, diagnostic kits, and therapies selected from the group comprising weight control, nutritional supplement, vitamins, infant diet, diabetic diet, athlete diet, geriatric diet, low carbohydrate diet, low fat diet, low protein diet, high carbohydrate diet, high fat diet, high protein diet, low calorie diet, non-caloric diet, oral hygiene products (e.g., toothpaste, mouthwash, rinses, floss, toothbrushes, other implements), personal care products (e.g., soaps, shampoos, rinses, lotions, balms, salves, ointments, paper goods, perfumes, lipstick, other cosmetics), professional dentistry products in which taste or smell is a factor (e.g., liquids, chewables, inhalables, injectables, salves, resins, rinses, pads, floss, implements), medical, veterinarian, and surgical products in which taste or smell is a factor (e.g., liquids, chewables, inhalables, injectables, salves, resins, rinses, pads, floss, implements), and pharmaceutical compounding fillers, syrups, capsules, gels, and coating products.

The Product can be used in consumer goods packaging materials and containers selected from the group comprising plastic film, thermoset and thermoplastic resin, gum, foil, paper, bottle, box, ink, paint, adhesive, and packaging coating products.

The Product can be used in goods selected from the group comprising sweeteners, co-sweeteners, coated sweetener sticks, frozen confection sticks, medicine spoons (human and veterinary uses), dental instruments, pre-sweetened disposable tableware and utensils, sachets, edible sachets, pot pourris, edible pot pourris, hotch potches, edible hotch potches, artificial flowers, edible artificial flowers, clothing, edible clothing, massage oils, and edible massage oils

Another aspect of the present application is directed to methods of using the steviol glycoside composition of the present application.

In some embodiments, the steviol glycoside composition of the present application is used in an effective amount as a sweetener with improved solubility and and/or sensory profiles.

In some embodiments, the steviol glycoside composition of the present application is used an effective amount as a co-sweetener with improved solubility and and/or sensory profiles.

In other embodiments, the steviol glycoside composition of the present application is used an effective amount as a flavoring agent.

The term “iso-sweet” as used herein is intended to mean that the subject composition has sweetness equal to that of sugar.

For use as a co-sweetener, the Product can be used in ways known in the art of sweeteners (e.g., steam, ethanol, or alkanol aerosolized Product vapor-deposited on a co-sweetener) to coat or permeate other solid sweeteners, such granular and powdered sugar and artificial sweeteners, to be mixed as a separate powder with such solid sweeteners, to be co-crystallized with other solid sweeteners, or to be suspended or dissolved in liquid sweeteners, such as corn syrup and honey. Commercially available spray dryers used in the ethanol purge and drying stage of the industrial embodiment can typically be configured to produce a particulate size of Product appropriate for an intended use.

In some embodiments, the steviol glycoside composition of the present application is used as a sweetener or a flavoring agent in a consumable composition including foodstuffs.

The term “foodstuff” includes both solid and liquid ingestible materials which usually do, but need not, have a nutritional value and are intended for consumption by man or animal. Representative examples of foodstuff include coffee, teas, herbal teas, baked goods, natural and synthetic flavors, spices, condiments, soups, stews, convenience foods, beverages (both carbonated and non-carbonated), dairy products, candies, vegetables, cereals, fruits, fruit drinks, snacks, cocoa products, chocolates, animal feed, and the like.

In some embodiments, the steviol glycoside composition of the present application is used as a flavoring agent that enhances or modify the flavor of a consumable. In some embodiments, the steviol glycoside composition of the present application, when used in an effective amount, modifies or enhances flavor characteristics that are sweet, fruity, floral, herbaceous, spicy, aromatic, pungent, “nut-like” (e.g., almond, pecan), “spicy” (e.g., cinnamon, clove, nutmeg, anise and wintergreen), “non-citrus fruit” flavor (e.g., strawberry, cherry, apple, grape, currant, tomato, gooseberry and blackberry), “citrus fruit” flavor (e.g., orange, lemon and grapefruit), and other useful flavors, including coffee, cocoa, peppermint, spearmint, vanilla and maple.

In some embodiments, the steviol glycoside composition of the present application is used in an amount effective to sweeten or to modify or enhance the taste, odor and/or texture of a consumable composition.

The terminology “amount effective” or “effective amount” means an amount that produces a sensory perception. The use of an excessive amount of a steviol glycoside composition will produce sweetness that may not be desired for flavor modification or enhancement, just as too much sugar can be added to a foodstuff or beverage. The amount of steviol glycoside composition employed can vary over a relatively wide range, depending upon the desired sensory effect to be achieved with the orally consumable composition and the nature of the initial composition.

The steviol glycoside composition can be added to a consumable composition by mixing the steviol glycoside composition with the consumable composition or mixing the steviol glycoside composition with a component of the consumable composition.

The steviol glycoside composition can be used in tobacco and tobacco-related products selected from the group comprising cigarettes, cigars, snuffs, chewing tobacco, other tobacco goods, filters, smoking papers, and other smoking compositions. A smoking composition having a sweetened, enhanced, or modified flavor comprises a smoking filler material selected from the group consisting of tobacco, reconstituted tobacco, non-tobacco substitutes and mixtures thereof, and containing an effective amount of steviol glycoside composition. “Containing” means both being included as an ingredient and being adsorbed to a material. In one variation of this embodiment, the smoking composition comprises a filter means containing a steviol glycoside composition. The term “filter means”, as used herein, includes a smoking device means such as a cigar or cigarette holder having a filtering or flavoring module incorporated therein and includes acetate, cotton, charcoal and other fiber, flake or particle filtering means. In another variation of this embodiment, the smoking composition comprises a wrapper means containing a steviol glycoside composition. In one variation of this embodiment, 0.003 to 0.30 parts by weight of a steviol glycoside composition is added to 100 parts by weight of the smoking filler material. In a preferred variation of this embodiment, 0.015 to 0.30 parts by weight of a Product is added to 100 parts of a weight of a smoking filler material.

Those skilled in the art of flavoring tobacco understand that the effective amount of the Product added to a smoking composition may depend upon the method in which the Product is added to the smoking composition and to which portion of the smoking composition Product is added. Product can be added directly to the smoking filler material, to the filter means, or to the wrapper means of a smoking composition. Product can be added to a filter means of a smoking composition by any manner known to those skilled in the art of flavoring filter means, including but not limited to, incorporating the Product among the fibers, flakes or particles of a filter means, filling the Product between two or more layers of fibers of a fiber filter means to form a triple filter means, or inserting the Product into a smoking device means, such as a cigarette holder.

It is apparent to those skilled in the art that only a portion of the smoking filler material or filter means need be treated with a steviol glycoside composition, since blending or other operations may be used to adjust the final or ultimate smoking composition within the effective or desired ranges of concentration of the steviol glycoside composition. In addition to the steviol glycoside composition, other flavorings or aroma additives known in the smoking composition flavoring art may be used with the steviol glycoside composition and added along with Product to the smoking composition. Representative flavorings used in the smoking composition flavoring art include ethyl acetate, isoamyl acetate, propyl isobutyrate, isobutyl butyrate, ethyl butyrate, ethyl valerate, benzyl formate, menthol, limonene, cymene, pinene, linalool, geraniol, citroneilol, citral, peppermint oil, orange oil, coriander oil, lemon oil, borneol, cocoa extract, tobacco extract, licorice extract and fruit extractives.

### Consumables Containing the Steviol Glycoside Composition

Another aspect of the present application is directed to an orally consumable composition comprising a steviol glycoside composition of the present application.

In one embodiment, the orally consumable composition comprises the steviol glycoside composition of the present application, a sweetener composition comprising the steviol glycoside composition of the present application, or a flavoring agent comprising the steviol glycoside composition of the present application. The steviol glycoside composition can be added to the consumable or consumable matrix to provide a sweetened consumable or a flavored consumable.

“Orally consumable composition,” as used herein, refers to substances which are contacted with the mouth of man or animal, including substances which are taken into and subsequently ejected from the mouth and substances which are drunk, eaten, swallowed or otherwise ingested, and are safe for human or animal consumption when used in a generally acceptable range.

Exemplary orally consumable compositions include, but are not limited to, confections, condiments, chewing compositions, cereal composition, baked goods, dairy products, and sweetener compositions, beverages and beverage products, medicinal compositions, smoking compositions, and oral hygiene compositions. Consumables can be sweetened or unsweetened.

Orally consumable compositions Consumable can optionally include additives, sweeteners, functional ingredients and combinations thereof, as described herein. Any of the additive, sweeteners and other ingredients described above can be present in the orally consumable compositions.

Consumables employing the steviol glycoside compositions of the present application are also suitable for use in processed agricultural products, livestock products or seafood; processed meat products such as sausage and the like; retort food products, pickles, preserves boiled in soy sauce, delicacies, side dishes; soups; snacks, such as potato chips, cookies, or the like; as shredded filler, leaf, stem, stalk, homogenized leaf cured and animal feed.

### Confections

In some embodiments, the orally consumable composition comprising the steviol glycoside composition of the present application is a confection. As referred to herein, “confection” can mean a candy, a sweet, a lollie, a confectionery, or similar term. The confection generally contains a base composition component and a sweetener component. A “base composition” refers to any composition which can be a food item and provides a matrix for carrying the sweetener component. The steviol glycoside composition of the present application or a sweetener composition comprising the same can serve as the sweetener component. The confection may be in the form of any food that is typically perceived to be rich in sugar or is typically sweet.

According to particular embodiments of the present application, the confections may be bakery products such as pastries; desserts such as yogurt, jellies, drinkable jellies, puddings, Bavarian cream, blancmnange, cakes, brownies, mousse and the like, sweetened food products eaten at tea time or following meals; frozen foods; cold confections, e.g., types of ice cream such as ice cream, ice milk, lacto-ice and the like (food products in which sweeteners and various other types of raw materials are added to milk products, and the resulting mixture is agitated and frozen), and ice confections such as sherbets, dessert ices and the like (food products in which various other types of raw materials are added to a sugary liquid, and the resulting mixture is agitated and frozen); general confections, e.g., baked confections or steamed confections such as crackers, biscuits, buns with bean-jam filling, halvah, alfajor, and the like; rice cakes and snacks; table top products; general sugar confections such as chewing gum (e.g. including compositions which comprise a substantially water-insoluble, chewable gum base, such as chicle or substitutes thereof, including jetulong, guttakay rubber or certain comestible natural synthetic resins or waxes), hard candy, soft candy, mints, nougat candy, jelly beans, fudge, toffee, taffy, Swiss milk tablet, licorice candy, chocolates, gelatin candies, marshmallow, marzipan, divinity, cotton candy, and the like; sauces including fruit flavored sauces, chocolate sauces and the like; edible gels; cremes including butter cremes, flour pastes, whipped cream and the like; jams including strawberry jam, marmalade and the like; and breads including sweet breads and the like or other starch products, and combinations thereof.

Suitable base compositions for embodiments of this application may include flour, yeast, water, salt, butter, eggs, milk, milk powder, liquor, gelatin, nuts, chocolate, citric acid, tartaric acid, fumaric acid, natural flavors, artificial flavors, colorings, polyols, sorbitol, isomalt, maltitol, lactitol, malic acid, magnesium stearate, lecithin, hydrogenated glucose syrup, glycerine, natural or synthetic gum, starch, and the like, and combinations thereof. Such components generally are recognized as safe (GRAS) and/or are U.S. Food and Drug Administration (FDA)-approved. According to particular embodiments of the application, the base composition is present in the confection in an amount ranging from about 0.1 to about 99 weight percent of the confection.

The base composition of the confection may optionally include other artificial or natural sweeteners, bulk sweeteners, or combinations thereof. Bulk sweeteners include both caloric and non-caloric compounds. Non-limiting examples of bulk sweeteners include sucrose, dextrose, maltose, dextrin, dried invert sugar, fructose, high fructose corn syrup, levulose, galactose, corn syrup solids, tagatose, polyols (e.g., sorbitol, mannitol, xylitol, lactitol, erythritol, and maltitol), hydrogenated starch hydrolysates, isomalt, trehalose, and mixtures thereof. Generally, the amount of bulk sweetener present in the confection ranges widely depending on the particular embodiment of the confection and the desired degree of sweetness. Those of ordinary skill in the art will readily ascertain the appropriate amount of bulk sweetener.

In a particular embodiment, a confection comprises a steviol glycoside composition of the present application or a sweetener composition comprising the same and a base composition. Generally, the amount of steviol glycoside composition of the present application or sweetener composition comprising the same in the confection ranges widely depending on the particular embodiment of the confection and the desired degree of sweetness.

### Condiments

In some embodiments, the consumable comprising a steviol glycoside composition of the present application or a sweetener composition comprising the same is a condiment. Condiments, as used herein, are compositions used to enhance or improve the flavor of a food or beverage. Non-limiting examples of condiments include ketchup (catsup); mustard; barbecue sauce; butter; chili sauce; chutney; cocktail sauce; curry; dips; fish sauce; horseradish; hot sauce; jellies, jams, marmalades, or preserves; mayonnaise; peanut butter; relish; remoulade; salad dressings (e.g., oil and vinegar, Caesar, French, ranch, bleu cheese, Russian, Thousand Island, Italian, and balsamic vinaigrette), salsa; sauerkraut; soy sauce; steak sauce; syrups; tartar sauce; and Worcestershire sauce.

Condiment bases generally comprise a mixture of different ingredients, non-limiting examples of which include vehicles (e.g., water and vinegar); spices or seasonings (e.g., salt, pepper, garlic, mustard seed, onion, paprika, turmeric, and combinations thereof); fruits, vegetables, or their products (e.g., tomatoes or tomato-based products (paste, puree), fruit juices, fruit juice peels, and combinations thereof); oils or oil emulsions, particularly vegetable oils; thickeners (e.g., xanthan gum, food starch, other hydrocolloids, and combinations thereof); and emulsifying agents (e.g., egg yolk solids, protein, gum arabic, carob bean gum, guar gum, gum karaya, gum tragacanth, carageenan, pectin, propylene glycol esters of alginic acid, sodium carboxymethyl-cellulose, polysorbates, and combinations thereof). Recipes for condiment bases and methods of making condiment bases are well known to those of ordinary skill in the art.

Generally, condiments also comprise caloric sweeteners, such as sucrose, high fructose corn syrup, molasses, honey, or brown sugar. In exemplary embodiments of the condiments provided herein, the steviol glycoside composition of the present application or a sweetener composition comprising the same is used instead of traditional caloric sweeteners. Accordingly, a condiment composition desirably comprises a steviol glycoside composition of the present application or a sweetener composition comprising the same and a condiment base.

The condiment composition optionally may include other natural and/or synthetic high-potency sweeteners, bulk sweeteners, pH modifying agents (e.g., lactic acid, citric acid, phosphoric acid, hydrochloric acid, acetic acid, and combinations thereof), fillers, functional agents (e.g., pharmaceutical agents, nutrients, or components of a food or plant), flavorings, colorings, or combinations thereof.

### Chewing Compositions

In some embodiments, the consumable comprising the steviol composition of the present application is a chewing composition. The term “chewing compositions” include chewing gum compositions, chewing tobacco, smokeless tobacco, snuff, chewing gum and other compositions which are masticated and subsequently expectorated.

Chewing gum compositions generally comprise a water-soluble portion and a water-insoluble chewable gum base portion. The water soluble portion, which typically includes a steviol glycoside composition of the present application or a sweetener composition comprising the same, dissipates with a portion of the flavoring agent over a period of time during chewing while the insoluble gum base portion is retained in the mouth. The insoluble gum base generally determines whether a gum is considered chewing gum, bubble gum, or a functional gum.

The insoluble gum base, which is generally present in the chewing gum composition in an amount in the range of about 15 to about 35 weight percent of the chewing gum composition, generally comprises combinations of elastomers, softeners (plasticizers), emulsifiers, resins, and fillers. Such components generally are considered food grade, recognized as safe (GRA), and/or are U.S. Food and Drug Administration (FDA)-approved.

Elastomers, the primary component of the gum base, provide the rubbery, cohesive nature to gums and can include one or more natural rubbers (e.g., smoked latex, liquid latex, or guayule); natural gums (e.g., jelutong, perillo, sorva, massaranduba balata, massaranduba chocolate, nispero, rosindinha, chicle, and gutta hang kang); or synthetic elastomers (e.g., butadiene-styrene copolymers, isobutylene-isoprene copolymers, polybutadiene, polyisobutylene, and vinyl polymeric elastomers). In a particular embodiment, the elastomer is present in the gum base in an amount in the range of about 3 to about 50 weight percent of the gum base.

Resins are used to vary the firmness of the gum base and aid in softening the elastomer component of the gum base. Non-limiting examples of suitable resins include a rosin ester, a terpene resin (e.g., a terpene resin from a-pinene, β-pinene and/or d-limonene), polyvinyl acetate, polyvinyl alcohol, ethylene vinyl acetate, and vinyl acetate-vinyl laurate copolymers. Non-limiting examples of rosin esters include a glycerol ester of a partially hydrogenated rosin, a glycerol ester of a polymerized rosin, a glycerol ester of a partially dimerized rosin, a glycerol ester of rosin, a pentaerythritol ester of a partially hydrogenated rosin, a methyl ester of rosin, or a methyl ester of a partially hydrogenated rosin. In a particular embodiment, the resin is present in the gum base in an amount in the range of about 5 to about 75 weight percent of the gum base.

Softeners, which also are known as plasticizers, are used to modify the ease of chewing and/or mouthfeel of the chewing gum composition. Generally, softeners comprise oils, fats, waxes, and emulsifiers. Non-limiting examples of oils and fats include tallow, hydrogenated tallow, large, hydrogenated or partially hydrogenated vegetable oils (e.g., soybean, canola, cottonseed, sunflower, palm, coconut, corn, safflower, or palm kernel oils), cocoa butter, glycerol monostearate, glycerol triacetate, glycerol abietate, lecithin, monoglycerides, diglycerides, triglycerides acetylated monoglycerides, and free fatty acids. Non-limiting examples of waxes include polypropylene/polyethylene/Fisher-Tropsch waxes, paraffin, and microcrystalline and natural waxes (e.g., candelilla, beeswax and carnauba). Microcrystalline waxes, especially those with a high degree of crystallinity and a high melting point, also may be considered as bodying agents or textural modifiers. In a particular embodiment, the softeners are present in the gum base in an amount in the range of about 0.5 to about 25 weight percent of the gum base.

Emulsifiers are used to form a uniform dispersion of the insoluble and soluble phases of the chewing gum composition and also have plasticizing properties. Suitable emulsifiers include glycerol monostearate (GMS), lecithin (phosphatidyl choline), polyglycerol polyricinoleic acid (PPGR), mono and diglycerides of fatty acids, glycerol distearate, tracetin, acetylated monoglyceride, glycerol triacetate, and magnesium stearate. In a particular embodiment, the emulsifiers are present in the gum base in an amount in the range of about 2 to about 30 weight percent of the gum base.

The chewing gum composition also may comprise adjuvants or fillers in either the gum base and/or the soluble portion of the chewing gum composition. Suitable adjuvants and fillers include lecithin, inulin, polydextrin, calcium carbonate, magnesium carbonate, magnesium silicate, ground limestome, aluminum hydroxide, aluminum silicate, talc, clay, alumina, titanium dioxide, and calcium phosphate. In particular embodiments, lecithin can be used as an inert filler to decrease the stickiness of the chewing gum composition. In other particular embodiments, lactic acid copolymers, proteins (e.g., gluten and/or zein) and/or guar can be used to create a gum that is more readily biodegradable. The adjuvants or fillers are generally present in the gum base in an amount up to about 20 weight percent of the gum base. Other optional ingredients include coloring agents, whiteners, preservatives, and flavors.

In particular embodiments of the chewing gum composition, the gum base comprises about 5 to about 95 weight percent of the chewing gum composition, more desirably about 15 to about 50 weight percent of the chewing gum composition, and even more desirably from about 20 to about 30 weight percent of the chewing gum composition.

The soluble portion of the chewing gum composition may optionally include other artificial or natural sweeteners, bulk sweeteners, softeners, emulsifiers, flavoring agents, coloring agents, adjuvants, fillers, functional agents (e.g., pharmaceutical agents or nutrients), or combinations thereof: Suitable examples of softeners and emulsifiers are described above.

Bulk sweeteners include both caloric and non-caloric compounds. Non-limiting examples of bulk sweeteners include sucrose, dextrose, maltose, dextrin, dried invert sugar, fructose, high fructose corn syrup, levulose, galactose, corn syrup solids, tagatose, polyols (e.g., sorbitol, mannitol, xylitol, lactitol, erythritol, and maltitol), hydrogenated starch hydrolysates, isomalt, trehalose, and mixtures thereof. In particular embodiments, the bulk sweetener is present in the chewing gum composition in an amount in the range of about 1 to about 75 weight percent of the chewing gum composition.

Flavoring agents may be used in either the insoluble gum base or soluble portion of the chewing gum composition. Such flavoring agents may be natural or artificial flavors. In a particular embodiment, the flavoring agent comprises an essential oil, such as an oil derived from a plant or a fruit, peppermint oil, spearmint oil, other mint oils, clove oil, cinnamon oil, oil of wintergreen, bay, thyme, cedar leaf, nutmeg, allspice, sage, mace, and almonds. In another particular embodiment, the flavoring agent comprises a plant extract or a fruit essence such as apple, banana, watermelon, pear, peach, grape, strawberry, raspberry, cherry, plum, pineapple, apricot, and mixtures thereof. In still another particular embodiment, the flavoring agent comprises a citrus flavor, such as an extract, essence, or oil of lemon, lime, orange, tangerine, grapefruit, citron, or kumquat.

In a particular embodiment, a chewing gum composition comprises a steviol glycoside composition of the present application or a sweetener composition comprising the same and a gum base.

### Cereal Compositions

In some embodiments, the consumable comprising the steviol composition of the present application is a cereal composition. Cereal compositions typically are eaten either as staple foods or as snacks. Non-limiting examples of cereal compositions for use in particular embodiments include ready-to-eat cereals as well as hot cereals. Ready-to-eat cereals are cereals which may be eaten without further processing (i.e., cooking) by the consumer. Examples of ready-to-eat cereals include breakfast cereals and snack bars. Breakfast cereals typically are processed to produce a shredded, flaky, puffy, or extruded form. Breakfast cereals generally are eaten cold and are often mixed with milk and/or fruit. Snack bars include, for example, energy bars, rice cakes, granola bars, and nutritional bars. Hot cereals generally are cooked, usually in either milk or water, before being eaten. Non-limiting examples of hot cereals include grits, porridge, polenta, rice, and rolled oats.

Cereal compositions generally comprise at least one cereal ingredient. As used herein, the term “cereal ingredient” denotes materials such as whole or part grains, whole or part seeds, and whole or part grass. Non-limiting examples of cereal ingredients for use in particular embodiments include maize, wheat, rice, barley, bran, bran endosperm, bulgur, sorghums, millets, oats, rye, triticale, buckwheat, fonio, quinoa, bean, soybean, amaranth, teff, spelt, and kaniwa.

In a particular embodiment, the cereal composition comprises a steviol glycoside composition of the present application or a sweetener composition comprising the same and at least one cereal ingredient. The steviol glycoside composition of the present application or sweetener composition comprising the same may be added to the cereal composition in a variety of ways, such as, for example, as a coating, as a frosting, as a glaze, or as a matrix blend (i.e., added as an ingredient to the cereal formulation prior to the preparation of the final cereal product).

Accordingly, in a particular embodiment, the steviol glycoside composition of the present application or sweetener composition comprising the same is added to the cereal composition as a matrix blend. In one embodiment, the steviol glycoside composition of the present application or sweetener composition comprising the same is blended with a hot cereal prior to cooking to provide a sweetened hot cereal product. In another embodiment, the steviol glycoside composition of the present application or sweetener composition comprising the same is blended with the cereal matrix before the cereal is extruded.

In another particular embodiment, the steviol glycoside composition of the present application or sweetener composition comprising the same is added to the cereal composition as a coating, such as, for example, by combining with a food grade oil and applying the mixture onto the cereal. In a different embodiment, the steviol glycoside composition of the present application or sweetener composition comprising the same and the food grade oil may be applied to the cereal separately, by applying either the oil or the sweetener first. Non-limiting examples of food grade oils for use in particular embodiments include vegetable oils such as corn oil, soybean oil, cottonseed oil, peanut oil, coconut oil, canola oil, olive oil, sesame seed oil, palm oil, palm kernel oil, and mixtures thereof. In yet another embodiment, food grade fats may be used in place of the oils, provided that the fat is melted prior to applying the fat onto the cereal.

In another embodiment, the steviol glycoside composition of the present application or sweetener composition comprising the same is added to the cereal composition as a glaze. Non-limiting examples of glazing agents for use in particular embodiments include corn syrup, honey syrups and honey syrup solids, maple syrups and maple syrup solids, sucrose, isomalt, polydextrose, polyols, hydrogenated starch hydrolysate, aqueous solutions thereof, and mixtures thereof. In another such embodiment, the steviol glycoside composition of the present application or sweetener composition comprising the same is added as a glaze by combining with a glazing agent and a food grade oil or fat and applying the mixture to the cereal. In yet another embodiment, a gum system, such as, for example, gum acacia, carboxymethyl cellulose, or algin, may be added to the glaze to provide structural support. In addition, the glaze also may include a coloring agent, and also may include a flavor.

In another embodiment, the steviol glycoside composition of the present application or sweetener composition comprising the same is added to the cereal composition as a frosting. In one such embodiment, the steviol glycoside composition of the present application or sweetener composition comprising the same is combined with water and a frosting agent and then applied to the cereal. Non-limiting examples of frosting agents for use in particular embodiments include maltodextrin, sucrose, starch, polyols, and mixtures thereof. The frosting also may include a food grade oil, a food grade fat, a coloring agent, and/or a flavor.

Generally, the amount of the steviol glycoside composition of the present application or sweetener composition comprising the same in a cereal composition varies widely depending on the particular type of cereal composition and its desired sweetness. Those of ordinary skill in the art can readily discern the appropriate amount of sweetener to put in the cereal composition.

### Baked Goods

In some embodiments, the consumable comprising the steviol composition of the present application is bakes goods. Baked goods, as used herein, include ready to eat and all ready to bake products, flours, and mixes requiring preparation before serving. Non-limiting examples of baked goods include cakes, crackers, cookies, brownies, muffins, rolls, bagels, donuts, strudels, pastries, croissants, biscuits, bread, bread products, and buns.

Preferred baked goods in accordance with embodiments of this application can be classified into three groups: bread-type doughs (e.g., white breads, variety breads, soft buns, hard rolls, bagels, pizza dough, and flour tortillas), sweet doughs (e.g., danishes, croissants, crackers, puff pastry, pie crust, biscuits, and cookies), and batters (e.g., cakes such as sponge, pound, devil's food, cheesecake, and layer cake, donuts or other yeast raised cakes, brownies, and muffins). Doughs are generally characterized as being flour-based, whereas batters are more water-based.

Baked goods in accordance with particular embodiments of this application generally comprise a combination of sweetener, water, and fat. Baked goods made in accordance with many embodiments of this application also contain flour in order to make a dough or a batter. The term “dough” as used herein is a mixture of flour and other ingredients stiff enough to knead or roll. The term “batter” as used herein consists of flour, liquids such as milk or water, and other ingredients, and is thin enough to pour or drop from a spoon. Desirably, in accordance with particular embodiments of the application, the flour is present in the baked goods in an amount in the range of about 15 to about 60% on a dry weight basis, more desirably from about 23 to about 48% on a dry weight basis.

The type of flour may be selected based on the desired product. Generally, the flour comprises an edible non-toxic flour that is conventionally utilized in baked goods. According to particular embodiments, the flour may be a bleached bake flour, general purpose flour, or unbleached flour. In other particular embodiments, flours also may be used that have been treated in other manners. For example, in particular embodiments flour may be enriched with additional vitamins, minerals, or proteins. Non-limiting examples of flours suitable for use in particular embodiments of the application include wheat, corn meal, whole grain, fractions of whole grains (wheat, bran, and oatmeal), and combinations thereof. Starches or farinaceous material also may be used as the flour in particular embodiments. Common food starches generally are derived from potato, corn, wheat, barley, oat, tapioca, arrow root, and sago. Modified starches and pregelatinized starches also may be used in particular embodiments of the application.

The type of fat or oil used in particular embodiments of the application may comprise any edible fat, oil, or combination thereof that is suitable for baking. Non-limiting examples of fats suitable for use in particular embodiments of the application include vegetable oils, tallow, lard, marine oils, and combinations thereof. According to particular embodiments, the fats may be fractionated, partially hydrogenated, and/or intensified. In another particular embodiment, the fat desirably comprises reduced, low calorie, or non-digestible fats, fat substitutes, or synthetic fats. In yet another particular embodiment, shortenings, fats, or mixtures of hard and soft fats also may be used. In particular embodiments, shortenings may be derived principally from triglycerides derived from vegetable sources (e.g., cotton seed oil, soybean oil, peanut oil, linseed oil, sesame oil, palm oil, palm kernel oil, rapeseed oil, safflower oil, coconut oil, corn oil, sunflower seed oil, and mixtures thereof). Synthetic or natural triglycerides of fatty acids having chain lengths from 8 to 24 carbon atoms also may be used in particular embodiments. Desirably, in accordance with particular embodiments of this application, the fat is present in the baked good in an amount in the range of about 2 to about 35% by weight on a dry basis, more desirably from about 3 to about 29% by weight on a dry basis.

Baked goods in accordance with particular embodiments of this application also comprise water in amounts sufficient to provide the desired consistency, enabling proper forming, machining and cutting of the baked good prior or subsequent to cooking. The total moisture content of the baked good includes any water added directly to the baked good as well as water present in separately added ingredients (e.g., flour, which generally includes about 12 to about 14% by weight moisture). Desirably, in accordance with particular embodiments of this application, the water is present in the baked good in an amount up to about 25% by weight of the baked good.

Baked goods in accordance with particular embodiments of this application also may comprise a number of additional conventional ingredients such as leavening agents, flavors, colors, milk, milk by-products, egg, egg by-products, cocoa, vanilla or other flavoring, as well as inclusions such as nuts, raisins, cherries, apples, apricots, peaches, other fruits, citrus peel, preservative, coconuts, flavored chips such a chocolate chips, butterscotch chips, and caramel chips, and combinations thereof. In particular embodiments, the baked goods may also comprise emulsifiers, such as lecithin and monoglycerides.

According to particular embodiments of this application, leavening agents may comprise chemical leavening agents or yeast leavening agents. Non-limiting examples of chemical leavening agents suitable for use in particular embodiments of this application include baking soda (e.g., sodium, potassium, or aluminum bicarbonate), baking acid (e.g., sodium aluminum phosphate, monocalcium phosphate, or dicalcium phosphate), and combinations thereof.

In accordance with another particular embodiment of this application, cocoa may comprise natural or “Dutched” chocolate from which a substantial portion of the fat or cocoa butter has been expressed or removed by solvent extraction, pressing, or other means. In a particular embodiment, it may be necessary to reduce the amount of fat in a baked good comprising chocolate because of the additional fat present in cocoa butter. In particular embodiments, it may be necessary to add larger amounts of chocolate as compared to cocoa in order to provide an equivalent amount of flavoring and coloring.

Baked goods generally also comprise caloric sweeteners, such as sucrose, high fructose corn syrup, erythritol, molasses, honey, or brown sugar. In exemplary embodiments of the baked goods provided herein, the caloric sweetener is replaced partially or totally with a steviol glycoside composition of the present application or a sweetener composition comprising the same. Accordingly, in one embodiment a baked good comprises a steviol glycoside composition of the present application or a sweetener composition comprising the same in combination with a fat, water, and optionally flour. In a particular embodiment, the baked good optionally may include other natural and/or synthetic high-potency sweeteners and/or bulk sweeteners.

### Dairy Products

In some embodiments, the consumable comprising the steviol composition of the present application is a dairy product. Dairy products and processes for making dairy products suitable for use with the steviol glycoside compositions of the present application are well known to those of ordinary skill in the art. Dairy products, as used herein, comprise milk or foodstutfs produced from milk. Non-limiting examples of dairy products suitable for use in embodiments of this application include milk, milk cream, sour cream, creme fraiche, buttermilk, cultured buttermilk, milk powder, condensed milk, evaporated milk, butter, cheese, cottage cheese, cream cheese, yogurt, ice cream, frozen custard, frozen yogurt, gelato, via, piima, filmjolk, kajmak, kephir, viili, kumiss, airag, ice milk, casein, ayran, lassi, khoa, or combinations thereof.

Milk is a fluid secreted by the mammary glands of female mammals for the nourishment of their young. The female ability to produce milk is one of the defining characteristics of mammals and provides the primary source of nutrition for newborns before they are able to digest more diverse foods. In particular embodiments, the dairy products are derived from the raw milk of cows, goats, sheep, horses, donkeys, camels, water buffalo, yaks, reindeer, moose, or humans.

In particular embodiments, the processing of the dairy product from raw milk generally comprises the steps of pasteurizing, creaming, and homogenizing. Although raw milk may be consumed without pasteurization, it usually is pasteurized to destroy harmful microorganisms such as bacteria, viruses, protozoa, molds, and yeasts. Pasteurizing generally comprises heating the milk to a high temperature for a short period of time to substantially reduce the number of microorganisms, thereby reducing the risk of disease.

Creaming traditionally follows pasteurization step, and involves the separation of milk into a higher-fat cream layer and a lower-fat milk layer. Milk will separate into milk and cream layers upon standing for twelve to twenty-four hours. The cream rises to the top of the milk layer and may be skimmed and used as a separate dairy product. Alternatively, centrifuges may be used to separate the cream from the milk. The remaining milk is classified according to the fat content of the milk, non-limiting examples of which include whole, 2%, 1%, and skim milk.

After removing the desired amount of fat from the milk by creaming, milk is often homogenized. Homogenization prevents cream from separating from the milk and generally involves pumping the milk at high pressures through narrow tubes in order to break up fat globules in the milk. Pasteurization, creaming, and homogenization of milk are common but are not required to produce consumable dairy products. Accordingly, suitable dairy products for use in embodiments of this application may undergo no processing steps, a single processing step, or combinations of the processing steps described herein. Suitable dairy products for use in embodiments of this application may also undergo processing steps in addition to or apart from the processing steps described herein.

Particular embodiments of this application comprise dairy products produced from milk by additional processing steps. As described above, cream may be skimmed from the top of milk or separated from the milk using machine-centrifuges. In a particular embodiment, the dairy product comprises sour cream, a dairy product rich in fats that is obtained by fermenting cream using a bacterial culture. The bacteria produce lactic acid during fermentation, which sours and thickens the cream. In another particular embodiment, the dairy product comprises creme fraiche, a heavy cream slightly soured with bacterial culture in a similar manner to sour cream. Creme fraiche ordinarily is not as thick or as sour as sour cream. In yet another particular embodiment, the dairy product comprises cultured buttermilk. Cultured buttermilk is obtained by adding bacteria to milk. The resulting fermentation, in which the bacterial culture turns lactose into lactic acid, gives cultured buttermilk a sour taste. Although it is produced in a different manner, cultured buttermilk generally is similar to traditional buttermilk, which is a byproduct of butter manufacture.

According to other particular embodiments of this application, the dairy products comprise milk powder, condensed milk, evaporated milk, or combinations thereof. Milk powder, condensed milk, and evaporated milk generally are produced by removing water from milk. In a particular embodiment, the dairy product comprises a milk powder comprising dried milk solids with a low moisture content. In another particular embodiment, the dairy product comprises condensed milk. Condensed milk generally comprises milk with a reduced water content and added sweetener, yielding a thick, sweet product with a long shelf-life. In yet another particular embodiment, the dairy product comprises evaporated milk. Evaporated milk generally comprises fresh, homogenized milk from which about 60% of the water has been removed, that has been chilled, fortified with additives such as vitamins and stabilizers, packaged, and finally sterilized. According to another particular embodiment of this application, the dairy product comprises a dry creamer and a steviol glycoside composition of the present application or a sweetener composition comprising the same.

In another particular embodiment, the dairy product provided herein comprises butter. Butter generally is made by churning fresh or fermented cream or milk. Butter generally comprises butterfat surrounding small droplets comprising mostly water and milk proteins. The churning process damages the membranes surrounding the microscopic globules of butterfat, allowing the milk fats to conjoin and to separate from the other parts of the cream. In yet another particular embodiment, the dairy product comprises buttermilk, which is the sour-tasting liquid remaining after producing butter from full-cream milk by the churning process.

In still another particular embodiment, the dairy product comprises cheese, a solid foodstuff produced by curdling milk using a combination of rennet or rennet substitutes and acidification. Rennet, a natural complex of enzymes produced in mammalian stomachs to digest milk, is used in cheese-making to curdle the milk, causing it to separate into solids known as curds and liquids known as whey. Generally, rennet is obtained from the stomachs of young ruminants, such as calves; however, alternative sources of rennet include some plants, microbial organisms, and genetically modified bacteria, fungus, or yeast. In addition, milk may be coagulated by adding acid, such as citric acid. Generally, a combination of rennet and/or acidification is used to curdle the milk. After separating the milk into curds and whey, some cheeses are made by simply draining, salting, and packaging the curds. For most cheeses, however, more processing is needed. Many different methods may be used to produce the hundreds of available varieties of cheese. Processing methods include heating the cheese, cutting it into small cubes to drain, salting, stretching, cheddaring, washing, molding, aging, and ripening. Some cheeses, such as the blue cheeses, have additional bacteria or molds introduced to them before or during aging, imparting flavor and aroma to the finished product. Cottage cheese is a cheese curd product with a mild flavor that is drained but not pressed so that some whey remains. The curd is usually washed to remove acidity. Cream cheese is a soft, mild-tasting, white cheese with a high fat content that is produced by adding cream to milk and then curdling to form a rich curd. Alternatively, cream cheese can be made from skim milk with cream added to the curd. It should be understood that cheese, as used herein, comprises all solid foodstuff produced by the curdling milk.

In another particular embodiment, the dairy product comprises yogurt. Yogurt generally is produced by the bacterial fermentation of milk. The fermentation of lactose produces lactic acid, which acts on proteins in milk to give the yogurt a gel-like texture and tartness. In particularly desirable embodiments, the yogurt may be sweetened with a sweetener and/or flavored. Non-limiting examples of flavorings include, but are not limited to, fruits (e.g., peach, strawberry, banana), vanilla, and chocolate. Yogurt, as used herein, also includes yogurt varieties with different consistencies and viscosities, such as dahi, dadih or dadiah, labneh or labaneh, bulgarian, kefir, and matsoni. In another particular embodiment, the dairy product comprises a yogurt-based beverage, also known as drinkable yogurt or a yogurt smoothie. In particularly desirable embodiments, the yogurt-based beverage may comprise sweeteners, flavorings, other ingredients, or combinations thereof.

Other dairy products beyond those described herein may be used in particular embodiments of this application. Such dairy products are well known to those of ordinary skill in the art, non-limiting examples of which include milk, milk and juice, coffee, tea, via, piima, filmjolk, kajmak, kephir, viili, kumiss, airag, ice milk, casein, ayran, lassi, and khoa.

According to particular embodiments of this application, the dairy compositions also may comprise other additives. Non-limiting examples of suitable additives include sweeteners and flavorants such as chocolate, strawberry, and banana. Particular embodiments of the dairy compositions provided herein also may comprise additional nutritional supplements such as vitamins (e.g., vitamin D) and minerals (e.g., calcium) to improve the nutritional composition of the milk.

In a particularly desirable embodiment, the dairy composition comprises a steviol glycoside composition of the present application or a sweetener composition comprising the same in combination with a dairy product.

### Sweetener Compositions

In some embodiments, the consumable comprising the steviol composition of the present application is a sweetener composition. In some emnbodiments, the sweetener composition is a tabletop sweetener composition. In some embodiments, the tabletop sweetener composition may further include at least one bulking agent, additive, anti-caking agent, functional ingredient or combination thereof.

Suitable “bulking agents” include, but are not limited to, maltodextrin (10 DE, 18 DE, or 5 DE), corn syrup solids (20 or 36 DE), sucrose, fructose, glucose, invert sugar, sorbitol, xylose, ribulose, mannose, xylitol, mannitol, galactitol, erythritol, maltitol, lactitol, isomalt, maltose, tagatose, lactose, inulin, glycerol, propylene glycol, polyols, polydextrose, fructooligosaccharides, cellulose and cellulose derivatives, and the like, and mixtures thereof. Additionally, in accordance with still other embodiments of the application, granulated sugar (sucrose) or other caloric sweeteners such as crystalline fructose, other carbohydrates, or sugar alcohol can be used as a bulking agent due to their provision of good content uniformity without the addition of significant calories.

As used herein, the phrase “anti-caking agent” and “flow agent” refer to any composition which assists in content uniformity and uniform dissolution. In accordance with particular embodiments, non-limiting examples of anti-caking agents include cream of tartar, calcium silicate, silicon dioxide, microcrystalline cellulose (Avicel, FMC BioPolymer, Philadelphia, Pa.), and tricalcium phosphate. In one embodiment, the anti-caking agents are present in the tabletop sweetener composition in an amount from about 0.001 to about 3% by weight of the tabletop sweetener composition.

The tabletop sweetener compositions can be packaged in any form known in the art. Non-limiting forms include, but are not limited to, powder form, granular form, packets, tablets, sachets, pellets, cubes, solids, and liquids.

In one embodiment, the tabletop sweetener composition is a single-serving (portion control) packet comprising a dry-blend. Dry-blend formulations generally may comprise powder or granules. Although the tabletop sweetener composition may be in a packet of any size, an illustrative non-limiting example of conventional portion control tabletop sweetener packets are approximately 2.5 by 1.5 inches and hold approximately 1 gram of a sweetener composition having a sweetness equivalent to 2 teaspoons of granulated sugar (˜8 g). The amount of the steviol glycoside composition of the present application or a sweetener composition comprising the same in a dry-blend tabletop sweetener formulation can vary. In a particular embodiment, a dry-blend tabletop sweetener formulation may contain steviol glycoside composition in an amount from about 1% (w/w) to about 10% (w/w) of the tabletop sweetener composition.

Solid tabletop sweetener embodiments include cubes and tablets. A non-limiting example of conventional cubes are equivalent in size to a standard cube of granulated sugar, which is approximately 2.2×2.2×2.2 cm3 and weigh approximately 8 g. In one embodiment, a solid tabletop sweetener is in the form of a tablet or any other form known to those skilled in the art.

A tabletop sweetener composition also may be embodied in the form of a liquid, wherein a steviol glycoside composition of the present application or a sweetener composition comprising the same is combined with a liquid carrier. Suitable non-limiting examples of carrier agents for liquid tabletop sweeteners include water, alcohol, polyol, glycerin base or citric acid base dissolved in water, and mixtures thereof. The sweetness equivalent of a tabletop sweetener composition for any of the forms described herein or known in the art may be varied to obtain a desired sweetness profile. For example, a tabletop sweetener composition may comprise a sweetness comparable to that of an equivalent amount of standard sugar. In another embodiment, the tabletop sweetener composition may comprise a sweetness of up to 100 times that of an equivalent amount of sugar. In another embodiment, the tabletop sweetener composition may comprise a sweetness of up to 90 times, 80 times, 70 times, 60 times, 50 times, 40 times, 30 times, 20 times, 10 times, 9 times, 8 times, 7 times, 6 times, 5 times, 4 times, 3 times, and 2 times that of an equivalent amount of sugar.

### Beverages and Beverage Products

In one embodiment, a beverage or beverage product comprises a steviol glycoside composition of the present application or a sweetener composition comprising the same. The beverage may be sweetened or unsweetened. The steviol glycoside composition, or sweetener composition comprising the same, may be added to a beverage to sweeten the beverage or enhance its existing sweetness or flavor profile.

“Beverage product”, as used herein, is a ready-to-drink beverage, a beverage concentrate, a beverage syrup, or a powdered beverage. Suitable ready-to-drink beverages include carbonated and non-carbonated beverages. Carbonated beverages include, but are not limited to, frozen carbonated beverages, enhanced sparkling beverages, cola, fruit-flavored sparkling beverages (e.g. lemon-lime, orange, grape, strawberry and pineapple), ginger-ale, soft drinks and root beer. Non-carbonated beverages include, but are not limited to, fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, beverage containing milk components (e.g. milk beverages, coffee containing milk components, cafe au lait, milk tea, fruit milk beverages), beverages containing cereal extracts and smoothies.

Beverage concentrates and beverage syrups are prepared with an initial volume of liquid matrix (e.g., water) and the desired beverage ingredients. Full strength beverages are then prepared by adding further volumes of water. Powdered beverages are prepared by dry-mixing all of the beverage ingredients in the absence of a liquid matrix. Full strength beverages are then prepared by adding the full volume of water.

Beverages comprise a matrix, i.e., the basic ingredient in which the ingredients—including the compositions of the present application—are dissolved. In one embodiment, a beverage comprises water of beverage quality as the matrix, such as, for example deionized water, distilled water, reverse osmosis water, carbon-treated water, purified water, demineralized water and combinations thereof, can be used. Additional suitable matrices include, but are not limited to phosphoric acid, phosphate buffer, citric acid, citrate buffer and carbon-treated water.

In one embodiment, a beverage comprises steviol glycoside composition of the present application. In another embodiment, a beverage product comprises a sweetener composition of the present application.

The beverage concentrations below can be provided by the steviol glycoside composition or sweetener composition of the present application.

In one embodiment, the total concentration of steviol glycosides in the beverage is from about 50 ppm to about 900 ppm, such as, for example, from about 50 ppm to about 600 ppm, from about 50 ppm to about 500 ppm, from about 50 ppm to about 400 ppm, from about 50 ppm to about 300 ppm, from about 50 ppm to about 200 ppm, from about 100 ppm to about 600 ppm, from about 100 ppm to about 500 ppm, from about 100 ppm to about 400 ppm, from about 100 ppm to about 300 ppm, from about 100 ppm to about 200 ppm, from about 200 ppm to about 600 ppm, from about 200 ppm to about 500 ppm, from about 200 ppm to about 400 ppm, from about 200 ppm to about 300 ppm, from about 300 ppm to about 600 ppm, from about 300 ppm to about 500 ppm, from about 300 ppm to about 400 ppm, from about 400 ppm to about 600 ppm, from about 400 ppm to about 500 ppm and from about 500 ppm to about 600 ppm.

### Medical Compositions

The term “medicinal composition” includes solids, gases and liquids which are ingestible materials having medicinal value, such as cough syrups, cough drops, medicinal sprays, vitamins, and chewable medicinal tablets.

### Oral Hygiene Compositions

The term “oral hygiene compositions” includes mouthwashes, mouth rinses, toothpastes, tooth polishes, dentifrices, mouth sprays, and mouth refreshers.

### Smoking Compositions

The term “smoking composition,” as used herein, includes cigarette, pipe and cigar tobacco, and all forms of tobacco such as shredded filler, leaf, stem, stalk, homogenized leaf cured, reconstituted binders, and reconstituted tobacco from tobacco dust, fines, or other sources in sheet, pellet or other forms. “Smoking compositions” also include tobacco substitutes formulated from non-tobacco materials, such as representative tobacco substitutes described in U.S. Pat. Nos. 3,529,602, 3,703,177 and 4,079,742 and references cited therein.

The following paragraphs enumerated consecutively from 1 through 114 provide for various aspects of the present application.

1. A steviol glycoside composition comprising: one or more steviol glycosides; one or more non-steviol glycoside sweeteners; and one or more salts.

2. The steviol glycoside composition of Paragraph 1, wherein the one or more steviol glycosides are selected from Table A.

3. The steviol glycoside composition of Paragraph 1, wherein the one or more steviol glycosides comprise RA.

4. The steviol glycoside composition of Paragraph 1, wherein the one or more steviol glycosides comprise RA and RB.

5. The steviol glycoside composition of Paragraph 1, wherein the one or more steviol glycosides comprise (1) ST or (2) ST and STB.

6. The steviol glycoside composition of Paragraph 1, wherein the one or more steviol glycosides comprise RA, RB, ST and STB.

7. The steviol glycoside composition of Paragraph 1, wherein the one or more steviol glycosides comprise RD or RM or both.

8. The steviol glycoside composition of Paragraph 1, wherein the one or more steviol glycosides comprise RA, RB and RD.

9. The steviol glycoside composition of Paragraph 1, wherein the one or more steviol glycosides comprise RA, RB and RM.

10. The steviol glycoside composition of Paragraph 1, wherein the one or more steviol glycosides comprise RA, RB, RD and RM.

11. The steviol glycoside composition of any one of Paragraph 1, wherein the composition comprises essentially purified RD, essentially purified RM, or a mixture essentially containing purified RD and purified RM.

12. The steviol glycoside composition of Paragraph 11, wherein the content of essentially purified RD, essentially purified RM, or mixture essentially containing purified RD and purified RM is in the range of 1% to 99%.

13. The steviol glycoside composition of any one of Paragraphs 1-12, wherein the non-steviol glycoside sweeteners comprise a carbohydrate sweetener and/or a non-carbohydrate sweetener.

14. The steviol glycoside composition of Paragraph 13, wherein the carbohydrate sweetener is selected from the group consisting of sucrose, glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, fucose, rhamnose, arabinose, turanose, sialose and combinations thereof.

15. The steviol glycoside composition of Paragraph 13, wherein the carbohydrate sweetener is glucose.

16. The steviol glycoside composition of any one of Paragraphs 1-15, wherein the salts comprise a steviol glycoside salt.

17. The steviol glycoside composition of Paragraph 16, wherein the steviol glycoside salt comprises a salt of STB.

18. The steviol glycoside composition of Paragraph 16, wherein the salts comprise a sodium salt of RB.

19. The steviol glycoside composition of any one of Paragraphs 1-15, wherein the salts comprise NaCl or KCl.

20. The steviol glycoside composition of any one of Paragraphs 1-15, further comprising thaumatin in the range of 0.01-4 wt %, 0.02-2 wt % or 0.1-0.5 wt %.

21. The steviol glycoside composition of Paragraph 1, comprising 10-95 wt % RA, 0.1-20 wt % RB, 0.01-10 wt % non-steviol glycoside sweetener and 0.01-5 wt % salt.

22. The steviol glycoside composition of Paragraph 21, further comprising 0-60 wt % ST and 0-10 wt % STB.

23. A steviol glycoside composition comprising: 20-90 wt % RA; 0.1-20 wt % RB or 0.1-16 wt % RB; 0.01-5 wt % non-steviol glycoside sweetener; 0.01-1.1 wt % salt; and 0-78.88 wt % non-RA and non-RB steviol glycosides.

24. The steviol glycoside composition of Paragraph 23, comprising 30-85 wt % RA, 0.5-12 wt % RB, 0.03-4 wt % non-steviol glycoside sweetener and 0.03-0.5 wt % salt.

25. The steviol glycoside composition of Paragraph 23, comprising 40-80 wt % RA, 1-10 wt % RB, 0.05-3 wt % non-steviol glycoside sweetener and 0.01-0.5 wt % salt.

26. The steviol glycoside composition of Paragraph 23, comprising 50-70 wt % RA, 2-5 wt % RB, 0.1-1 wt % non-steviol glycoside sweetener and 0.02-0.2 wt % salt.

27. The steviol glycoside composition of Paragraph 23, comprising 75-85 wt % RA, 4-10 wt % RB, 1-2 wt % non-steviol glycoside sweetener and 0.1-0.3 wt % salt.

28. The steviol glycoside composition of Paragraph 23, comprising 45-60 wt % RA, 1-4 wt % RB, 1-2 wt % non-steviol glycoside sweetener and 0.1-0.3 wt % salt.

29. The steviol glycoside composition of any one of Paragraphs 23-28, wherein the salt comprises one or more salts selected from the group consisting of a salt of RB, a salt of STB, a sodium salt and a chloride salt.

30. The steviol glycoside composition of any one of Paragraphs 23-29, further comprising 2-40 wt % ST and 0-2 wt % STB.

31. The steviol glycoside composition of Paragraph 30, wherein the composition comprises 2-4 wt % ST.

32. The steviol glycoside composition of Paragraph 30, wherein the composition comprises 20-40 wt % ST and 0-1 wt % STB.

33. The steviol glycoside composition of Paragraph 30, wherein the composition comprises 20-40 wt % ST and 0-0.4 wt % STB.

34. The composition of Paragraph 30, wherein the composition comprises 20-40 wt % ST and 0.2-0.5 wt % STB.

35. The steviol glycoside composition of Paragraph 30, wherein the composition comprises 25-40 wt % ST and 0.5-1.5 wt % STB, wherein the salt comprises a salt of STB.

36. The steviol glycoside composition of any one of Paragraphs 23-35, wherein the non-steviol glycoside sweetener is glucose.

37. The steviol glycoside composition of any one of Paragraphs 23-36, wherein the salt comprises a sodium salt of RB and/or a sodium salt of STB.

38. The steviol glycoside composition of Paragraph 23, comprising 40-80 wt % RA, 1.5-8 wt % RB, 0.1-2.5 wt % glucose and 0.01-0.3 wt % salt of RB.

39. The steviol glycoside composition of Paragraph 38, wherein the salt of RB comprises a sodium salt of RB.

40. The steviol glycoside composition of Paragraph 37, comprising 20-40 wt % ST and 0-1 wt % STB.

41. The steviol glycoside composition of any one of Paragraphs 21-40, further comprising thaumatin.

42. The steviol glycoside composition of Paragraph 41, comprising 0.01-10 wt % thaumatin.

43. The steviol glycoside composition of Paragraph 41, comprising 0.02-1 wt % thaumatin.

44. The steviol glycoside composition of Paragraph 41, comprising 0.04-0.2 wt % thaumatin.

45. The steviol glycoside composition of any one of Paragraphs 21-44, wherein the composition comprises at least one alkaline-hydrolyzed steviol glycoside.

46. The steviol glycoside composition of any one of Paragraphs 21-44, wherein the composition has been heated and then cooled.

47. A blended steviol glycoside composition, comprising a blend of: (A) a hydrolysis product of a steviol glycoside composition comprising one or more steviol glycosides, and (B) a steviol glycoside composition.

48. The blended steviol glycoside composition of Paragraph 47, wherein the steviol glycoside composition of component (A) comprises one or more steviol glycosides from Table A.

49. The blended steviol glycoside composition of any one of Paragraphs 47-48, wherein the steviol glycoside composition of component (B) comprises one or more steviol glycosides from Table A.

50. The blended steviol glycoside composition of Paragraph 47, wherein the hydrolysis product of the steviol glycoside composition in (A) has a degree of hydrolysis is at least about 0.5%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 99.5%.

51. The blended steviol glycoside composition of Paragraph 47, wherein the hydrolysis product in component (A) is an alkaline hydrolysis product.

52. The blended steviol glycoside composition of any one of Paragraphs 47-51, wherein the weight ratio of component (B):component (A) is in a range of 9:1 to 1:9, 8:2 to 2:8, 7:3 to 3:7, or 6:4 to 4:6.

53. The blended steviol glycoside composition of any one of Paragraphs 47-52, wherein the steviol glycoside composition in component (A) and/or (B) is selected from the group consisting of RA20, RA30, RA40, RA50, RA60, RA80, RA90, RA97 and RA99.

54. The blended steviol glycoside composition of Paragraph 51, wherein the steviol glycoside composition in component (A) is RA99, and wherein the steviol glycoside composition in component (B) is selected from the group consisting of RA50, RA60, RA80 and RA90.

55. The blended steviol glycoside composition of Paragraph 51, wherein the steviol glycoside composition in component (A) and the steviol glycoside composition in component (B) are RA50.

56. The blended steviol glycoside composition of any one of Paragraphs 47-55, further comprising thaumatin, preferably in an amount of 0.04-0.2 wt %.

57. An orally consumable composition, comprising the steviol glycoside composition of any one of Paragraphs 1-56.

58. The orally consumable composition of Paragraph 57, wherein the orally consumable composition is a sweetener.

59. The orally consumable composition of Paragraph 57, wherein the orally consumable composition is a flavoring agent.

60. An orally consumable composition, comprising the blended steviol glycoside composition of any one of Paragraphs 47-56.

61. A method for preparing a hydrolyzed steviol glycoside composition, comprising the steps of: dissolving at least one steviol glycoside in water, adding alkali to the at least one steviol glycoside to form a starting mixture; and incubating the starting mixture at a desired temperature for a desired period of time.

62. The method of Paragraph 61, wherein the desired temperature is selected from the group of ranges 4-200° C., 15-150° C., 25-150° C., 50-125° C., 75-105° C. and 90-95° C.

63. The method of any one of Paragraphs 61-62, wherein the desired period of time is selected from the group of ranges 1 minute to 144 hours, 30 minutes to 24 hours and 2 hours to six hours.

64. The method of any one of Paragraphs 61-63, wherein the at least one steviol glycoside comprises at least one steviol glycoside from Table A.

65. A method for preparing a hydrolyzed steviol glycoside composition, comprising the steps of: dissolving at least one glycosylated steviol glycoside in water; adding alkali to the at least one steviol glycoside to form a starting mixture; and incubating the starting mixture and incubating the starting mixture at a desired temperature for a desired period of time.

66. A method for preparing a hydrolyzed steviol glycoside composition, comprising the steps of: dissolving at least one glycosylated steviol glycoside and at least one steviol glycoside in water; adding alkali to the at least one glycosylated steviol glycoside and the at least one steviol glycoside to form a starting mixture; and incubating the starting mixture at a desired temperature for a desired period of time.

67. A method for preparing a blended steviol glycoside composition, comprising the steps of: dissolving a first steviol glycoside composition in water; adding alkali to the first steviol glycoside composition to form a starting mixture; incubating the starting mixture at a desired temperature for a desired period of time to produce a hydrolysis product; and mixing the hydrolysis product with a second steviol glycoside composition to form a final product.

68. The method of Paragraph 67, wherein the first steviol glycoside composition comprises at least one steviol glycoside selected from Table A.

69. The method of any one of Paragraphs 67-68, wherein the second steviol glycoside composition comprises at least one steviol glycoside selected from Table A.

70. The method of any one of Paragraphs 61-69, wherein the alkali is NaOH.

71. The method of any one of Paragraphs 61-70, further comprising the step of adjusting the pH of the hydrolysis product.

72. The method of Paragraph 71, wherein the step of adjusting comprises adding an acid.

73. The method of Paragraph 72, wherein the acid is HCl.

74. The method of any one of Paragraphs 71-73, wherein the adjusted pH of the final hydrolysis product is 7.

75. The method of any one of Paragraphs 67-74, wherein the first steviol glycoside composition is RA99 and wherein the second steviol glycoside composition is selected from the group consisting of RA50, RA60, RA80 and RA90.

76. The method of any one of Paragraphs 67-75, further comprising adding a non-steviol sweetener.

77. The method of any one of Paragraphs 67-76, further comprising adding a salt.

78. The method of any one of Paragraphs 67-77, further comprising the steps of heating and cooling the final product.

79. A method for preparing a steviol glycoside composition, comprising the steps of: dissolving a first steviol glycoside composition in water; adding alkali to the first steviol glycoside composition to form a starting mixture; incubating the starting mixture at a desired temperature for a desired period of time to produce a hydrolysis product; and mixing the hydrolysis product with a second steviol glycoside composition to form a final product, wherein the final product has balanced flavor, as well as improved solubility and sensory profiles compared to the first or second steviol glycoside composition.

80. The method of Paragraph 79, wherein the alkali is NaOH.

81. The method of any one of Paragraphs 79-80, further comprising the step of adjusting the pH of the final hydrolysis product to pH 7 with an acid.

82. The method of Paragraph 81, wherein the acid is HCl.

83. The method of any one of Paragraphs 79-82, wherein the first steviol glycoside composition is RA99 and wherein the second steviol glycoside composition is selected from the group consisting of RA50, RA60, RA80 and RA90.

84. A method for increasing the sweetness of an orally consumable composition, comprising the step of: adding an effective amount of a steviol glycoside composition any one of Paragraphs 1-56 to the orally consumable composition, wherein the steviol glycoside composition comprises 10-95 wt % RA, 0.1-20 wt % RB, 0.01-10 wt % non-steviol glycoside sweetener, 0.01-5 wt % salt, and 0-89.88 wt % non-RA and non-RB steviol glycosides.

85. The method of Paragraph 84, wherein the salt comprises one or more salts selected from the group consisting of a salt of RB, a salt of steviobioside (STB), a sodium salt, and a chloride salt.

86. A method for increasing a taste or flavor of an orally consumable composition, comprising the step of: adding an effective amount of a steviol glycoside composition any one of Paragraphs 1-56 to the orally consumable composition, wherein the steviol glycoside composition comprises 10-95 wt % RA, 0.1-20 wt %0 RB, 0.01-10 wt % non-steviol glycoside sweetener, 0.01-5 wt % salt, and 0-89.88 wt % non-RA and non-RB steviol glycosides.

87. The method of Paragraph 86, wherein the salt comprises one or more salts selected from the group consisting of a salt of RB, a salt of steviobioside (STB), a sodium salt, and a chloride salt.

88. A method for increasing sweetness of an orally consumable composition, comprising the step of: adding an effective amount ofa steviol glycoside composition any one of Paragraphs 1-53 to the orally consumable composition, wherein the steviol glycoside composition comprises 20-90 wt % RA; 0.1-15 wt % RB; 0.01-5 wt % non-steviol glycoside sweetener, 0.01-5 wt % salt, and 0-79.88 wt % non-RA and non-RB steviol glycosides.

89. The method of Paragraph 88, wherein the steviol glycoside composition comprises 40-80 wt % RA, 1.5-8 wt % RB, 0.1-2.5 wt % glucose and 0.01-0.3 wt % salt of RB.

90. The method of Claim 89, wherein the salt of RB comprises a sodium salt of RB.

91. The method of any one of Paragraphs 88-90, further comprising 20-40 wt % ST and 0-1 wt % STB.

92. The method of any one of Paragraphs 88-91, further comprising 0.01-1 wt % thaumatin.

93. A method for increasing a taste or flavor of an orally consumable composition, comprising the step of: adding an effective amount of a steviol glycoside composition any one of Paragraphs 1-53 to the orally consumable composition, wherein the steviol glycoside composition comprises 20-90 wt % rebaudioside A (RA); 0.1-15 wt % rebaudioside B (RB); 0.01-5 wt % non-steviol glycoside sweetener, 0.01-5 wt % salt, and 0-79.88 wt % non-RA and non-RB steviol glycosides.

94. The method of Paragraph 93, wherein the steviol glycoside composition comprises 40-80 wt % RA, 1.5-8 wt % RB, 0.1-2.5 wt % glucose and 0.01-0.3 wt % salt of RB.

95. The method of Paragraph 93, wherein the salt of RB comprises a sodium salt of RB.

96. The method of any one of Paragraphs 93-95, further comprising 20-40 wt % ST and 0-1 wt % STB.

97. The method of any one of Paragraphs 93-96, further comprising 0.01-1 wt % thaumatin.

98. A composition comprising: RA in an amount of 40-95 wt % of the composition, RB in an amount of 1-20 wt. % of the composition, one or more non-steviol glycoside sweeteners in an amount of 0.05-3 wt % of the composition, and one or more salts in an amount of 0.005-0.5 wt % of the composition

99. The composition of Paragraph 98, wherein RA comprises 40-80 wt % of the composition.

100. The composition of Paragraph 99, wherein RB comprises 1-5 wt % of the composition.

101. The composition of Paragraph 100, wherein the one or more non-steviol glycoside sweeteners comprise 0.05-2 wt % of the composition.

102. The composition of Paragraph 101, wherein the one or more salts comprise 0.005-0.3 wt % of the composition.

The composition of Paragraph 98, comprising 50-65 wt % RA, 1.5-3.5 wt % RB, 0.1-1 wt % non-steviol glycoside sweetener and 0.01-0.15 wt % salt.

104. The composition of Paragraph 98, comprising 60-75 wt % RA, 1.5-3.5 wt % RB, 0.1-1 wt % non-steviol glycoside sweetener and 0.01-0.15 wt % salt.

105. The composition of Paragraph 98, comprising 40-60 wt % RA, 1.5-3.5 wt % RB, 0.1-1 wt % non-steviol glycoside sweetener and 0.01-0.15 wt % salt.

106. The composition of Paragraph 98, wherein RA comprises 75-95 wt % of the composition.

107. The composition of Paragraph 106, wherein RB comprises 4-20 wt % of the composition.

8) 108. The composition of Paragraph 107, wherein the one or more non-steviol glycoside sweeteners comprise 0.5-3 wt % of the composition.

109. The composition of Paragraph 108, wherein the one or more salts comprise 0.05-0.5 wt % of the composition.

110. The composition of Paragraph 98, comprising 75-95 wt % RA, 4-20 wt % RB, 0.5-2 wt % non-steviol glycoside sweetener, and 0.1-0.2 wt % salt.

111. The composition of Paragraph 98, comprising 75-95 wt % RA, 7-20 wt % RB, 1-3 wt % non-steviol glycoside sweetener, and 0.2-0.3 wt % salt.

112. The composition of Paragraph 98, wherein the non-steviol glycoside sweetener is glucose.

113. The composition of Paragraph 98, further comprising 0.1-100 ppm thaumatin.

114. The composition of Paragraph 98, further comprising 1-10 ppm thaumatin.

115. A blended steviol glycoside composition, comprising: (A) an alkaline hydrolysis product of a first steviol glycoside composition, and (B) a second steviol glycoside composition, wherein the weight ratio of component (A):component (B) is in a range of 0.5:9.5 to 9.5:0.5 and wherein the blended steviol glycoside composition has an improved sensory profile compared to component (B).

116. The blended steviol glycoside composition of Paragraph 115, wherein component (A) comprises residual non-hydrolyzed steviol glycoside of the first steviol glycoside.

117. The blended steviol glycoside composition of Paragraph 115, wherein the first steviol glycoside composition is selected from the group consisting of RA20, RA30, RA40, RA50, RA60, RA80, RA90, RA97 and RA99, wherein the second steviol glycoside is selected from the group consisting of RA20, RA30, RA40, RA50, RA60, RA80, RA90, RA97 and RA99.

118. The blended steviol glycoside composition of Paragraph 115, comprising 50-85 wt % RA, 2-10 wt % RB, 0.1-2 wt % non-steviol glycoside sweetener and 0.01-0.3 wt % salt.

119. The blended steviol glycoside composition of Paragraph 115, comprising 50-70 wt % RA, 2-5 wt % RB, 0.1-1 wt % non-steviol glycoside sweetener and 0.02-0.2 wt % salt.

120. The blended steviol glycoside composition of Paragraph 115, comprising 75-85 wt % RA, 4-10 wt % RB, 1-2 wt % non-steviol glycoside sweetener and 0.1-0.3 wt % salt.

121. The blended steviol glycoside composition of Paragraph 115, comprising 45-60 wt % RA, 1-4 wt % RB, 1-2 wt % non-steviol glycoside sweetener and 0.1-0.3 wt % salt.

122. The blended steviol glycoside composition of Paragraph 115, wherein the composition is in solid or liquid form, wherein the concentration of component (A) ranges from about 50 to about 450 ppm, and wherein the concentration of component (B) ranges from about 50 to about 450 ppm.

123. The blended steviol glycoside composition of Paragraph 115, wherein the composition is in solid or liquid form, and wherein the total concentration of component (A) and component (B) ranges from about 100 to about 1000 ppm.

124. The blended steviol glycoside composition of Paragraph 123, wherein the total concentration of component (A) and component (B) ranges from about 100 to about 600 ppm.

125. The blended steviol glycoside composition of Paragraph 124, wherein the total concentration of component (A) and component (B) ranges from about 100 to about 500 ppm.

126. The blended steviol glycoside composition of Paragraph 115, wherein the second steviol glycoside composition comprises rebaudioside M (RM) and/or rebaudioside D (RD).

127. The blended steviol glycoside composition of Paragraph 126, wherein the composition comprises 1-99 wt % RM and/or 1-99% wt % RD.

128. A steviol glycoside composition, comprising a blend of: (A) an alkaline hydrolysis product of a first steviol glycoside, and (B) a thaumatin.

129. The steviol glycoside composition of Paragraph 128, wherein the first steviol glycoside is selected from the group consisting of RA20, RA30, RA40, RA50, RA60, RA80, RA90, RA97 and RA99.

130. The steviol glycoside composition of Paragraph 128, wherein the composition comprises 0.01-15 wt % thaumatin.

131. The steviol glycoside composition of Paragraph 128, wherein the composition comprises 0.04-2 wt % thaumatin.

134. The steviol glycoside composition of Paragraph 128, wherein the composition comprises 0.1-2 wt % thaumatin.

135. The steviol glycoside composition of Paragraph 128, wherein the composition comprises 0.6-1.4 wt % thaumatin.

136. The steviol glycoside composition of Paragraph 128, wherein the weight ratio of component (A):component (B) is in a range of 500:0.5 to 50:7.

137. The steviol glycoside composition of Paragraph 128, wherein the composition is in solid or liquid form, wherein the concentration of component (A) ranges from about 50 to about 800 ppm, and the concentration of component (B) ranges from about 0.1 to about 10 ppm.

138. The steviol glycoside composition of Paragraph 128, wherein the concentration of component (A) ranges from about 100 to about 600 ppm, and the concentration of component (B) ranges from about 0.5 to about 7 ppm.

139. The steviol glycoside composition of Paragraph 128, further comprising acid.

140. The steviol glycoside composition of Paragraph 139, wherein the acid is organic acid or inorganic acid.

141. The steviol glycoside composition of Paragraph 140, wherein the organic acid is selected from the group consisting of C2-C30 carboxylic acids, substituted hydroxyl C2-C30 carboxylic acids, butyric acid, substituted butyric acid, benzoic acid, substituted benzoic acids, substituted cinnamic acids, hydroxyacids, substituted hydroxybenzoic acids, anisic acid substituted cyclohexyl carboxylic acids, tannic acid, aconitic acid, lactic acid, tartaric acid, citric acid, isocitric acid, gluconic acid, glucoheptonic acids, adipic acid, hydroxycitric acid, malic acid, fruitaric acid, fumaric acid, maleic acid, succinic acid, chlorogenic acid, salicylic acid, creatine, caffeic acid, bile acids, acetic acid, ascorbic acid, alginic acid, erythorbic acid, polyglutamic acid, glucono delta lactone, and amino acids.

142. The steviol glycoside composition of Paragraph 140, wherein the inorganic acid is selected from the group consisting of phosphoric acid, phosphorous acid, polyphosphoric acid, hydrochloric acid, sulfuric acid and carbonic acid.

143. An alkaline hydrolysis product of steviol glycoside comprising: RA in an amount of 20-100 wt % of the composition, RB in an amount of 1-80 wt % of the composition, one or more non-steviol glycoside sweeteners in an amount of 0-30 wt % of the composition, and one or more salts in an amount of 0-30 wt % of the composition.

144. The alkaline hydrolysis product of steviol glycoside of Paragraph 143 comprising: RA in an amount of 70-80 wt % of the composition, RB in an amount of 10-20 wt % of the composition, one or more non-steviol glycoside sweeteners in an amount of 0.1-10 wt % of the composition, and one or more salts in an amount of 0.1-5 wt % of the composition.

145. The alkaline hydrolysis product of Paragraph 143, wherein the steviol glycoside is selected from the group consisting of RA20, RA30, RA40, RA50, RA60, RA80, RA90, RA97 and RA99.

146. An orally consumable product, comprising the blended steviol glycoside composition of Paragraph 115.

147. The orally consumable product of Paragraph 146, wherein the product is selected from the group consisting of foods, beverages, pharmaceuticals, tobacco, nutraceuticals, oral hygienic products, and cosmetic products.

148. An orally consumable product, comprising alkaline hydrolysis product of Paragraph 144.

149. The orally consumable product of Paragraph 148, wherein the product is selected from the group consisting of foods, beverages, pharmaceuticals, tobacco, nutraceuticals, oral hygienic products, and cosmetic products.

The application will be further described with reference to the following non-limiting Examples. It will be apparent to those skilled in the art that many changes can be made in the embodiments described without departing from the scope of the present application. Thus the scope of the present application should not be limited to the embodiments described in this application, but only by embodiments described by the language of the claims and the equivalents of those embodiments. Unless otherwise indicated, all percentages are by weight.

### EXAMPLES

The following blends of steviol glycosides are denoted using the rubric “% Wt1/% Wt2 type1/type2”. For instance, “70/30 RA/RB” means a sweetener in which the sweetener content by weight 70% RA and 30% RB by mass. The RA80 ingredient used in the experiments disclosed herein contained approximately 95% total steviol glycosides. The RA50, RA80 and RA97 ingredients used in the experiments were obtained from Sweet Green Fields LLC (“SGF”) of Bellingham, Wash. All blends prepared for the examples below can also be produced by using different Stevia glycosides as starting material for hydrolysis instead of blending partially hydrolyzed material with Stevia glycosides.

### Example 1. Solubility and Sensory Analysis of RA Hydrolysates

Aim: Determine the solubility and taste attributes of RA50/RA80/RA97 hydrolytes made using differing amounts of reaction reagent.

Materials:

RA50 hydrolyzed using 0.0625/0.125/0.25/0.3125/0.375/0.4375/0.5625/0.625 mL NaOH reagent

RA80 hydrolyzed using 0.0625/0.125/0.25/0.3125/0.375/0.4375/0.5625/0.625 mL NaOH reagent

RA97 hydrolyzed using 0.0625/0.125/0.25/0.3125/0.375/0.4375/0.5625/0.625 mL NaOH reagent

RA50 lot#3020510

RA80 lot#3020526

RA97 lot#3030508

RB lot#032-05-04

Experiment 1a: Solubility of dried RA50, 80 and 97 hydrolysates vs. source samples: 20% concentration in preservative.

Hypothesis: There is a minimum RB content in a Stevia extract below which the Stevia extract is rendered relatively insoluble.

1. 1 g of dry RA50 lot#3020510, RA80 Iot#3020526, or RA97 lot#3030508 was weighed into a 15 mL screw cap vial.

2. 1/10 dilute Vogler preservative was added until powder was dissolved in a final volume of 5 mL at room temp.

3. Screw cap vial was sealed and placed in observation rack.

4. Steps 1-3 were repeated for each of the eight RA50, 80 or 97 samples hydrolyzed using 0.0625/0.125/0.25/0.3125/0.375/0.4375/0.5625/0.625 mL NaOH reagent.

5. All dissolved concentrates were photographed and placed under observation indefinitely.

Experiment 1b: Solubility of RA97 treated with 0.625 mL vs. equivalent blend of RA97/RB.

Hypothesis: The mere presence of significant amounts of rebaudioside B causes increased apparent solubility of high RA purity Stevia extracts.

1. RA97 3030508 and RB were blended to mimic the composition of the RA97 0.625 mL treatment described above.

2. 1 g of RA/RB blend was weighed into a 15 mL screw cap vial.

3. 1/10 dilute Vogler preservative was added until powder was fully dissolved in a final volume of 5 mL.

4. Screw cap vial was sealed and placed in observation rack alongside RA97 0.625 mL treatment.

5. RA/RB blend was photographed and placed under observation indefinitely.

6. Sample did not dissolve readily, so RB powder was dried to determine if higher moisture was the cause of insolubility. Dried RB powder consisted of 3.8% moisture.

7. Steps 1-4 were repeated and solubility was not improved.

Experiment 2: Sensory analysis of RA source samples vs. 0.0625/0.3125/0.625 mL treated samples.

1. 300 ppm samples of RA50 #30205 10 parent and RA50 0.0625/0.3125/0.625 mL treatments were made in distilled water and tasted blindly by Tester #10 and Tester #11.

2. Scores were recorded using flash sensory profiling sheets

3. Sensory analysis was repeated for RA80 #3020526 parent and treated samples

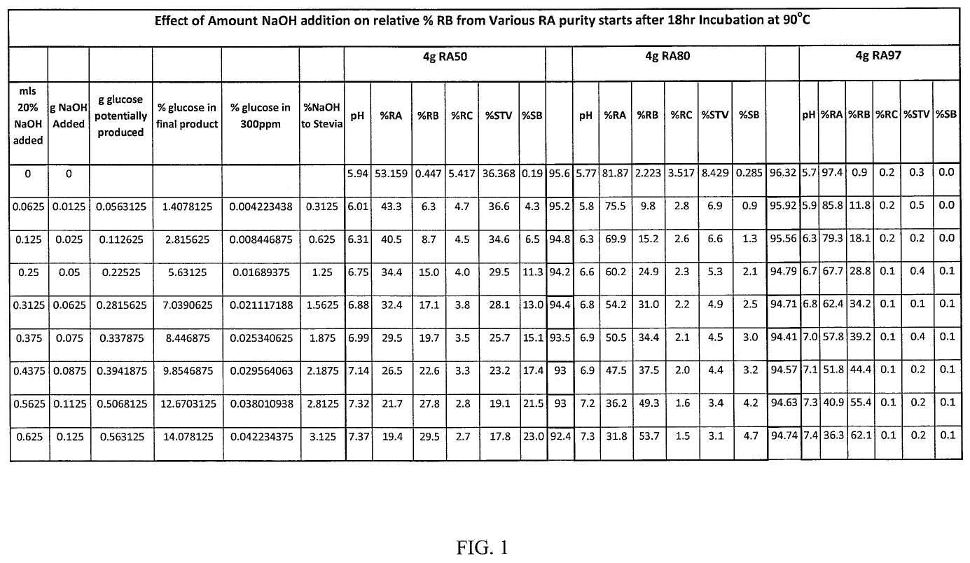

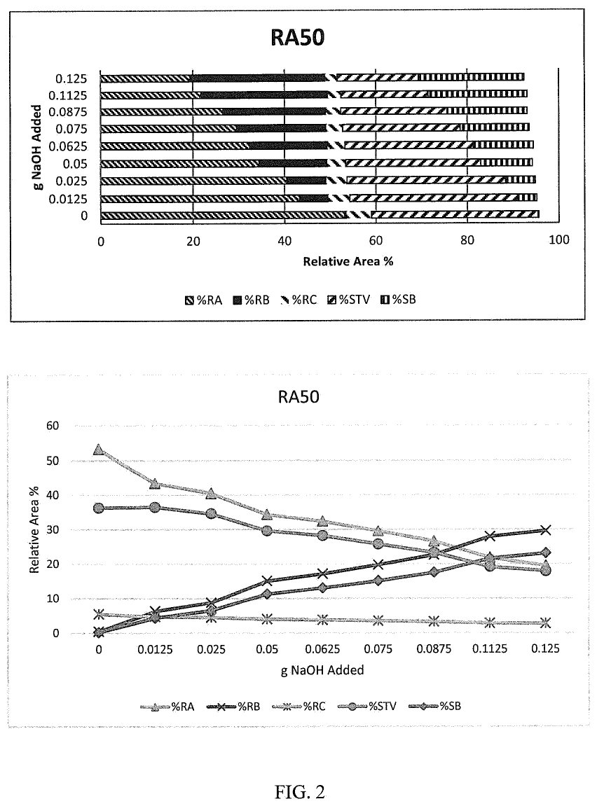

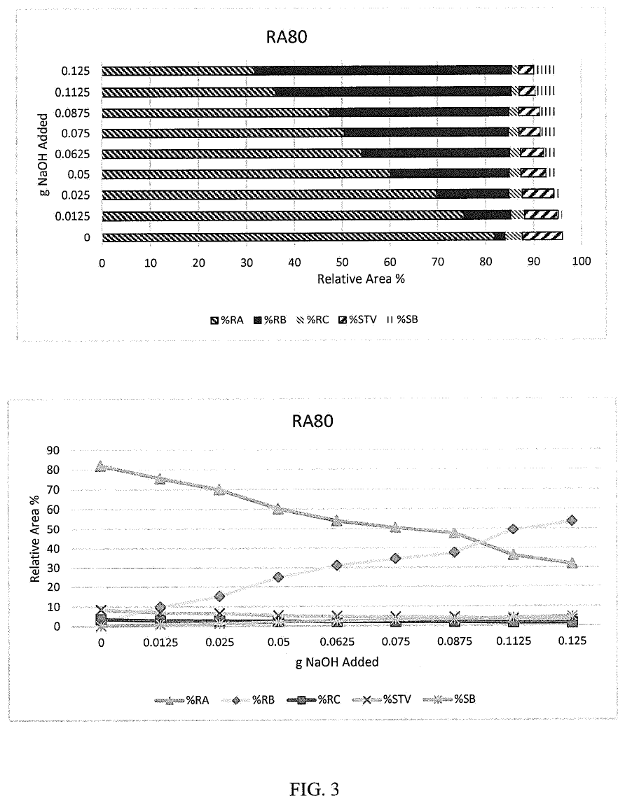

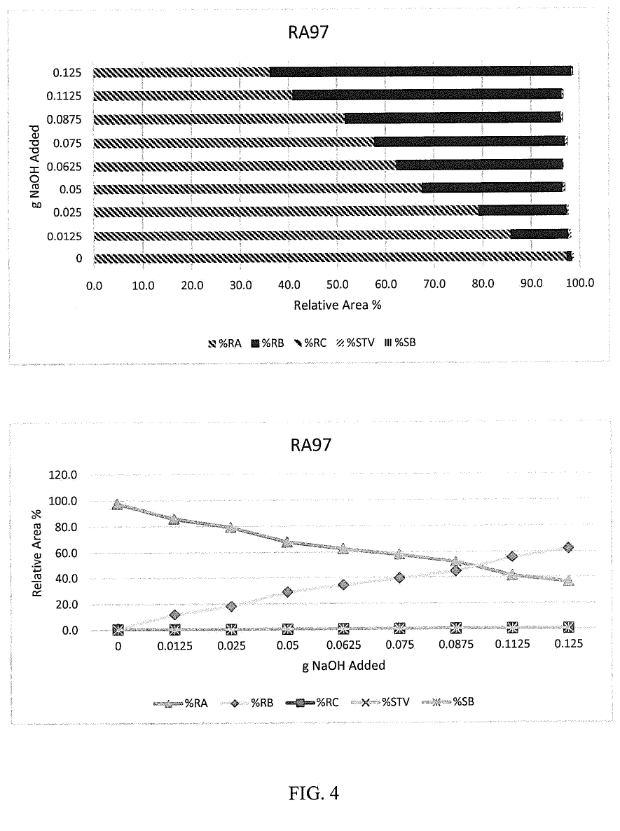

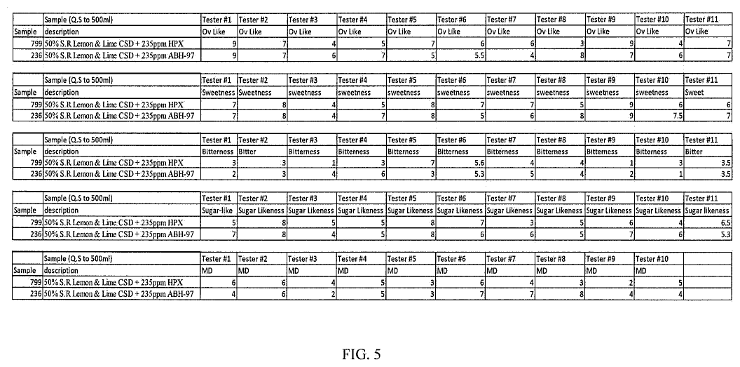

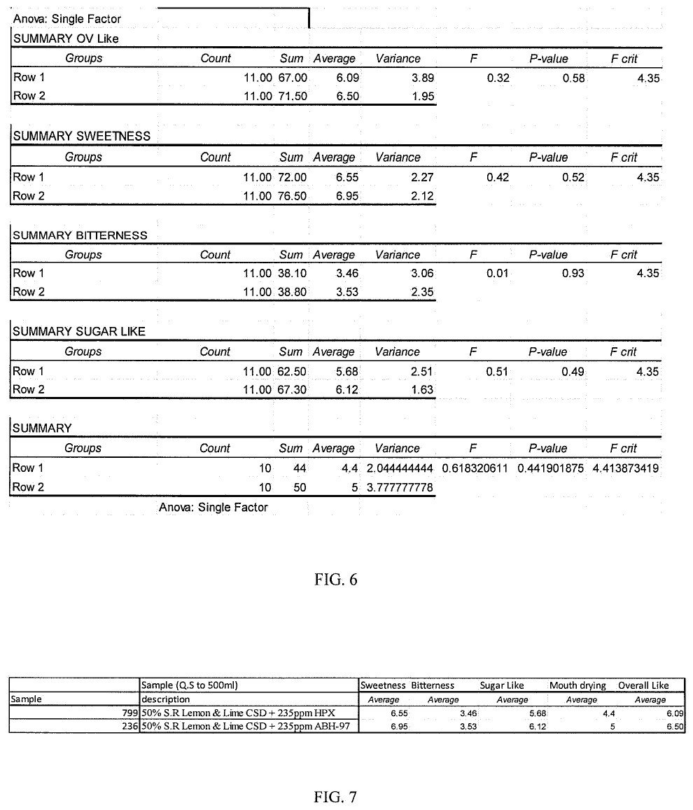

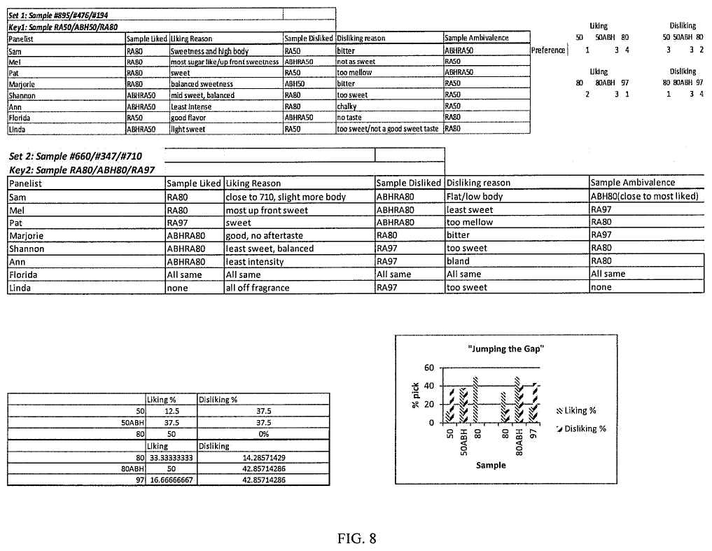

4. Sensory analysis was repeated for RA97 #3030508 parent and treated samples See FIGS. 1-4 for hydrolysis results and FIGS. 5-8 for and sensory analysis of RA Hydrolytes

### Example 2. Sensory Effects of Hydrolyzed D-Glucose on RA/RB and RA97

Hypothesis:

The reaction of sodium hydroxide (NaOH) with Stevia produces glucose, which causes the brown coloration of liquid concentrates made using this reaction method.

This reaction product enhances the sugar-like sensory attributes of RA/RB, i.e. mouth-feel, body, lower bitterness and improved overall liking.

Materials

RA97 lot#3030508

Rebaudioside B lot#032-05-04

D-Glucose

Distilled H.sub.2O

Sodium Hydroxide (NaOH)

Hydrochloric Acid (HCl)

Experiment 1: D-Glucose Hydrolysis

1. Preheat water bath to 90° C.

2. Dissolve 20 g NaOH in distilled H₂O to reach a final volume of 100 mL, and label as “20% w/v NaOH in H₂O”

3. Label 3 separate 50 mL screw cap vials a/b/c and to each add:

0.56 g D-Glucose-+−39 mL H₂O

0.28 g D-Glucose+39.5 mL H₂O

0.056 g D-Glucose+40 mL H₂O

4. Place all vials in 90° C. preheated water-bath and allow solutions to reach temp

5. In rapid succession, add the following amount of previously made 20% NaOH concentrate to samples a/b/c:

0.625 mL 20% NaOH Concentrate

0.3125 mL 20% NaOH Concentrate

0.0625 mL 20% NaOH Concentrate

6. Heat samples for 2 hours in 90° C. water bath

7. After 2 hours of heating, remove vials from the water bath and allow samples to cool to room temperature. Take pictures of the samples upon removal for coloration recording.

8. Take pH of room temperature samples and record. If samples are not at a target pH of about 7.4, neutralize them to target using a IM solution of HCl. Alternatively, the neutralization step is omitted.

Experiment 2: Testing the sensory effects of hydrolyzed D-glucose on RA/RB and RA97

1. To replicate the composition of a dried RA/RB hydrolyte treated with 0.625 mL of reagent, 5 g of RALRB using a 61:39 ratio of RA97:RB was prepared, making sure to mix the sample thoroughly to ensure homogenization. (3.05 g RA97+1.95 g RB=5 g RA/RB blend). This mixture was a replica of the RA97 treated sample where 0.625 mL NaOH had been added. HPLC was used to confirm replication.

2. The amount of liquid D-glucose from each vial to be equivalent to 0.96 mg D-glucose from vial A/0.48 mg reacted D-glucose from vial B (representing the reaction product from use of 300 ppm of Stevia reacted with the highest and mid-level amount of 20% NaOH (0.625 mL and 0.3215 mL respectively) would be:

X=microliters of reacted D-glucose liquid

14.36 mg/1000 μl=0.96 mg/X μl

14.36 X=0.96*1000

X=960/14.36

X=66.85 μl=0.96 mg reacted glucose from vial A for a 100 mL test beverage and 0.48 mg reacted glucose from vial B.

3. The following solution sets were created:

a. Set 1

i. 299.04 mg RA/RB blend+668.5 μL D-Glucose solution vial A+distilled H₂O to a final volume of 1,000 mL. (299.04 ppm RA/RB+9.6 ppm reacted glucose).

ii. 299.52 mg RA/RB blend+668.5 μL D-Glucose solution vial B+distilled H₂O to a final volume of 1,000 mL (299.52 ppm RA/RB+4.8 ppm reacted glucose).

iii. 300 mg RA/RB blend+distilled H₂O to a final volume of 1,000 mL (300 ppm RA/RB).

b. Set 2

i. 299.04 mg RA97+668.5 μL D-Glucose solution vial A-+distilled 1-1H₂O to a final volume of 1,000 mL (299.04 ppm RA97+9.6 ppm reacted glucose).

ii. 299.52 mg RA97+668.5 μL D-Glucose solution vial B+distilled H₂O to a final volume of 1,000 mL (299.04 ppm RA97+4.8 ppm reacted glucose).

iii. 300 mg RA97+distilled H₂O to a final volume of 1,000 mL (300 ppm RA97).

Each set was tasted using double-blind Flash sensory analysis (number of analysts=2).

TABLE 1
Double-blind taste results (T = Tester)

| | | | | | | | T#10 | T#11 | | | |
|---|---|---|---|---|---|---|---|---|---|---|---|
| | T#10 | T#11 | | | | | Sugar | Sugar | | T#10 | T#11 |
| | Sweet- | Sweet- | T#10 | T#11 | T#10 | T#11 | Like | Like | T#11 | Ov. | Ov. |
| | ness | ness | Bitter | Bitter | Linger | Linger | Body | Body | Dry | Like | Like |
| Set 1 | | | | | | | | | | | |
| RA/RB + A | 6.6 | 6 | 1 | 2.5 | 2.7 | 5.5 | 5 | 5 | 3.8 | 7 | 8 |
| RA/RB + B | 6.6 | 6 | 1 | 3.5 | 2.7 | 5.5 | 4.5 | 4.5 | 3.8 | 6 | 6.8 |
| RA/RB Control | 6.6 | 6 | 2 | 6 | 3 | 5.5 | 4.5 | 4.5 | 7 | 6 | 6 |
| Set 2 | | | | | | | | | | | |
| RA97 + A | 6.5 | 6.8 | 1.2 | 5 | 5 | 5 | 5.1 | 5.9 | 4.5 | 7 | 7.2 |
| RA97 + B | 6.5 | 6.8 | 1.2 | 5 | 5 | 5 | 5.1 | 4.9 | 5.5 | 7 | 6.8 |
| RA97 Control | 5.8 | 6.8 | 2.3 | 5 | 5 | 5 | 3.2 | 4.4 | 5.9 | 6 | 6.8 |

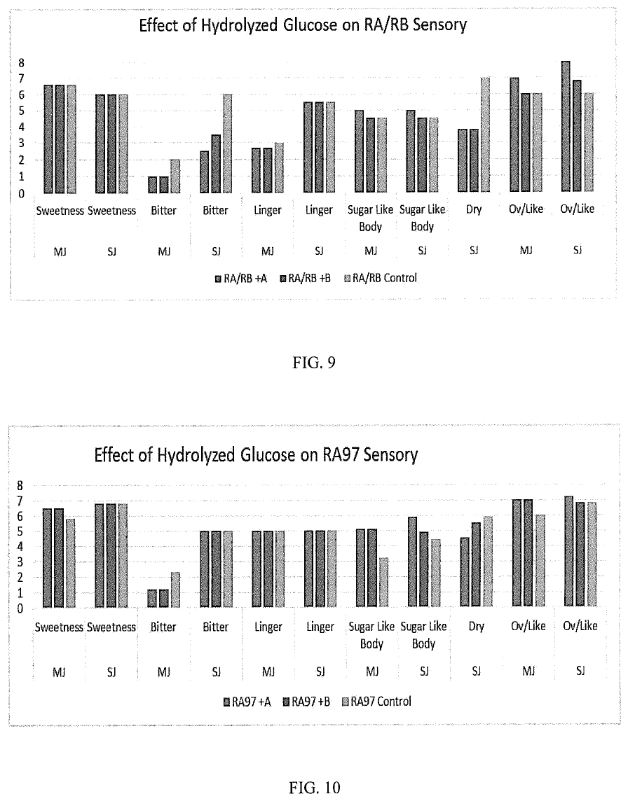

All samples appeared to be iso-sweet (FIGS. 9 and 10).

In the RA/RB samples (Set 1), addition of hydrolyzed glucose at 9.6 or 4.8 ppm appeared to:

1. Reduced bitterness.

2. Have no effect on lingering

3. Increase sugar-like body

4. Increase overall liking.

In the RA97 samples (Set 2), addition of hydrolyzed glucose at 9.6 or 4.8 ppm appeared to:

1. Very slightly reduce bitterness.

2. Have no effect on lingering

3. Increase sugar-like body

4. Increase overall liking.

Conclusions:

The glucose hydrolysate appears to be acting as a flavor. At the concentration used, it likely has no functional sweetness, which was evidenced in the sweetness ratings. The sensory work was done completely blind and with sample order randomized. Even at the low concentrations used, the sample containing 10 ppm glucose hydrolysate was easily discernible. Even though at these low concentrations the hydrolyzed glucose acted as a flavor, the next step is to increase the concentration to determine whether at the maximum potential hydrolyzed glucose concentration (calculated at about 42 ppm or 0.042% for the highest degree of hydrolysis) has negative sensory effects.

### Example 3. Iso-Sweet and Preference Testing for Hydrolyzed Stevia (Equivalent to a Commercial Cranberry Juice Having 83:17 RA/RB Blend)

Aim 1: Determine via HPLC which RA97 hydrolysis material and which RA80 hydrolysis material is closest compositionally in terms of RA to RB ratio with commercial cranberry juice having 83:17 RA/RB blend.

Aim 2: Determine via sensory analysis what ppm level of equivalent RA97 hydrolysis material and RA 80 hydrolysis material is iso-sweet with commercial cranberry juice having 83:15 RA/RB blend in a 9% sugar base.

Aim 3: Determine via sensory analysis if any other treatment level of RA97/RA80 hydrolysis material are more preferred than the iso-sweet hydrolysis materials of RA97/RA80 or commercial fruit drink 83:15 RA/RB blend in a 9% sugar base

Materials

RA100 SGF lot#3020604

RB 032-05-04

RA80 Hydrolysis products formed following treatment with 0.125 mL of 20% NaOH (RA80-H.125)

RA80 Hydrolysis products formed following treatment with 0.3125 mL of 20% NaOH (RA80-H.3125)

RA80 Hydrolysis products formed following treatment with 0.625 mL of 20% NaOH (RA80-H.625)

RA97 Hydrolysis products formed following treatment with 0.125 mL of 20% NaOH (RA97-H.125)

RA97 Hydrolysis products formed following treatment with 0.3125 mL of 20% NaOH (RA97-H.3125)

RA97 Hydrolysis products formed following treatment with 0.625 mL of 20% NaOH (RA97-H.625)

White Granulated Sucrose

Distilled Reverse Osmosis Water

Experiment 1: Composition Comparison and Selection

All samples of RA97 and RA80 hydrolysis material were compared to 83:17 RA 100/RB blend. The samples that were closest in composition were the 0.125 mL reagent treated RA97 (RA97-H.125) and RA80 (RA80-H.125) samples.

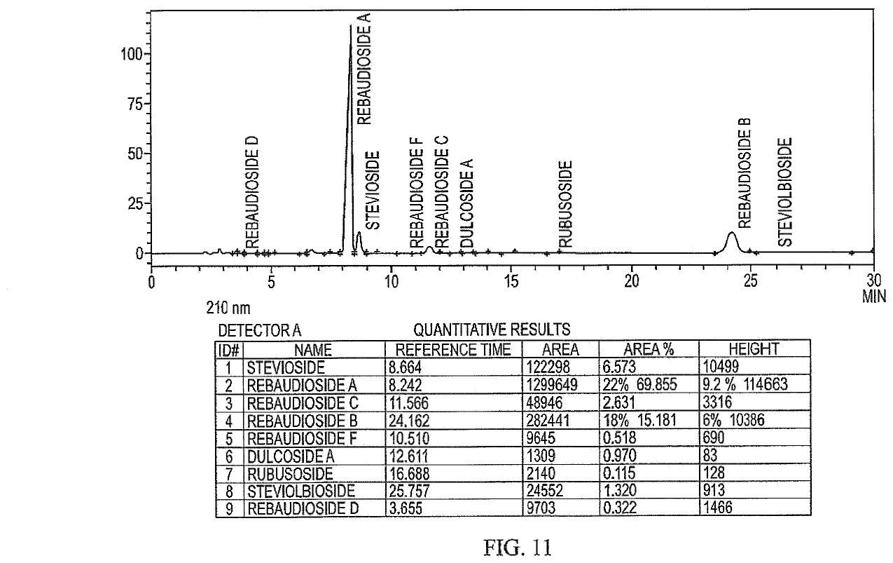

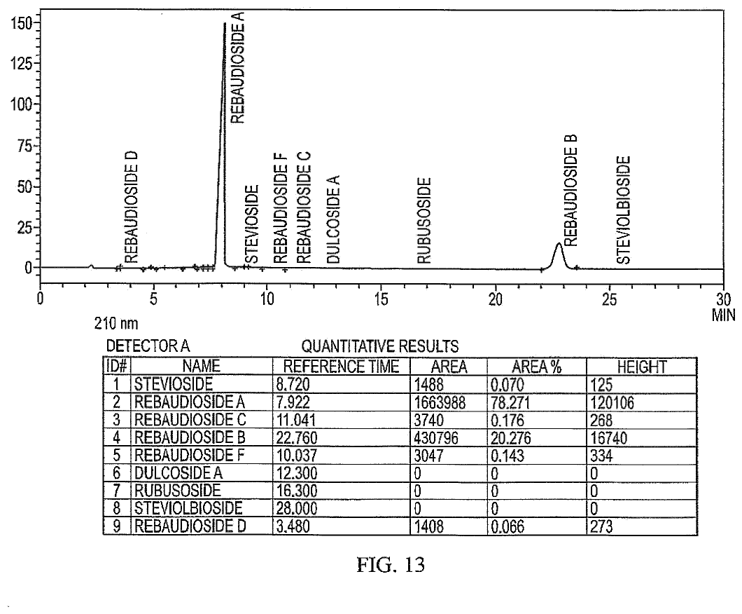

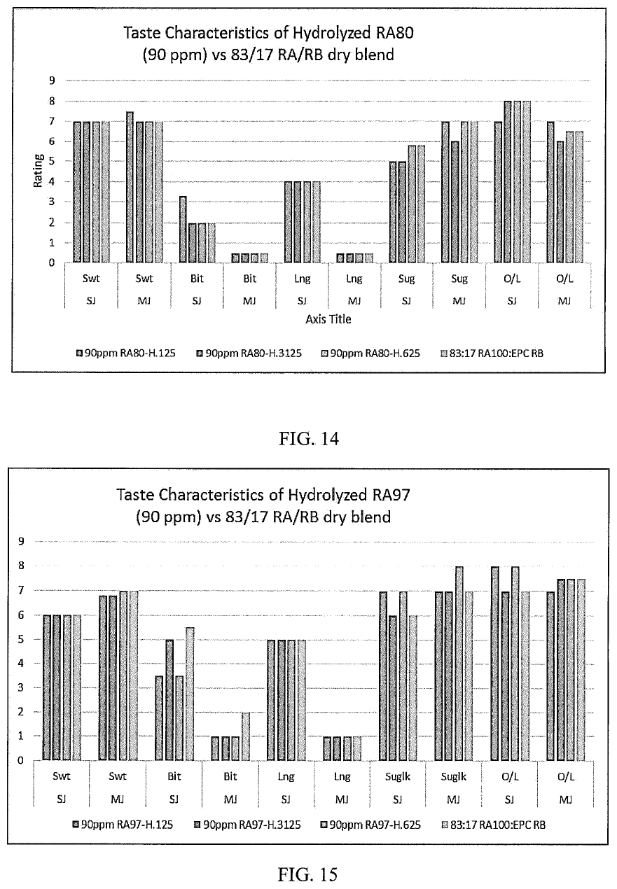

HPLC chromatograms of the dry blend and RA80 and 97 hydrolyzed products are shown in FIGS. 11-13.

Experiment 2: Iso-Sweet Sensory Test

Both RA97-H.125 & RA80-H.125 were tested against known control 83:17 RA/RB blend in a 9% sucrose water base samples were double blinded and tested n=2 using flash sensory scales. After testing the iso-sweet was determined to be closest at 90 ppm, the same level found in a commercial cranberry juice.

TABLE 2
Iso-sweet sensory test results A

| | Sample (Q.S. to 500 mL) | Tester #12 | Tester #13 |
|---|---|---|---|
| Sample | Description | Sweetness | Sweetness |
| 736 | 70 ppm RA97- | 4.4 | 4.8 |
| | H.125 | | |
| 591 | 90 ppm RA97- | 5 | 4 |
| | H.125 | | |
| 188 | 110 ppm RA97- | 5.6 | 6 |
| | H.125 | | |
| 905 | 130 ppm RA97- | 5.9 | 5.2 |
| | H.125 | | |
| control | 83:17 RA100:RB | 5 | 5 |
| | blend | | |

TABLE 3
Iso-sweet sensory test results B

| | Sample (Q.S | | |
|---|---|---|---|
| | to 500 ml) | Tester #12 | Tester #13 |
| Sample | Description | Sweetness | Sweetness |
| 460 | 70 ppm RA80- | 4.2 | 4.6 |
| | H.125 | | |
| 568 | 90 ppm RA80- | 5 | 4.5 |
| | H.125 | | |
| 633 | 110 ppm | 5.5 | 5 |
| | RA80-H.125 | | |
| 789 | 130 ppm | 6.4 | 5.5 |
| | RA80-H.125 | | |
| control | 83:17 | 5 | 5 |
| | RA100:RB | | |
| | blend | | |

To determine if a hydrolyzed RA product had similar taste characteristics to an 83/17 dry blend of RA 100 and RB, 90 ppm concentration in 9% (w/w) sugar water (cold) were compared using flash sensory to the 83/17 dry blend. Samples were tasted double blind and sample order was randomized. The results are shown in Table 4.

TABLE 4
Taste characteristics of hydrolyzed RA80 (90 ppm)
vs 83/17 RA/RB blend (see FIG. 11)

| | Sample | | | | | | | | | | |
|---|---|---|---|---|---|---|---|---|---|---|---|
| | (Q.S. to | | | | | | | | | | |
| | 500 ml) | T11 | T10 | T11 | T10 | T11 | T10 | T11 | T10 | T11 | T10 |
| Sample | Description | Swt | Swt | Bit | Bit | Lng | Lng | Sug | Sug | O.L. | O.L. |
| 883 | 90 ppm | 7 | 7.5 | 3.3 | 0.5 | 4 | 0.5 | 5 | 7 | 7 | 7 |
| | RA80-H.125 | | | | | | | | | | |
| 997 | 90 ppm | 7 | 7 | 2 | 0.5 | 4 | 0.5 | 5 | 6 | 8 | 6 |
| | RA80-H.3125 | | | | | | | | | | |
| 422 | 90 ppm | 7 | 7 | 2 | 0.5 | 4 | 0.5 | 5.8 | 7 | 8 | 6.5 |
| | RA80-H.625 | | | | | | | | | | |
| 472 | 83:17 RA 100: | 7 | 7 | 2 | 0.5 | 4 | 0.5 | 5.8 | 7 | 8 | 6.5 |
| | RB | | | | | | | | | | |

Conclusions: Overall there appeared to no marked difference between samples.

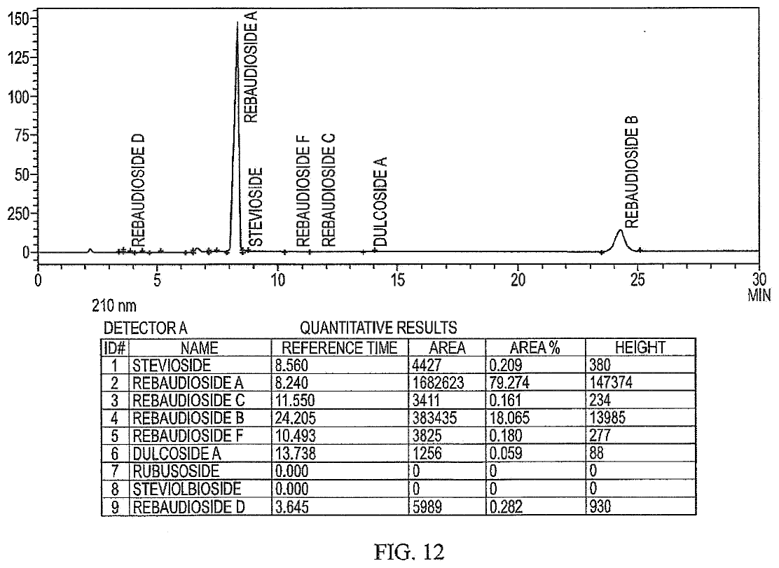

TABLE 5
Taste characteristics of hydrolyzed RA97 (90 ppm)
vs 83/17 RA/RB blend (see FIG. 12)

| | Sample | | | | | | | | | | |
|---|---|---|---|---|---|---|---|---|---|---|---|
| | (Q.S to | | | | | | | | | | |
| | 500 ml) | T11 | T10 | T11 | T10 | T11 | T10 | T11 | T10 | T11 | T10 |
| Sample | Description | Swt | Swt | Bit | Bit | Lng | Lng | Sug | Sug | O.L. | O.L |
| 883 | 90 ppm | 6 | 6.8 | 3.5 | 1 | 5 | 1 | 7 | 7 | 8 | 7 |
| | RA97-H.125 | | | | | | | | | | |
| 315 | 90 ppm | 6 | 6.8 | 5 | 1 | 5 | 1 | 6 | 7 | 7 | 7.5 |
| | RA97-H.3125 | | | | | | | | | | |
| 997 | 90 ppm RA97- | 6 | 7 | 3.5 | 1 | 5 | 1 | 7 | 8 | 8 | 7.5 |
| | H.625 | | | | | | | | | | |
| 472 | 83:17 RA100: RB | 6 | 7 | 5.5 | 2 | 5 | 1 | 6 | 7 | 7 | 7.5 |
| 472 | 83:17 RA 100: RB | 7 | 7 | 2 | 0.5 | 4 | 0.5 | 5.8 | 7 | 8 | 6.5 |

Conclusions: There are no marked differences between sample taste profiles. The only relatively consistent difference was the apparent reduction in bitterness.

### Example 4

The samples in lines 2, 4, and 8 of FIG. 1 (0.0625, 0.25, and 0.5625 20% NaOH added) were prepared by mixing raw materials and then formulated in to solutions.

Test 1

The results showed that for sample 1-1 and sample 1-2, the concentrations of both glucose and salt were relative low and the difference between the samples was not significant; for sample 2-1 and sample 2-2 the concentrations of both glucose and salt were higher than sample 1-1 and 1-2, and the difference between the samples was significant; for sample 3-1 and sample 3-2 the concentration of RB in the product was high, lowing the overall sweetness. The difference between the samples was not significant.

TABLE 6
Sample formulations for taste profiling

| | RA | RB | Glucose | NaCl | |
|---|---|---|---|---|---|
| Sample # | (ppm) | (ppm) | (ppm) | (ppm) | Sample # |
| 1-1 | 202 | 76 | 17 | 5.5 | 1-1 |
| 1-2 | 202 | 76 | — | — | 1-2 |
| 2-1 | 155 | 112 | 25 | 8 | 2-1 |
| 2-2 | 155 | 112 | — | — | 2-2 |
| 3-1 | 85 | 165 | 37 | 12 | 3-1 |
| 3-2 | 85 | 165 | — | — | 3-2 |

TABLE 7
Test results of taste profiling

| | Sugar | | | | Sugar |
|---|---|---|---|---|---|
| Sample # | like | Bitterness | Aftertaste | Lingering | like |
| | 3 | 1 | 2 | 4 | 3 |
| | 3 | 1 | 2 | 4 | 3 |
| | 4 | 0 | 0 | 2 | 4 |
| | 3 | 1 | 2 | 4 | 3 |
| | 4 | 0.5 | 1 | 2 | 4 |
| | 4 | 0.5 | 2 | 2 | 4 |

Test 2

Hydrolysis product: Lot#15-0100, comprising RA 77.55%, RB 16.39%, Glucose 3.99%, and NaCl 1.30%.

Mixed product: prepared by simply mixing raw materials according to the ratio of Lot#15-0100.

TABLE 8
Sample formulations for taste profiling

| Sample | RA | RB | Glucose | NaCl |
|---|---|---|---|---|
| No. | (ppm) | (ppm) | (ppm) | (ppm) |
| 4-1 | 384 | 89 | 20 | 6.5 |
| 4-2 | 384 | 89 | — | — |
| 4-3 | 384 | 89 | 20 | — |
| 4-4 | 384 | 89 | — | 6.5 |
| 4-5 | | Lot#15-0100 | 500 ppm | |

TABLE 9
Test results of taste profiling

| Sample | Sugar | | | |
|---|---|---|---|---|
| No. | like | Bitterness | Aftertaste | Lingering |
| 4-1 | 4 | 0 | 0.5 | 2 |
| 4-2 | 3.5 | 1 | 2 | 4 |
| 4-3 | 4 | 0 | 1 | 2 |
| 4-4 | 3.5 | 0 | 0.5 | 2 |
| 4-5 | 4 | 0 | 0.5 | 2 |

The results showed that there is no difference in taste profile between the products prepared by hydrolysis and that prepared by simply mixing. The addition of glucose and salt improved the taste profile significantly, wherein glucose improved the “sugar like” profile, and salt improved the “aftertaste” profile, both the two components had positive effects on the taste profile.

### Example 5

Sample 1 was prepared according to the below hydrolysis process and the content of each component was analyzed. Another sample (Sample 2), which has the same component as Sample 1, was formulated by simply blending the raw materials. A control sample, which has the same RA and RB content but does not contain any salt or additional sweetener, was prepared by simply blending the raw materials. The taste profile of the three samples were evaluated.

Preparation of Sample 1:

10 grams of RA97 was dissolved in deionized water and 1.56 mL of 20% NaOH was added. The mixture was heated to 90° C. for 8 h with stirring. The resultant mixture was then cooled, neutralized to pH 7.0 with dilute hydrochloric acid, and spray dried, resulting in a yellowish powder as the final product.

Test Result

RA 20.7%

RB 61.2%

NaCl 4.4%

Glucose 13.7%

The product was formulated into 300 ppm solution with deionized water.

The concentration of each component was:

RA 20.7%.times.300 ppm=62.1 ppm

RB 61.2%.times.300 ppm 183.6 ppm

NaCl 4.4%.times.300 ppm 13.2 ppm

Glucose 13.7%.times.300 ppm=41.1 ppm

Preparation of Sample 2:

Sample 2 was prepared and formulated into 300 ppm solution, with RA, RB, NaCl, and glucose.

RA 62.1 ppm

RB 183.6 ppm

NaCl 13.2 ppm

Glucose 41.1 ppm

Preparation of Control Sample:

Control sample was prepared and formulated into solution with RA and RB.

RA 62.1 ppm

RB 183.6 ppm

Select sensory taste profiles of these three solutions were evaluated, and the results were summarized below.

TABLE 10
Taste profiles of samples

| Sample | | | | |
|---|---|---|---|---|
| No. | Sugar like | Bitterness | Aftertaste | Lingering |
| Sample 1 | 4 | 0.5 | 0.5 | 2 |
| Sample 2 | 4 | 0.5 | 0.5 | 2 |
| Control | 3.5 | 2 | 1.5 | 1 |

The results showed that there is no difference between Sample 1 and Sample 2, demonstrating that the taste profile was determined by composition per se, regardless of the preparation process. The results showed that there is significant difference between Sample 1 or Sample 2 and control sample, demonstrating that combination of RA, RB, glucose and salts can improve the sensory profile (i.e., in this experiment sugar like, bitterness, aftertaste, and lingering) of a sweetening composition.

### Example 6

A composition according to the present application was prepared from RA100 as shown in Table 11.

TABLE 11
RA-100 Compositions

| | | mls 1% | g NaOH | g glucose | % | % | % | % Total |
|---|---|---|---|---|---|---|---|---|
| Sample No. | RA100 | NaOH | added | potentially | RA | RB | SS | glycoside |
| 140-35-01 | 10 g | 3.125 | 0.03125 | 0.14 | 90.87 | 6.66 | 0.19 | 97.72 |
| 140-35-02 | 10 g | 31.25 | 0.3125 | 1.4 | 37.66 | 47.18 | 0.15 | 84.99 |

The RA composition in Table 11 were prepared into solutions in Table 12.

TABLE 12
RA-100 Solutions

| Sample No. | RA | RB | Glucose | NaCl |
|---|---|---|---|---|
| 1 | | 140-35-01 | 500 ppm | |
| 2 | 454 ppm | 33 ppm | — | — |
| 3 | | 140-35-02 | 500 ppm | |
| 4 | 188 ppm | 236 ppm | | |

Sensory profiles were taken and are shown in Table 13 and Table 14.

TABLE 13
Evaluation results for sample 1 and 2

| Sample No. | Sugar like | Bitterness | Aftertaste | Lingering |
|---|---|---|---|---|
| 1 | 3.5 | 1 | 2 | 3 |
| 2 | 3 | 2 | 3 | 3 |

Result: The concentrations of glucose and salt in the product are low, since a relative small amount of NaOH was added. The taste profile of the product is improved in comparison with a similar composition without glucose and salt.

Result: The taste profile of the composition according to the present application is significantly improved in comparison with a control sample without glucose and salt.

### Example 7. Evaluation of the Effects of Other Sweeteners and Inorganic Salts on the Taste Profile of the Composition

Test 1: Evaluation of Compositions Comprising Sodium Chloride and Potassium Chloride

TABLE 15
Solutions for evaluation

| Sample No. | RA | RB | NaCl | KCl |
|---|---|---|---|---|
| 309 | 384 ppm | 89 ppm | — | — |
| 517 | 384 ppm | 89 ppm | 6.5 ppm | — |
| 273 | 384 ppm | 89 ppm | — | 6.5 ppm |

TABLE 16
Evaluation results

| Sample No. | Sugar like | Bitterness | Aftertaste | Lingering |
|---|---|---|---|---|
| 309 | 3.5 | 1 | 2 | 4 |
| 517 | 4 | 0 | 1 | 2 |
| 273 | 4 | 0 | 0.5 | 2 |

Results: Substantially same results were achieved with potassium chloride and sodium chloride.

Test 2: Evaluation of Compositions Comprising Various Sweeteners

TABLE 17
Solution for evaluation

| Sample No. | RA | TB | Sweetener |
|---|---|---|---|
| 724 | 384 ppm | 89 ppm | Glucose (20 ppm) |
| 136 | 384 ppm | 89 ppm | Frutose (20 ppm) |
| 507 | 384 ppm | 89 ppm | Lactose (20 ppm) |
| 302 | 384 ppm | 89 ppm | Galactose (20 ppm) |
| 109 | 384 ppm | 89 ppm | Maltose (20 ppm) |

TABLE 18
Evaluation results

| Sample No. | Sugar like | Bitterness | Aftertaste | fingering |
|---|---|---|---|---|
| 724 | 4 | 0 | 1 | 2 |
| 136 | 3.5 | 1 | 1 | 2 |
| 507 | 4.5 | 0 | 0 | 1 |
| 302 | 4 | 0 | 1 | 2 |
| 109 | 4 | 0 | 0 | 2 |

Results: The effect of fructose was slightly lower than glucose, and those of lactose, galactose, and maltose were similar or even better than glucose. The taste profiles of the compositions with an additional sweetener were significantly improved in comparison to that without an additional sweetener (sample 309 in test 1).

### Example 8. Evaluation of Salt on the Taste Profile

Test I: Evaluation of Various Salts on the Taste Profile of Compositions without Glucose.

TABLE 19
Solution for evaluation

| Sample No. | Salt | RA | RB | Salt |
|---|---|---|---|---|
| 327 | NaCl | 384 ppm | 89 ppm | 6.5 ppm |
| 782 | Na₂CO₃ | 384 ppm | 89 ppm | 6.5 ppm |
| 509 | K₂CO₃ | 384 ppm | 89 ppm | 6.5 ppm |

TABLE 20
Evaluation result

| Sample No. | Sugar like | Bitterness | Aftertaste | Lingering |
|---|---|---|---|---|
| 327 | 4 | 0 | 1 | 2 |
| 782 | 3.5 | 1 | 2 | 2 |
| 509 | 3.5 | 1 | 1.5 | 2 |

The addition of carbonates to the composition may result in an “alkaline” (bitterness, astringent, and soapy) taste. Carbonates can also carbonate the composition and can result in a “soda like” taste.

Test II: Evaluation of Various Salts on the Taste Profile of Composition According to the Present Application with Glucose.

TABLE 21
Solution for evaluation

| Sample No. | Salt | RA | RB | Salt | Glucose |
|---|---|---|---|---|---|
| 327 | NaCl | 384 ppm | 89 ppm | 6.5 ppm | 20 ppm |
| 782 | Na₂CO₃ | 384 ppm | 89 ppm | 6.5 ppm | 20 ppm |
| 509 | K₂CO₃ | 384 ppm | 89 ppm | 6.5 ppm | 20 ppm |

TABLE 22
Evaulatiou result

| | | | | | Sample |
|---|---|---|---|---|---|
| Sample No. | Sugar like | Bitterness | Aftertaste | Lingering | No. |
| 327 | 4 | 0 | 1 | 2 | 327 |
| 782 | 3.5 | 0 | 1.5 | 2 | 782 |
| 509 | 3.5 | 0 | 1.5 | 2 | 509 |

Glucose may mask the “bitterness” taste of carbonates, however as shown, the aftertaste improvement can be significant.

### Example 9. Evaluation of RA99 Hydrolysis Products

Using the method described in Example 2 above, RA99 hydrolysis products were created using 20% NaOH solution, resulting in RA99-HP (hydrolysis product) as shown in Table 23 below.

TABLE 23

| Sample | Lot | % | % | % | % | % Rubusoside | % | % | % |
|---|---|---|---|---|---|---|---|---|---|
| name | No. | RA | RB | ST | STB | glycoside | Total | glucose | salt |
| RA99- | 20150815 | 77.46 | 16.54 | 0.45 | N.D | N.D. | 95.1 | 3.7 | 0.5 |
| HP | | | | | | | | | |

RA50, RA60, RA80 and RA97 were blended with RA99-HP. RA50, RA60, RA80 and RA97 have the compositions as shown in Table 24 below.

TABLE 24

| Sample | Lot. | % | % | % | % | % | % Total |
|---|---|---|---|---|---|---|---|
| name | No. | RA | RB | ST | STB | Rubusoside | glycoside |
| RA50 | 20150705 | 54.0 | 0.99 | 35.2 | 0.35 | N.D. | 95.9 |
| RA60 | 20150203 | 62.4 | 0.8 | 25.4 | 0.4 | 0.3 | 95.3 |
| RA80 | 3060001 | 83.2 | 0.93 | 4.52 | N.D. | N.D. | 95.7 |
| RA97 | 20150704 | 97.5 | 0.6 | 0.3 | N.D. | N.D. | 99.0 |

The blend ratio and composition of samples was as shown in Table 25 below.

TABLE 25

| | Ratio | | | | | | | | |
|---|---|---|---|---|---|---|---|---|---|
| | of | | | | | | | | |
| | RA50 | | | | | | | | |
| | to | | | | | | % | | |
| | RA99- | % | % | % | % | % | Total | % | % |
| Sample | HP | RA | RB | ST | STB | Rubusoside | glycoside | glucose | salt |
| 1-1 | 9:1 | 56.3 | 2.6 | 31.73 | 0.32 | N.D. | 95.8 | 0.37 | 0.05 |
| 1-2 | 8:2 | 58.7 | 4.1 | 28.25 | 0.28 | N.D. | 95.7 | 0.74 | 0.1 |

Sample solutions were prepared by dissolving the blends, RA50 and RA97 in deionized water to prepare four solutions as shown in Table 26 below.

TABLE 26

| Sample # | Sample | Concentration (ppm) |
|---|---|---|
| A | RA97 | 500 ppm |
| B | RA50 | 500 ppm |
| C | 1-1 | 500 ppm |
| D | 1-2 | 500 ppm |

The samples were tested and were scored 0-5 according to the increasing sugar like, bitterness, aftertaste and lingering taste profiles. The results were recorded as the mean value of the results provided by the panel (4 person) as shown in Table 27 below.

TABLE 27

| Sample No. | Sugar like | Bitterness | Aftertaste | Lingering |
|---|---|---|---|---|
| A | 3.5 | 2.5 | 3 | 3 |
| B | 2 | 3 | 3 | 4 |
| C | 3.5 | 2.5 | 2 | 2 |
| D | 4 | 2 | 2.5 | 2 |

Result: RA99-HP can improve the taste profile of RA50 significantly. The taste of RA50/RA99-HP blend can be similar to RA97 even if the ratio of RA99-HP to RA50 is 1:9 or less.

A second set of blends with ratios and compositions of sample was created as shown in Table 28 below.

TABLE 28

| | Ratio | | | | | | | | |
|---|---|---|---|---|---|---|---|---|---|
| | of | | | | | | | | |
| | RA60 | | | | | | | | |
| | to | | | | | | % | | |
| | RA99- | % | % | % | % | % | Total | % | % |
| Sample | HP | RA | RB | ST | STB | Rubusoside | glycoside | Glucose | Salt |
| 2-1 | 9:1 | 63.91 | 2.37 | 22.91 | 0.36 | 0.27 | 95.28 | 0.37 | 0.05 |
| 2-2 | 8:2 | 65.41 | 3.95 | 20.41 | 0.32 | 0.24 | 95.26 | 0.74 | 0.1 |

Sample solutions were prepared by dissolving the blends, RA65 and RA97 in deionized water to prepare four solutions as shown in Table 26 below.

TABLE 29

| Sample # | sample | Concentration (ppm) |
|---|---|---|
| E | RA97 | 500 ppm |
| F | RA60 | 500 ppm |
| G | 2-1 | 500 ppm |
| H | 2-2 | 500 ppm |

The samples were tested and were scored 0-5 according to the increasing sugar like, bitterness, aftertaste and lingering taste profiles. The results were recorded as the mean value of the results provided by the panel (4 person) as shown in Table 30 below.

TABLE 30

| Sample No. | Sugar like | Bitterness | Aftertaste | Lingering |
|---|---|---|---|---|
| E | 3.5 | 2.5 | 3 | 3 |
| F | 2.5 | 3 | 3 | 4 |
| G | 3.5 | 2.5 | 2.5 | 2 |
| H | 4 | 2.5 | 2.5 | 2 |

Result: RA99-HP can improve the taste profile of RA60 significantly. The taste of RA60/RA99-HP blend can be similar to RA97 even if the ratio of RA99-HP to RA60 is 1:9 or less.

A third set of blends with ratios and compositions of sample was created as shown in Table 31 below.

TABLE 31

| | Ratio | | | | | | | | |
|---|---|---|---|---|---|---|---|---|---|
| | of | | | | | | | | |
| | RA80 | | | | | | | | |
| | to | | | | | | % | | |
| | RA99- | % | % | % | % | % | Total | % | % |
| Sample | HP | RA | RB | ST | STB | Rubusoside | glycoside | Glucose | Salt |
| 3-1 | 5:5 | 80.35 | 8.74 | 2.49 | N.D. | N.D. | 95.40 | 1.85 | 0.25 |
| 3-2 | 7:3 | 81.50 | 5.61 | 3.30 | N.D. | N.D. | 95.52 | 1.11 | 0.15 |

Sample solutions were prepared by dissolving the blends, RA80 and RA99-HP in deionized water to prepare four solutions as shown in Table 32 below.

TABLE 32

| Sample # | Sample | Concentration (ppm) |
|---|---|---|
| I | RA99-HP | 500 ppm |
| J | RA80 | 500 ppm |
| K | 3-1 | 500 ppm |
| L | 3-2 | 500 ppm |

The samples were tested and were scored 0-5 according to the increasing sugar like, bitterness, aftertaste and lingering taste profiles. The results were recorded as the mean value of the results provided by the panel (4 person) as shown in Table 33 below.

TABLE 33

| Sample No. | Sugar like | Bitterness | Aftertaste | Lingering |
|---|---|---|---|---|
| I | 4 | 0 | 0.5 | 2 |
| J | 3 | 1.5 | 2 | 3 |
| K | 4 | 0.5 | 0.5 | 2 |
| L | 3.5 | 0.5 | 1 | 2 |

Result: RA99-HP can improve the taste profile of RA80 significantly. The taste of RA80/RA99-HP blend can be similar to RA99-HP itself even if the ratio of RA99-HP to RA80 is 3:7 or less.

### Example 10. Evaluation of RA50 Hydrolysis Products

A hydrolyzed product of RA50 was prepared as shown in Table 34 below.

TABLE 34

| | % | % | % | % | % | % |
|---|---|---|---|---|---|---|
| Batch No. | RA | RB | ST | STB | Rubososide | TSG |
| 20150705 | 53.95 | 0.99 | 35.20 | 0.35 | N.D. | 95.9 |

Ratio of material to alkali as used in Example 2 above is shown in Table 35 below.

TABLE 35

| Sample No. | Ratio of material to alkali |
|---|---|
| 4-1 | 16:1.25 (W/V) |
| 4-2 | 16:1 (W/V) |

Composition of hydrolyzed products (per HPLC) was as shown in Table 36 below.

TABLE 36

| | % | % | % | % | % | % |
|---|---|---|---|---|---|---|
| Sample No. | RA | RB | ST | STB | Rubososide | TSG |
| 4-1 | 36.89 | 13.25 | 24.20 | 7.46 | N.D. | 86.18 |
| 4-2 | 40.25 | 10.58 | 26.32 | 5.88 | N.D. | 87.49 |

Hydrolysis conditions were the same as in Example 2 above. The material was isolated as a powder.

The blend ratio and composition of samples was as shown in Table 37 below.

TABLE 37

| | | | | | | | % | |
|---|---|---|---|---|---|---|---|---|
| Sample | | | % | % | % | % | Rubu- | % |
| No. | Blend | Ratio | RA | RB | ST | STB | soside | TSG |
| 5-1 | RA50/4-1 | 9:1 | 53.39 | 2.29 | 31.95 | 0.96 | N.D. | 95.45 |
| 5-2 | RA50/4-2 | 9:1 | 53.25 | 2.17 | 31.90 | 0.88 | N.D. | 95.58 |

Sample solutions were prepared by dissolving the blends, RA50 and RA97 in deionized water to prepare four solutions as shown in Table 38 below.

TABLE 38

| Sample # | Sample | Concentration (ppm) |
|---|---|---|
| M | RA97 | 500 ppm |
| N | RA50 | 500 ppm |
| O | 5-1 | 500 ppm |
| P | 5-2 | 500 ppm |

The samples were tested and were scored 0-5 according to the increasing sugar like, bitterness, aftertaste and lingering taste profiles. The results were recorded as the mean value of the results provided by the panel (4 person) as shown in Table 39 below.

TABLE 39

| Sample No. | Sugar like | Bitterness | Aftertaste | Lingering |
|---|---|---|---|---|
| M | 3.5 | 2.5 | 3 | 3 |
| N | 2 | 3 | 3 | 4 |
| O | 3.5 | 2 | 3 | 3 |
| P | 3.5 | 2.5 | 2.5 | 3 |

Result: The hydrolyzed product of RA50 can improve the taste profile of RA50 significantly. The taste of two blend samples can be similar to RA97 even if the ratio of it to RA50 is 1:9 or less.

### Example 11. Addition of Thaumatin

All above products can show synergistic effects with thaumatin and their taste profile can also be improved by thaumatin. For example, the synergistic effect of RA99-H.125 and thaumatin is shown below. Thaumatin was obtained from Naturex (10%, GA90-00005).

Sample solutions were made by dissolving thaumatin and RA99-H.125 in deionized water to prepare two solutions as shown in Table 40 below.

TABLE 40

| Sample # | RA99-H.125 (ppm) | Thaumatin (ppm) |
|---|---|---|
| 073 | 500 ppm | None |
| 429 | 500 ppm | 1 ppm |

The samples were tested and were scored 0-5 according to the increasing sugar like, bitterness, aftertaste and lingering taste profiles. For the sweetness evaluation of each sample, the sample was tested in pairwise with several sucrose solutions of given sweetness. The sweetness of each sample was compared with those of the sucrose solutions, and the sweetness was evaluated and recorded according to the judgment that the sweetness of the sample was similar to a specific sugar solution or between specific sugar solutions. The results were recorded as the mean value of the results provided by the panel (4 person) as shown in Table 41 below.

TABLE 41

| Sample No. | SE | Sugar like | Bitterness | Aftertaste | Lingering |
|---|---|---|---|---|---|
| 073 | 7.5% | 4 | 0 | 0.5 | 2 |
| 429 | 10.5% | 5 | 0 | 0 | 2 |

Result: The synergistic effect of RA99-H.125 and thaumatin was obvious. Thaumatin can mask the aftertaste of RA99-H.125 and provide an increase in sweetness of about 2% even when the concentration of thaumatin was 1 ppm.

### Example 12. Blend of RA99-H.125 with RA80

The blend ratio and composition of samples were as in Table followed.

TABLE 42

| | Ratio | | | | | | | | |
|---|---|---|---|---|---|---|---|---|---|
| | of | | | | | | | | |
| | RA80 | | | | | | | | |
| | to | | | | | | % | | |
| | RA99- | % | % | % | % | % | Total | % | % |
| Sample | H.125 | RA | RB | STV | Steviobioside | Rubusoside | glycoside | glucose | salt |
| | 6:1 | 82.41 | 3.16 | 3.94 | N.D. | N.D. | 95.61 | 0.53 | 0.07 |

### Example 13. Blend of RA99-HP with RA50

TABLE 43
Raw material

| | | | | | % | % | % | | |
|---|---|---|---|---|---|---|---|---|---|
| Sample | | % | % | % | Stevio- | Rubu- | Total | % | % |
| name | Lot. No. | RA | RB | STV | side | soside | glycoside | glucose | salt |
| RA99- | 20150815 | 77.46 | 16.5 | 0.45 | N.D. | N.D. | 95.1 | 3.7 | 0.5 |
| HP | | | | | | | | | |
| RA50- | 174-71-01 | 40.25 | 10.58 | 26.32 | 5.88 | N.D. | 87.49 | 6.12 | 1.3 |
| HP | | | | | | | | | |

Solutions for taste evaluation: prepare the test solutions by mixing with water at 25′C then stirring to make all components dissolve thoroughly. The data of solution # and concentration are as followed.

TABLE 44

| | | Ratio of RA99-HP to | | |
|---|---|---|---|---|
| Sampl# | Sample | RA50 | RA99-HP | RA50 |
| 101 | RA97 | | 500 ppm of RA97 | |
| 102 | RA50 | | 500 ppm of RA50 | |
| 103 | Blend | 10/90 | 50 ppm | 450 ppm |
| 104 | Blend | 30/70 | 150 ppm | 350 ppm |
| 105 | Blend | 50/50 | 250 ppm | 250 ppm |
| 106 | Blend | 70/30 | 350 ppm | 150 ppm |
| 107 | Blend | 90/10 | 450 ppm | 50 ppm |

Taste evaluation: the samples were tested and were scored 0-5 according to the increasing sugar like, bitterness, aftertaste and lingering taste profiles. The results were recorded as the mean value of the results provided by the panel (4 person).

TABLE 45

| Sample # | Sugar like | Bitterness | Aftertaste | Lingering |
|---|---|---|---|---|
| 101 | 3.5 | 2.5 | 3 | 3 |
| 102 | 2 | 3 | 3 | 4 |
| 103 | 3.5 | 2.5 | 3 | 3 |
| 104 | 4 | 2.5 | 2.5 | 2.5 |
| 105 | 4 | 2.5 | 2.5 | 2.5 |
| 106 | 4 | 2.5 | 2.5 | 2 |
| 107 | 4 | 2 | 2 | 2 |

Conclusion: RA99-HP can improve the taste profile of RA50 significantly. The taste of RA50/RA99-HP blend can be similar to RA97 even if the ratio of RA99-HP to RA50 is 1:9.

### Example 14. Blend of RA99-HP with RA60

Solutions for taste evaluation: Prepare the test solutions by mixing with water at 25° C. then stirring to make all components dissolve thoroughly. The data of solution # and concentration are as followed.

TABLE 46

| | | Ratio of RA99-HP to | | |
|---|---|---|---|---|
| Sampl# | Sample | RA60 | RA99-HP | RA50 |
| 201 | RA97 | | 500 ppm of RA97 | |
| 202 | RA60 | | 500 ppm of RA60 | |
| 203 | Blend | 10/90 | 50 ppm | 450 ppm |
| 204 | Blend | 30/70 | 150 ppm | 350 ppm |
| 205 | Blend | 50/50 | 250 ppm | 250 ppm |
| 206 | Blend | 70/30 | 350 ppm | 150 ppm |
| 207 | Blend | 90/10 | 450 ppm | 50 ppm |

Taste evaluation: the samples were tested and were scored 0-5 according to the increasing sugar like, bitterness, aftertaste and lingering taste profiles. The results were recorded as the mean value of the results provided by the panel (4 person).

TABLE 47

| Sample # | Sugar like | Bitterness | Aftertaste | Lingering |
|---|---|---|---|---|
| 201 | 3.5 | 2.5 | 3 | 3 |
| 202 | 2.5 | 3 | 3 | 3.5 |
| 203 | 3.5 | 2.5 | 2.5 | 2.5 |
| 204 | 4 | 2.5 | 2.5 | 2.5 |
| 205 | 4 | 2.5 | 2.5 | 2.5 |
| 206 | 4 | 2.5 | 2.5 | 2 |
| 207 | 4 | 2 | 2 | 2 |

Conclusion: RA99-HP can improve the taste profile of RA60 significantly. The taste of RA60/RA99-HP blend can be similar to RA97 even if the ratio of RA99-HP to RA50 is 1:9.

### Example 15. Blend of RA99-HP with RA80

Solutions for taste evaluation: Prepare the test solutions by mixing with water at 25° C. then stirring to make all components dissolve thoroughly. The data of solution # and concentration are as followed.

TABLE 48

| | | Ratio of RA99- | | |
|---|---|---|---|---|
| Sampl# | Sample | HP to RA80 | RA99-HP | RA80 |
| 301 | RA99-HP | 100/0 | 500 ppm | 0 |
| 302 | RA80 | 0/100 | 0 | 500 ppm |
| 303 | Blend | 10/90 | 50 ppm | 450 ppm |
| 304 | Blend | 30/70 | 150 ppm | 350 ppm |
| 305 | Blend | 50/50 | 250 ppm | 250 ppm |
| 306 | Blend | 70/30 | 350 ppm | 150 ppm |
| 307 | Blend | 90/10 | 450 ppm | 50 ppm |

Taste evaluation: the samples were tested and were scored 0-5 according to the increasing sugar like, bitterness, aftertaste and lingering taste profiles. The results were recorded as the mean value of the results provided by the panel (4 person).

TABLE 59

| Sample # | Sugar like | Bitterness | Aftertaste | Lingering |
|---|---|---|---|---|
| 301 | 4 | 0 | 0.5 | 2 |
| 302 | 3 | 1.5 | 2 | 3 |
| 303 | 3.5 | 1.5 | 2 | 2.5 |
| 304 | 3.5 | 0.5 | 1 | 2 |
| 305 | 4 | 0.5 | 0.5 | 2 |
| 306 | 4 | 0.5 | 0.5 | 2 |
| 307 | 4 | 0 | 0.5 | 2 |

Conclusion: RA99-HP can improve the taste profile of RA80 significantly. The taste of RA80/RA99-HP blend can be similar to RA99-HP itself even if the ratio of RA99-HP to RA80 is 3:7.

### Example 16. Blend of RA50-HP with RA50

Solutions for taste evaluation: Prepare the test solutions by mixing with water at 25° C. then stirring to make all components dissolve thoroughly. The data of solution # and concentration are as followed.

TABLE 50

| | | Ratio of RA50- | | |
|---|---|---|---|---|
| Sampl# | Sample | HP to RA50 | RA50-HP | RA50 |
| 401 | RA97 | | 500 ppm of RA97 | |
| 402 | RA50 | | 500 ppm of RA50 | |
| 403 | Blend | 10/90 | 50 ppm | 450 ppm |
| 404 | Blend | 30/70 | 150 ppm | 350 ppm |
| 405 | Blend | 50/50 | 250 ppm | 250 ppm |
| 406 | Blend | 70/30 | 350 ppm | 150 ppm |
| 407 | Blend | 90/10 | 450 ppm | 50 ppm |

Taste evaluation: the samples were tested and were scored 0-5 according to the increasing sugar like, bitterness, aftertaste and lingering taste profiles. The results were recorded as the mean value of the results provided by the panel (4 person).

TABLE 51

| Sample # | Sugar like | Bitterness | Aftertaste | Lingering |
|---|---|---|---|---|
| 401 | 3 | 2.5 | 3 | 3 |
| 402 | 2 | 3 | 3 | 4 |
| 403 | 3 | 2.5 | 2.5 | 3 |
| 404 | 3 | 2 | 3 | 3.5 |
| 405 | 3.5 | 2 | 2.5 | 3 |
| 406 | 3.5 | 2 | 2.5 | 3 |
| 407 | 3.5 | 2 | 2.5 | 2.5 |

Conclusion: RA50-HP can improve the taste profile of RA50 significantly. The taste of RA50/RA50-HP blend can be similar to RA97 even if the ratio of RA50-HP to RA50 is 1:9.

### Example 17. Blend of RA50-HP with RA60

Solutions for taste evaluation: Prepare the test solutions by mixing with water at 25° C. then stirring to make all components dissolve thoroughly. The data of solution # and concentration are as followed.

TABLE 52

| | | Ratio of RA50- | | |
|---|---|---|---|---|
| Sampl# | Sample | HP to RA60 | RA50-HP | RA60 |
| 501 | RA97 | | 500 ppm of RA97 | |
| 502 | RA60 | | 500 ppm of RA60 | |
| 503 | Blend | 10/90 | 50 ppm | 450 ppm |
| 504 | Blend | 30/70 | 150 ppm | 350 ppm |
| 505 | Blend | 50/50 | 250 ppm | 250 ppm |
| 506 | Blend | 70/30 | 350 ppm | 150 ppm |
| 507 | Blend | 90/10 | 450 ppm | 50 ppm |

Taste evaluation: the samples were tested and were scored 0-5 according to the increasing sugar like, bitterness, aftertaste and lingering taste profiles. The results were recorded as the mean value of the results provided by the panel (4 person).

TABLE 53

| Sample # | Sugar like | Bitterness | Aftertaste | Lingering |
|---|---|---|---|---|
| 501 | 3.5 | 1.5 | 1.5 | 2.5 |
| 502 | 1.5 | 2.5 | 3.5 | 3.5 |
| 503 | 3 | 2 | 1.5 | 2.5 |
| 504 | 3 | 2 | 1.5 | 2.5 |
| 505 | 3.5 | 2 | 1.5 | 2 |
| 506 | 3.5 | 2 | 1.5 | 2 |
| 507 | 3.5 | 1.5 | 1.5 | 2 |

Conclusion: RA50-HP can improve the taste profile of RA60 significantly. The taste of RA60/RA50-HP blend can be similar to RA97 even if the ratio of RA50-HP to RA50 is 1:9.

### Example 18. Blend of RA50-HP with RA50

Solutions for taste evaluation: Prepare the test solutions by mixing with water at 25° C. then stirring to make all components dissolve thoroughly. The data of solution # and concentration are as followed.

TABLE 54

| | | Ratio of RA50- | | |
|---|---|---|---|---|
| Sampl# | Sample | HP to RA80 | RA50-HP | RA80 |
| 501 | RA97 | | 500 ppm of RA97 | |
| 502 | RA80 | | 500 ppm of RA80 | |
| 503 | Blend | 10/90 | 50 ppm | 450 ppm |
| 504 | Blend | 30/70 | 150 ppm | 350 ppm |
| 505 | Blend | 50/50 | 250 ppm | 250 ppm |
| 506 | Blend | 70/30 | 350 ppm | 150 ppm |
| 507 | Blend | 90/10 | 450 ppm | 50 ppm |

Taste evaluation: the samples were tested and were scored 0-5 according to the increasing sugar like, bitterness, aftertaste and lingering taste profiles. The results were recorded as the mean value of the results provided by the panel (4 person).

TABLE 55

| Sample # | Sugar like | Bitterness | Aftertaste | Lingering |
|---|---|---|---|---|
| 501 | 3.5 | 1.5 | 1.5 | 2.5 |
| 502 | 3 | 1.5 | 2 | 3 |
| 503 | 3.5 | 1.5 | 2 | 2.5 |
| 504 | 3.5 | 2 | 1.5 | 2.5 |
| 505 | 4 | 1.5 | 1.5 | 2 |
| 506 | 4 | 1.5 | 1.5 | 2 |
| 507 | 4 | 1.5 | 1.5 | 2 |

Conclusion: RA50-HP can improve the taste profile of RA80 significantly. The taste of RA80/RA50-HP blend can be similar to RA97 even if the ratio of RA50-HP to RA50 is 1:9. When the ratio is up to 5:5, the taste profile is better than RA97.

### Example 19. Different Concentration of Blend of RA99-HP with RA50 (1:9)

TABLE 56

| RA99-HP/RA50 | | | | |
|---|---|---|---|---|
| (1:9) | Sugar Like | Bitterness | Aftertaste | Lingering |
| 100 ppm | 3.5 | 1.5 | 1.5 | 2 |
| 200 ppm | 4 | 1.5 | 1.5 | 1.5 |
| 400 ppm | 3.5 | 1.5 | 2 | 2.5 |
| 500 ppm | 3.5 | 2.5 | 3 | 3 |
| 600 ppm | 3 | 2.5 | 3 | 3.5 |
| 800 ppm | 2.5 | 3.5 | 3 | 3 |
| 1000 ppm | 2 | 3.5 | 3.5 | 3 |

Conclusion: Blended RA99-HP/RA50 (1:9) can provide better taste profile (sugar like score is greater than 2.5) in the concentration range of 100 ppm-800 ppm; especially when the concentration is lower than 600 ppm, the taste profile can achieve good performance (sugar like score is greater than 3); when the concentration is lower than 500 ppm, the taste profile is excellent, similar to the performance of sucrose (sugar like score is greater than 3.5)

### Example 20. Different Concentration of Blend of RA99-HP with RA80 (5:5)

TABLE 57

| RA99-HP/RA80 | | | | |
|---|---|---|---|---|
| (5:5) | Sugar Like | Bitterness | Aftertaste | Lingering |
| 100 ppm | 4 | 0 | 0.5 | 2 |
| 200 ppm | 4 | 0 | 0.5 | 2 |
| 400 ppm | 4 | 0 | 0.5 | 2 |
| 500 ppm | 4 | 0.5 | 0.5 | 2 |
| 600 ppm | 3.5 | 0.5 | 1 | 2.5 |
| 800 ppm | 3 | 3 | 2.5 | 3.5 |
| 1000 ppm | 2 | 3.5 | 2.5 | 3.5 |

Conclusion: Blended RA99-HP/RA80 (5:5) can provide a good taste profile (sugar like score is greater than 3) in the concentration range of 100 ppm-800 ppm; especially when the concentration is lower than 600 ppm, the taste profile is excellent, similar to the performance of sucrose (sugar like score is greater than 3.5)

### Example 21. The Taste Improvement of Thaumatin to RA99-HP

Sample preparation: thaumatin is available from EPC Natural Products Co., Ltd. (lot#20180201). Dissolve Thaumatin and RA99-HP to deionized water to prepare test solutions. The Sweetness threshold of thaumatin is 7 ppm (which means people cannot taste sweetness of thaumatin if the concentration of thaumatin is lower than 7 ppm).

TABLE 58

| Sample # | RA99-HP/ppm | Thaumatin/ppm |
|---|---|---|
| 601 | 500 ppm | / |
| 602 | 500 ppm | 0.5 ppm |
| 603 | 500 ppm | 1 ppm |
| 604 | 500 ppm | 3 ppm |
| 605 | 500 ppm | 5 ppm |
| 606 | 500 ppm | 7 ppm |

Method: The samples were tested and were scored 0-5 according to the increasing sugar like, bitterness, aftertaste and lingering taste profiles. For the sweetness evaluation of each sample, the sample was tested in pairwise with several sucrose solutions of given sweetness. The sweetness of each sample was compared with those of the sucrose solutions, and the sweetness was evaluated and recorded according to the judgment that the sweetness of the sample was similar to a specific sugar solution or between specific sugar solutions. The results were recorded as the mean value of the results provided by the panel (4 persons).

Result:

TABLE 59

| Sample No. | SE | Sugar like | Bitterness | Aftertaste | Lingering |
|---|---|---|---|---|---|
| 601 | 7.5% | 4 | 0 | 0.5 | 2 |
| 602 | 8.5% | 4.5 | 0 | 0 | 2 |
| 603 | 9% | 5 | 0 | 0 | 2 |
| 604 | 9.5% | 5 | 0 | 0 | 2 |
| 605 | 9.8% | 5 | 0 | 0 | 2 |
| 606 | 10% | 5 | 0 | 0 | 3 |

Conclusion: the synergy effect of RA99-HP and thaumatin was very obvious. Thaumatin can mask the aftertaste of RA99-HP and give an about 2% of sweetness increasing when the concentration of thaumatin was 1 ppm. For the taste profile, thaumatin can improve the taste of RA99-HP and make it more similar to sugar.

### Example 22. The Synergic Effect of RA99-HP to Thaumatin

Sample preparation: thaumatin is available from EPC Natural Products Co., Ltd. (lot#20180201). Dissolve Thaumatin and RA99-HP to deionized water to prepare test solutions.

TABLE 60

| Sample # | RA99-HP/ppm | Thaumatin/ppm |
|---|---|---|
| 701 | 1000 ppm | 7 ppm |
| 702 | 900 ppm | 7 ppm |
| 703 | 800 ppm | 7 ppm |
| 704 | 700 ppm | 7 ppm |
| 705 | 600 ppm | 7 ppm |
| 706 | 500 ppm | 7 ppm |
| 707 | 400 ppm | 7 ppm |
| 708 | 300 ppm | 7 ppm |
| 709 | 200 ppm | 7 ppm |
| 710 | 100 ppm | 7 ppm |
| 711 | 80 ppm | 7 ppm |
| 712 | 50 ppm | 7 ppm |
| 713 | / | 7 ppm |

Method: The samples were tested and were scored 0-5 according to the increasing sugar like, bitterness, aftertaste and lingering taste profiles. For the sweetness evaluation of each sample, the sample was tested in pairwise with several sucrose solutions of given sweetness. The sweetness of each sample was compared with those of the sucrose solutions, and the sweetness was evaluated and recorded according to the judgment that the sweetness of the sample was similar to a specific sugar solution or between specific sugar solutions. The results were recorded as the mean value of the results provided by the panel (4 persons).

Result:

TABLE 61

| Sample No. | SE | Sugar like | Bitterness | Aftertaste | Lingering |
|---|---|---|---|---|---|
| 701 | 10.5% | 4 | 1 | 3 | 5 |
| 702 | 10.5% | 4 | 0 | 2 | 4 |
| 703 | 10% | 4.5 | 0 | 2 | 4 |
| 704 | 9.8% | 4.5 | 0 | 1 | 4 |
| 705 | 10% | 5 | 0 | 0 | 3 |
| 706 | 10% | 5 | 0 | 0 | 3 |
| 707 | 9.8% | 5 | 0 | 0 | 3 |
| 708 | 9.5% | 4.5 | 0 | 0 | 4 |
| 709 | 8% | 4 | 0 | 0 | 3 |
| 710 | 5.5% | 3 | 0 | 0 | 2 |
| 711 | 4.5% | 2 | 0 | 0 | 2 |
| 712 | 3% | 2 | 0 | 0 | 2 |
| 713 | 1.5% | 2 | 0 | 0.5 | 3 |

Conclusion: The synergy effect of RA99-HP and thaumatin was very obvious. The lingering of thaumatin at 7 ppm is very serious. RA99-HP can cut the sweet lingering of thaumatin and make its taste more similar to sugar when the concentration of RA99-HP ranges from 200 ppm to 700 ppm. When the concentration of RA99-HP increases beyond 800 ppm, the bitterness, aftertaste and lingering of the blend become serious again but still better than thaumatin itself.

### Example 23. The Taste Improvement of Thaumatin to RA50-HP

Sample preparation: thaumatin is available from EPC Natural Products Co., Ltd. (lot#20180201). Dissolve Thaumatin and RA99-HP to deionized water to prepare test solutions.

TABLE 62

| Sample # | RA50-HP/ppm | Thaumatin/ppm |
|---|---|---|
| 801 | 500 ppm | / |
| 802 | 500 ppm | 0.5 ppm |
| 803 | 500 ppm | 1 ppm |
| 804 | 500 ppm | 3 ppm |
| 805 | 500 ppm | 5 ppm |
| 806 | 500 ppm | 7 ppm |

Method: The samples were tested and were scored 0-5 according to the increasing sugar like, bitterness, aftertaste and lingering taste profiles. For the sweetness evaluation of each sample, the sample was tested in pairwise with several sucrose solutions of given sweetness. The sweetness of each sample was compared with those of the sucrose solutions, and the sweetness was evaluated and recorded according to the judgment that the sweetness of the sample was similar to a specific sugar solution or between specific sugar solutions. The results were recorded as the mean value of the results provided by the panel (4 persons).

Result:

TABLE 63

| Sample No. | SE | Sugar like | Bitterness | Aftertaste | Lingering |
|---|---|---|---|---|---|
| 801 | 7% | 3 | 0 | 0.5 | 3 |
| 802 | 8% | 3 | 0 | 0 | 3 |
| 803 | 8.5% | 4 | 0 | 0 | 3 |
| 804 | 9% | 5 | 0 | 0 | 2 |
| 805 | 9.3% | 5 | 0 | 0 | 2 |
| 806 | 9.5% | 4.5 | 0 | 0 | 3 |

Conclusion: The synergy effect of RA50-HP and thaumatin was very obvious. Thaumatin can mask the aftertaste of RA50-HP and give an about 2% of sweetness increasing when the concentration of thaumatin was 1 ppm. For the taste profile, thaumatin can improve the taste of RA50-HP and make it more similar to sugar.

### Example 24. Taste Profile of the Hydrolyzed RA and the Corresponding Mixed Product

Raw Material:

Hydrolyzed product: lot #3060268, RA 77.0%, RB 15.95%, Glucose 3.57%, NaCl 1.16%

Mixed product: prepared by simply mixing the raw materials according to the ratio of lot #3060268

Solutions for taste evaluation: Prepare the solutions of products by mixing with water at 25° C. then stirring to make them resolve thoroughly. The data of solution # and concentration are as followed.

TABLE 64

| Sample # | Product | concentration |
|---|---|---|
| 201 | Hydrolyzed product | 200 ppm |
| 202 | Mixed product | 200 ppm |
| 501 | Hydrolyzed product | 500 ppm |
| 502 | Mixed product | 500 ppm |
| 801 | Hydrolyzed product | 800 ppm |
| 802 | Mixed product | 800 ppm |

Taste evaluation: The samples were tested and were scored 0-5 according to the increasing sugar like, bitterness, sweet lingering, full body and caramel taste profiles. The results were recorded as the mean value of the results provided by the panel (6 persons).

TABLE 65

| Sample # | sugar like | bitterness | sweet lingering | full body | caramel |
|---|---|---|---|---|---|
| 201 | 3.92 | 0.08 | 2.17 | 2.25 | 1.83 |
| 202 | 3.00 | 0.17 | 3.00 | 0.33 | 0.00 |
| 501 | 4.00 | 0.17 | 3.00 | 3.08 | 2.83 |
| 502 | 3.08 | 0.33 | 3.75 | 0.25 | 0.00 |
| 801 | 3.75 | 0.42 | 2.92 | 2.75 | 2.75 |
| 802 | 3.17 | 0.67 | 3.83 | 0.75 | 0.0 |

Conclusion: Although there is almost no difference in the ingredient between the hydrolyzed product and the simple mixed product, compared to the mixed product, the hydrolyzed product has increased caramel flavor and the full body mouthfeel of the solution is also improved. Due to the effect of caramel flavor, the overall sweet lingering of the hydrolyzed product was also reduced accordingly.

### Example 25. Taste Profile of Different Ratios of RA50-HP to RM

TABLE 66

| Materials | | | |
|---|---|---|---|
| sample | source | Lot # | specification |
| RD, | Sichuan Ingia Biosynthetic | 20180914 | RD 94.39% |
| rebaudioside D | Co,. ltd, China | | |
| RM, | Sichuan Ingia Biosynthetic | 20180915 | RM 93.03%, |
| rebaudioside M | Co,. ltd, China | | RD 3.67% |

Solutions for taste evaluation: Prepare the test solutions by mixing with water at 25° C. then stirring to make all components dissolve thoroughly. The data of solution # and concentration are as followed.

TABLE 67

| | | Ratio of | | |
|---|---|---|---|---|
| Sample# | Sample | RA50-HP to RM | RA50-HP | RM |
| 1101 | RM | 0/100 | | 500 ppm |
| 1102 | Blend | 5/95 | 25 ppm | 475 ppm |
| 1103 | Blend | 10/90 | 50 ppm | 450 ppm |
| 1104 | Blend | 20/80 | 100 ppm | 400 ppm |
| 1105 | Blend | 30/70 | 150 ppm | 350 ppm |
| 1106 | Blend | 40/60 | 200 ppm | 300 ppm |
| 1107 | Blend | 50/50 | 250 ppm | 250 ppm |
| 1108 | Blend | 60/40 | 300 ppm | 200 ppm |
| 1109 | Blend | 70/30 | 350 ppm | 150 ppm |
| 1110 | Blend | 80/20 | 400 ppm | 100 ppm |
| 1111 | Blend | 90/10 | 450 ppm | 50 ppm |
| 1112 | Blend | 95/5 | 475 ppm | 25 ppm |
| 1113 | RA50-HP | 100/0 | 500 ppm | 0 |

Taste evaluation. The samples were tested and were scored 0-5 according to the increasing sugar like, bitterness, aftertaste and lingering taste profiles. The results were recorded as the mean value of the results provided by the panel (4 persons).

TABLE 68

| Sample # | Sugar like | Bitterness | Aftertaste | Lingering |
|---|---|---|---|---|
| 1101 | 3 | 1 | 1.5 | 2 |
| 1102 | 3 | 1 | 1.5 | 1.5 |
| 1103 | 3 | 1 | 1.5 | 1.5 |
| 1104 | 3.5 | 0.5 | 1.5 | 1.5 |
| 1105 | 3.5 | 0.5 | 1.5 | 2 |
| 1106 | 3.5 | 0.5 | 2 | 2 |
| 1107 | 3 | 0.5 | 2 | 2 |
| 1108 | 2.5 | 1 | 2 | 2.5 |
| 1109 | 2.5 | 1.5 | 2 | 2.5 |
| 1110 | 2 | 2 | 2 | 2.5 |
| 1111 | 2 | 2 | 2 | 2.5 |
| 1112 | 2 | 2 | 2 | 2.5 |
| 1113 | 2 | 2 | 2 | 2.5 |

Conclusion: When blending RA50-HP with RM, their taste profiles could be improved by each other significantly, especially in masking the bitterness and metallic aftertaste, and cutting the sweet lingering. When the blend ratio of RA50-HP to RM is between 5/95 and 50/50, the taste profile of the composition became better.

### Example 26. Taste Profile of Different Ratios of RA50-HP to RD

Solutions for taste evaluation: Prepare the test solutions by mixing with water at 25° C. then stirring to make all components dissolve thoroughly. The data of solution # and concentration are as followed.

TABLE 69

| Sample# | Sample | Ratio of RA50-HP to RD | RA50-HP | RD |
|---|---|---|---|---|
| 1201 | RD | 0/100 | | 500 ppm |
| 1202 | Blend | 5/95 | 25 ppm | 475 ppm |
| 1203 | Blend | 10/90 | 50 ppm | 450 ppm |
| 1204 | Blend | 20/80 | 100 ppm | 400 ppm |
| 1205 | Blend | 30/70 | 150 ppm | 350 ppm |
| 1206 | Blend | 40/60 | 200 ppm | 300 ppm |
| 1207 | Blend | 50/50 | 250 ppm | 250 ppm |
| 1208 | Blend | 60/40 | 300 ppm | 200 ppm |
| 1209 | Blend | 70/30 | 350 ppm | 150 ppm |
| 1210 | Blend | 80/20 | 400 ppm | 100 ppm |
| 1211 | Blend | 90/10 | 450 ppm | 50 ppm |
| 1212 | Blend | 95/5 | 475 ppm | 25 ppm |
| 1213 | RA50-HP | 100/0 | 500 ppm | 0 |

Taste evaluation: The samples were tested and were scored 0-5 according to the increasing sugar like, bitterness, aftertaste and lingering taste profiles. The results were recorded as the mean value of the results provided by the panel (4 persons).

TABLE 70

| Sample # | Sugar like | Bitterness | Aftertaste | Lingering |
|---|---|---|---|---|
| 1201 | 3 | 0.5 | 1.5 | 2 |
| 1202 | 3 | 0.5 | 1.5 | 1.5 |
| 1203 | 3 | 0.5 | 1.5 | 1.5 |
| 1204 | 3 | 0.5 | 1 | 2 |
| 1205 | 3.5 | 0.5 | 1 | 2 |
| 1206 | 3.5 | 0.5 | 1 | 2 |
| 1207 | 3.5 | 0.5 | 1 | 2 |
| 1208 | 3 | 1 | 1 | 2 |
| 1209 | 2.5 | 1.5 | 1.5 | 2 |
| 1210 | 2 | 1.5 | 1.5 | 2.5 |
| 1211 | 2 | 1.5 | 1.5 | 2.5 |
| 1212 | 2 | 1.5 | 1.5 | 2.5 |
| 1213 | 2 | 2 | 2 | 2.5 |

Conclusion: When blending RA50-HP with RD, their taste profiles could be improved by each other significantly, especially in masking the bitterness and metallic aftertaste, and cutting the sweet lingering. When the blend ratio of RA50-HP to RD was between 5/95 and 60/40, the taste profile of the composition became better.

Although the present application has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A composition comprising:
rebaudioside A (RA) in an amount of 40-95 wt % of the composition,
rebaudioside B (RB) in an amount of 1-20 wt. % of the composition,
one or more non-steviol glycoside sweeteners in an amount of 0.05-3 wt % of the composition, and
one or more salts in an amount of 0.005-0.5 wt % of the composition

2. The composition of claim 1, comprising 50-65 wt % RA, 1.5-3.5 wt % RB, 0.1-1 wt % non-steviol glycoside sweetener and 0.01-0.15 wt % salt.

3. The composition of claim 1, comprising 60-75 wt % RA, 1.5-3.5 wt % RB, 0.1-1 wt % non-steviol glycoside sweetener and 0.01-0.15 wt % salt.

4. The composition of claim 1, comprising 40-60 wt % RA, 1.5-3.5 wt % RB, 0.1-1 wt % non-steviol glycoside sweetener and 0.01-0.15 wt % salt.

5. The composition of claim 1, comprising 75-95 wt % RA, 4-20 wt % RB, 0.5-2 wt % non-steviol glycoside sweetener, and 0.1-0.2 wt % salt.

6. The composition of claim 1, comprising 75-95 wt % RA, 7-20 wt % RB, 1-3 wt % non-steviol glycoside sweetener, and 0.2-0.3 wt % salt.

7. A blended steviol glycoside composition, comprising:
(A) an alkaline hydrolysis product of a first steviol glycoside composition, and
(B) a second steviol glycoside composition.
wherein the weight ratio of component (A):component (B) is in a range of 5:95 to 95:5 and wherein the blended steviol glycoside composition has an improved sensory profile compared to component (B).

8. The blended steviol glycoside composition of claim 7, wherein component (A) comprises residual non-hydrolyzed steviol glycoside of the first steviol glycoside.

9. The blended steviol glycoside composition of claim 7, wherein the first steviol glycoside composition is selected from the group consisting of RA20, RA30, RA40, RA50, RA60, RA80, RA90, RA97 and RA99, wherein the second steviol glycoside is selected from the group consisting of RA20, RA30, RA40, RA50, RA60, RA80, RA90, RA97 and RA99.

10. The blended steviol glycoside composition of claim 7, comprising 50-85 wt % RA, 2-10 wt % RB, 0.1-2 wt % non-steviol glycoside sweetener and 0.01-0.3 wt % salt.

11. The blended steviol glycoside composition of claim 7, comprising 50-70 wt % RA, 2-5 wt % RB, 0.1-1 wt % non-steviol glycoside sweetener and 0.02-0.2 wt % salt.

12. The blended steviol glycoside composition of claim 7, comprising 75-85 wt % RA, 4-10 wt % RB, 1-2 wt % non-steviol glycoside sweetener and 0.1-0.3 wt % salt.

13. The blended steviol glycoside composition of claim 7, comprising 45-60 wt % RA, 1-4 wt % RB, 1-2 wt % non-steviol glycoside sweetener and 0.1-0.3 wt % salt.

14. The blended steviol glycoside composition of claim 7, wherein the second steviol glycoside composition comprises rebaudioside M (RM) and/or rebaudioside D (RD).

15. The blended steviol glycoside composition of claim 14, wherein the composition comprises 50-95 wt % RM.

16. The blended steviol glycoside composition of claim 14, wherein the composition comprises 40-95 wt % RD.

17. A steviol glycoside composition, comprising a blend of:
(A) a steviol glycoside composition, and
(B) thaumatin,
wherein the weight ratio of A:B is between 5000:1 and 5:1.

18. The steviol glycoside composition of claim 16, wherein the steviol glycoside composition is (1) RA20, RA30, RA40, RA50, RA60, RA80, RA90, RA97 or RA99, or (2) the hydrolysis product of RA20, RA30, RA40, RA50, RA60, RA80, RA90, RA97 or RA99.

19. The steviol glycoside composition of claim 17 wherein the composition comprises 0.02-10 wt % thaumatin.

20. The steviol glycoside composition of claim 17, wherein the composition comprises 0.1-2 wt % thaumatin.

21. The steviol glycoside composition of claim 17, wherein the weight ratio of component (A):component (B) is in a range of 1,000:1 to 50:1.

22. An orally consumable product, comprising the blended steviol glycoside composition of claim 7.

23. A method for preparing a hydrolyzed steviol glycoside composition, comprising the steps of:
dissolving a steviol glycoside composition in water, wherein the steviol glycoside composition comprises 20-99 wt % RA;
adding an alkali to the steviol glycoside composition to form a starting mixture; and
incubating the starting mixture and incubating the starting mixture at 75-105° C. for 2 to 6 hours to produce an incubated mixture;
neutralizing the incubated mixture to produce a neutralized mixture; and
spray drying the neutralized mixture to produce the hydrolyzed steviol glycoside composition.

24. A method for improving taste profile of a target steviol glycoside composition, comprising the steps of:
adding an alkaline hydrolyzed steviol glycoside composition prepared by the method of claim 23 to the target steviol glycoside composition at a weight ratio of 5:95 to 95:5 to generate an improved composition,
wherein the target steviol glycoside composition comprises 20-99 wt % RA and wherein the improved composition comprises 40-95 wt % RA.
